(19) United States
(12) Patent Application Publication
(10) Pub. No.: US 2026/0023433 A1
(43) Pub. Date: Jan. 22, 2026

(54) INTERACTION FRAMEWORK FOR BIOSIGNALS

(71) Applicant: Cognixion Corporation, Santa Barbara, CA (US)

(72) Inventors: Cole Heiner, Vista, CA (US); Christopher Jason Ullrich, Ventura, CA (US); Joseph Andreas Forsland, Santa Barbara, CA (US)

(73) Assignee: Cognixion Corporation, Santa Barbara, CA (US)

(21) Appl. No.: 19/276,907

(22) Filed: Jul. 22, 2025

Related U.S. Application Data
(60) Provisional application No. 63/674,214, filed on Jul. 22, 2024.

(51) Int. Cl. G06F 3/01; G06F 3/0482

(52) U.S. Cl. CPC G06F 3/015; G06F 3/0482

(57) ABSTRACT

An interactive system is presented for interacting with a user through biosignals and sensor data. The system includes a user input system, an interaction framework, a dynamic user interface (UI), a processor, and a memory. The interaction framework processes biosignal inputs, sensor data, and current context data to provide a context estimation, which may be used to classify user attention and determine the state of selection targets. The dynamic UI receives the UI configuration and LLM/GenAI suggestions or instructions, and provides output to the user. The system can also include additional features, such as presenting selection targets in the idle state, analyzing biosignal inputs and context data to determine user attention, and performing actions based on selection states.

### CROSS-REFERENCE TO RELATED APPLICATIONS

This application claims the benefit of U.S. provisional patent application Ser. No. 63/674,214, filed on Jul. 22, 2024, the contents of which are incorporated herein by reference in their entirety.

### BACKGROUND

Human agency as a term of human psychology may refer to an individual's capacity to actively and independently make choices and to impose those choices on their surroundings. There are many situations in which people have a need and desire to make choices in interacting with their environment but are unable to do so without assistance. In this manner, such people find themselves impaired in their human agency to effect a change in their surroundings or communicate with those around them.

Advances in augmented and virtual reality, as well as large language models (LLMs) and the field of robotics, machine learning (ML), and artificial intelligence (AI), offer a host of tools whereby a user unable to enact their agency to interact with the world around them unassisted may be supported in doing so. These systems may remain partially or fully inaccessible to users unable to speak, users with limited mobility, users with impaired perception of their surroundings, either sensory perception or social perception, and users inexperienced in interacting with augmented reality (AR), virtual reality (VR), and robotics.

There is, therefore, a need for a framework for interaction between a user and an assistive device that supports the user in enacting their agency in their environment based on biosignals, such as brain activity detectable by a brain computer interface (BCI), which may be manipulated through mental activity and movement performed by the user.

### BRIEF SUMMARY

An interactive system is disclosed, comprising a framework for processing biosignal input, sensor data, and user context. The system includes user input systems for collecting data, a classification framework, a context estimator, a dynamic user interface, and a processor for executing instructions. The framework receives biosignal inputs, sensor data, and context data, and uses the context estimator to generate a context estimation, which is then used by the classifier. The classifier determines a UI configuration, which is transmitted to the dynamic UI. The UI receives generative AI output, or the UI is controlled by the generative AI, and displays output to the user. Additionally, a method is described for processing biosignal inputs and sensor data using the framework, involving receipt of data by the interaction framework, processing by the context estimator, and generation of UI configuration and generative AI output.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an interactive system 100 in accordance with one embodiment.

FIG. 2 illustrates exemplary selection target interaction operating states 200 in accordance with one embodiment.

FIG. 3A-FIG. 3E illustrate exemplary selection target display outputs 300 in accordance with one embodiment.

FIG. 4 illustrates a user interaction routine 400 in accordance with one embodiment.

FIG. 5 illustrates an input analysis and attention determination subroutine 500 in accordance with one embodiment.

FIG. 6 illustrates a BCI classification routine 600 in accordance with one embodiment.

FIG. 7 illustrates a head or eye tracking classification routine 700 in accordance with one embodiment.

FIG. 8 illustrates a head or eye tracking classification routine 800 in accordance with one embodiment.

FIG. 9 illustrates a binary input classification routine 900 in accordance with one embodiment.

FIG. 10 illustrates an eye tracking and binary input classification routine 1000 in accordance with one embodiment.

FIG. 11 illustrates an eye tracking and BCI classification routine 1100 in accordance with one embodiment.

FIG. 12 illustrates an eye tracking and BCI classification routine 1200 in accordance with one embodiment.

FIG. 13 illustrates a radial gesture classification routine 1300 in accordance with one embodiment.

FIG. 14 illustrates a radial gesture classification routine 1400 in accordance with one embodiment.

FIG. 15 illustrates a BCI binary input classification routine 1500 in accordance with one embodiment.

FIG. 16 illustrates a BCI binary input classification routine 1600 in accordance with one embodiment.

FIG. 17 illustrates a routine for modal submenu selection targets 1700 in accordance with one embodiment.

FIG. 18A-FIG. 18F illustrate exemplary display output for keyboard interaction 1800 in accordance with one embodiment.

FIG. 19 illustrates a routine using context estimation 1900 in accordance with one embodiment.

FIG. 20A and FIG. 20B illustrate an exemplary selection among eight BCI selection targets 2000 in accordance with one embodiment.

FIG. 21A-FIG. 21C illustrate an exemplary simplified selection among eight BCI selection targets 2100 in accordance with one embodiment.

FIG. 22A-FIG. 22G illustrate exemplary simplified display output for keyboard interaction 2200 in accordance with one embodiment.

FIG. 23 illustrates a user agency and capability augmentation system 2300 in accordance with one embodiment.

FIG. 24 illustrates a biosignals subsystem 2400 in accordance with one embodiment.

FIG. 25 illustrates a context subsystem 2500 in accordance with one embodiment.

FIG. 26A illustrates an isometric view of a BCI headset system 2600 in accordance with one embodiment.

FIG. 26B illustrates a rear view of a BCI headset system 2600 in accordance with one embodiment.

FIG. 26C and FIG. 26D illustrate exploded views of a BCI headset system 2600 in accordance with one embodiment.

FIG. 27 illustrates a BCI+AR environment 2700 in accordance with one embodiment.

FIG. 28 illustrates an augmented reality device logic 2800 in accordance with one embodiment.

FIG. 29 illustrates a block diagram of nonverbal multi-input and feedback device 2900 in accordance with one embodiment.

FIG. 30 illustrates a block diagram of a single framework of a nonverbal multi-input and feedback device 3000 in accordance with one embodiment.

FIG. 31 illustrates a block diagram of nonverbal multi-input and feedback device 3100 in accordance with one embodiment.

FIG. 32 illustrates a logical diagram of a user wearing an augmented reality headset 3200 in accordance with one embodiment.

FIG. 33 a logical diagram of a user wearing an augmented reality headset 3300 in accordance with one embodiment.

FIG. 34 illustrates a diagram of a use case including a user wearing an augmented reality headset 3400 in accordance with one embodiment.

FIG. 35 illustrates a flow diagram 3500 in accordance with one embodiment.

FIG. 36 illustrates a flow diagram 3600 in accordance with one embodiment.

FIG. 37 illustrates a block diagram 3700 in accordance with one embodiment.

FIG. 38 illustrates a block diagram 3800 in accordance with one embodiment.

FIG. 39 illustrates a block diagram 3900 in accordance with one embodiment.

FIG. 40 illustrates an embodiment of a computing device 4000 to implement components and process steps of the system described herein.

FIG. 41 illustrates a cloud computing node 4100 in accordance with one embodiment.

FIG. 42 illustrates a cloud computing environment 4200 in accordance with one embodiment.

FIG. 43 illustrates an item 4300 in accordance with one embodiment.

FIG. 44 illustrates an exemplary tokenizer 4400 in accordance with one embodiment.

FIG. 45 illustrates a deep neural network 4500 in accordance with one embodiment.

FIG. 46A illustrates inference and/or training logic 4600a in accordance with one embodiment.

FIG. 46B illustrates inference and/or training logic 4600b in accordance with one embodiment.

FIG. 47 illustrates a basic deep neural network 4700 in accordance with one embodiment.

FIG. 48 illustrates an artificial neuron 4800 in accordance with one embodiment.

### DETAILED DESCRIPTION

An interaction framework is disclosed through which a human user may interact with an assistive computing device such as an AR/VR head set through a user interface (UI) by using biosignal input, and taking into account the user's current context, such as environment, use history, etc.

This may be accomplished using a system and/or apparatus performing a method of detecting and performing actions based on user attention, as interpreted through biosignals and other sensed inputs. Such inputs may include some combination of electroencephalogram (EEG), electrocorticography (ECoG), electrocardiogram (ECG or EKG), electromyography (EMG), electrooculography (EOG), pulse, heart rate variability, blood sugar sensing, dermal conductivity, environmental temperature, location data, use history, etc.

In one embodiment, common interaction states (idle, hover, and select) may provide a way to control interfaces using the various input modalities offered within the framework.
Idle State: The default state of a selection target with which a user may, but is not currently, interacting.
Hover State: This state signifies a user's desire to interact with a selection target, as interpreted by biosignal input and other sensor input, and may be visualized in various ways such as by changing color, size, adding a ring, glow effect, flashing, etc., of a displayed selection target.
Selected State: Occurs when a specific action is performed to confirm a user's desire to interaction with a selection target.

In one embodiment, selection targets may be configured but may be inactive. An inactive target may be configured for a display design, but may not yet be displayed or may be displayed but unable to be interacted with. For example, in BCI applications, an inactive selection target may be visible to a user, but may not be flashing at a preconfigured frequency, and thus interaction with the control may not be possible through the detection of brain-generated signals from the BCI.

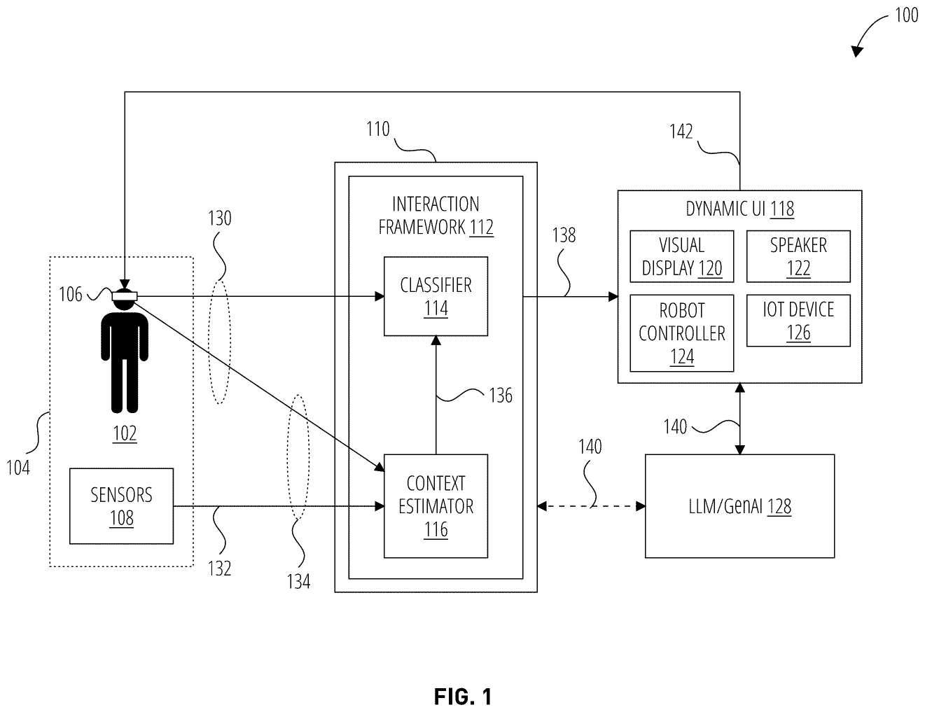

FIG. 1 illustrates an interactive system 100 in accordance with one embodiment. The interactive system 100 may comprise a user 102 providing input through user input systems 104 that may include a user device 106 and sensor 108. The interactive system 100 may further comprise a computing device 110 configured with an interaction framework 112 including a classifier 114 and a context estimator 116. The interactive system 100 may further comprise a dynamic user interface 118, which may include one or more of a visual display 120, a speaker 122, a robot controller 124, and an IoT device 126. The user interface 118 may be static, responsive, adaptive or generative. A Static UI generally includes a manually designed fixed layout (e.g., traditional websites). A Responsive UI generally adapts to screen size (e.g., modern websites, mobile friendly websites). Adaptive UI generally modifies content based on user preferences (e.g., enterprise software, Web Content Accessibility Guidelines (WCAG) focused). Generative UI is generally AI-driven with real-time UI adaption (e.g., AP-powered dashboards, conversational UI, and no-code platforms). Dynamic UI is a term that captures all of the features in the Responsive, Adaptive, and Generative designs. The user interface 118 may further incorporate principles of natural user interface design (NUI) including personalization, accessibility, scalability and efficiency. The interactive system 100 may finally comprise a large language model/GenAI 128. Biosignal inputs 130 and sensor data 132 may be provided to the interaction framework 112 from the user input systems 104. Current context data 134 may also be provided to the interaction framework 112 by the user input systems 104. The context estimator 116 may provide a context estimation 136 to the classifier 114. The classifier 114 may provide a UI configuration 138 to the dynamic user interface 118. The large language model/GenAI 128 may provide Generative AI based suggestions and configurations 140 to the dynamic user interface 118 and/or the interaction framework 112. The dynamic user interface 118 may include a visual display 120, a speaker 122, a robot controller 124, and an IoT device 126, which may provide output 142 to the user 102. In some embodiments, the dynamic UI is a static layout where at least a portion of the content is provided at runtime. In other embodiments, the dynamic UI layout and at least a portion of the content is provided at runtime, in some instances by an agentic or LLM system.

In this disclosure, GenAI and its subset LLMs are not intended to limit the analysis and instruction generating tools useful in various embodiments. Exemplary alternatives to GenAI that may be used in various embodiments include symbolic AI, which uses rule-based algorithms to process data, and traditional machine learning models like decision trees and random forests, which rely on structured input data for predictions. Other options include expert systems that mimic human decision-making in specific domains and optimization algorithms such as genetic algorithms and simulated annealing for solving complex problems. Additional alternatives may include methods like recurrent neural networks and Markov models for certain text generation tasks.

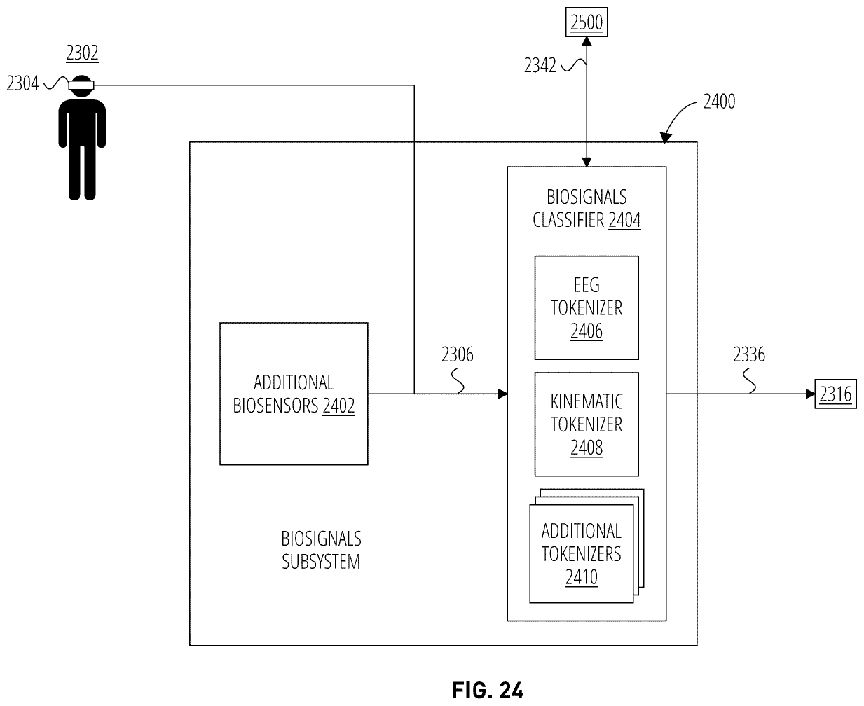

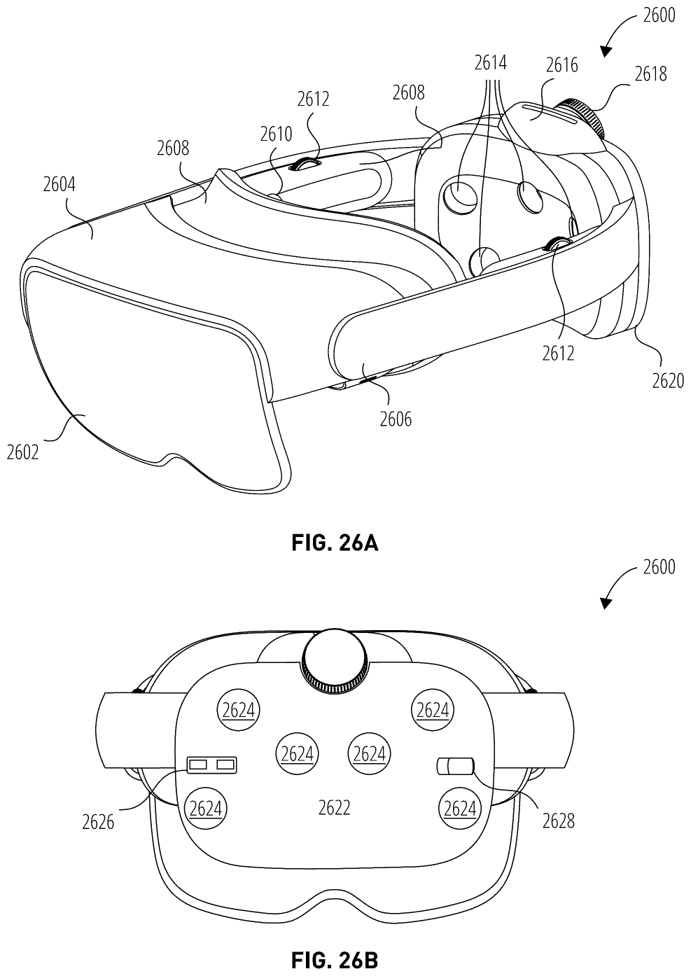

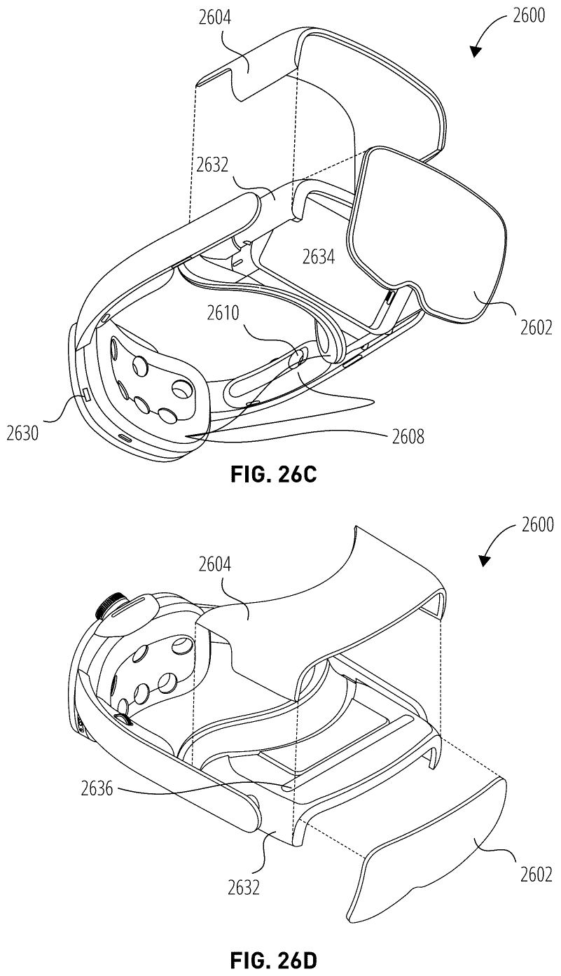

The user input systems 104 may include a wearable and/or portable user devices 106. A wearable or portable user device 106 may be a BCI device such as the BCI headset system 2600 described in greater detail with respect to FIG. 26A-FIG. 26D. The user device 106 may include extended reality (XR) glasses, an eye tracker, etc. The user device 106 may be capable of detecting and transmitting data for biosignal input 130. The biosignal input 130 may include data from EEG, ECOG, ECG or EKG, EMG, EOG, pulse, heart rate variability, blood sugar sensing, and dermal conductivity measurement devices. The biosignal input 130 may display characteristics indicative of the current cognitive load, fatigue, attention/distraction levels, mood, etc., of the user 102. In one embodiment, the biosignal input 130 may be processed and analyzed by a biosignals subsystem 2400 such as is described with respect to FIG. 24 or similar.

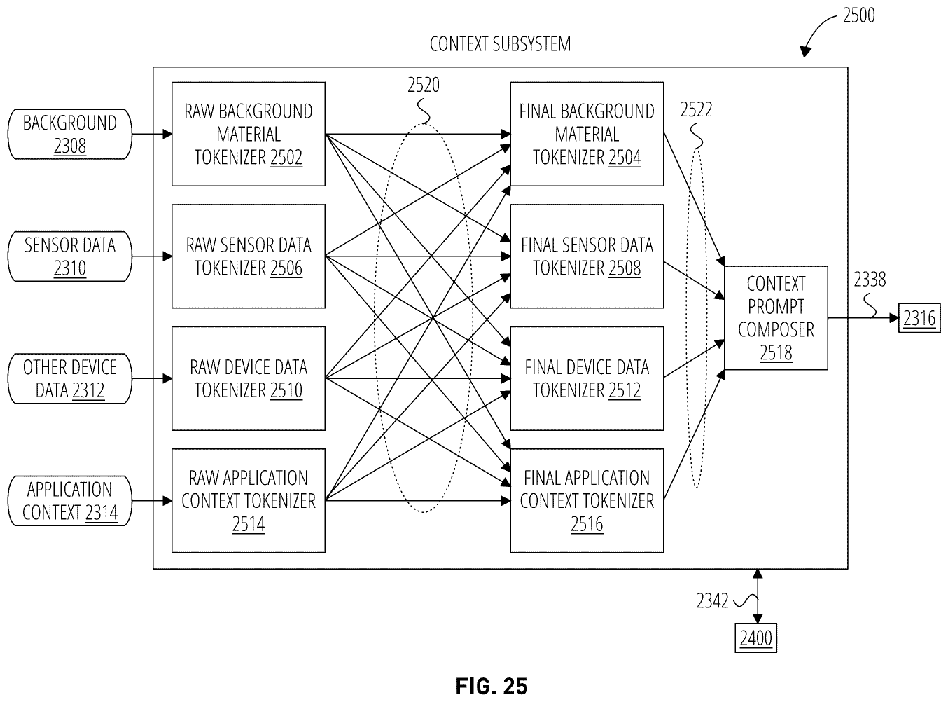

The user input system 104 may further include sensor 108 that collect and transmit sensor data 132. Sensor data 132 may include microphone output indicative of sound in the user's environment, temperature, air pressure, and humidity data from climactic sensors, etc., output from motion sensors, and a number of other sensing devices readily available and pertinent to the user's surroundings and desired application of the interactive system 100. Other device data may include camera output, either still or video, indicating visual data available from the user's surrounding environment, location information from a global positioning system device, date and time data, information available via a network based on the user's location, and data from a number of other devices readily available and of use in the desired application of the interactive system 100 and interaction framework 112. This sensor data 132 may be included as current context data 134, and may be processed and analyzed by a context subsystem 2500 such as is described with respect to FIG. 25 or similar.

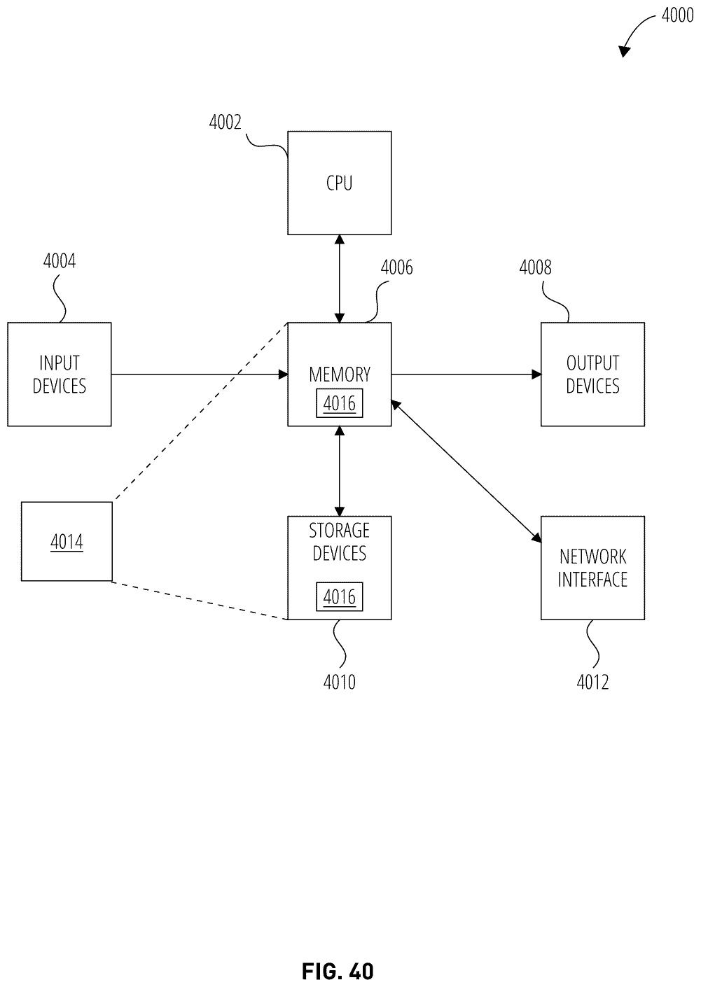

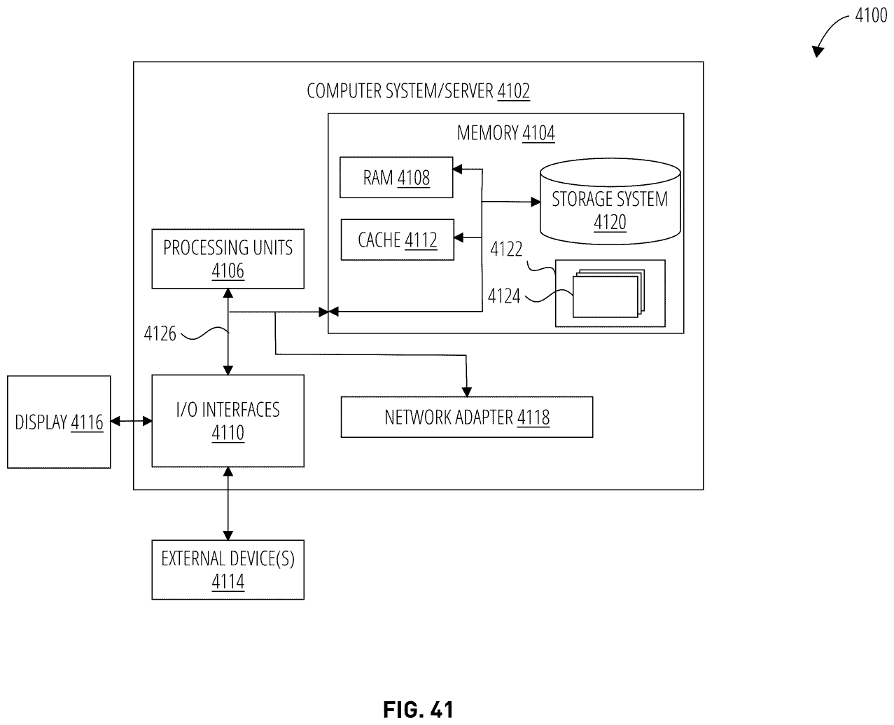

The computing device 110 may be integrated with the user device 106 in one embodiment. The computing device 110 may be a mobile computing device such as a smart phone, tablet, laptop or desktop computer, a server accessed through wired or wireless connection, etc. For example, the computing device 110 may be the computing device 4000 of FIG. 40. The computing device 110 may also be a cloud computing node 4100 such as is described with respect to FIG. 41.

The interaction framework 112 may include a classifier 114 and a context estimator 116. In one embodiment, elements of a biosignals subsystem may be implemented as the classifier 114. In one embodiment, elements of a context subsystem may be implemented as the context estimator 116 and the classifier 114. The interaction framework 112 may take in biosignal input 130 and a context estimation 136 and may determine an appropriate input modality or combination of input modalities to use in configuring a UI configuration 138. For example, the interaction framework 112 may interpret user attention and focus using brain signals from a BCI, head and eye tracking, switched or binary input devices, video cameras, microphones, etc.

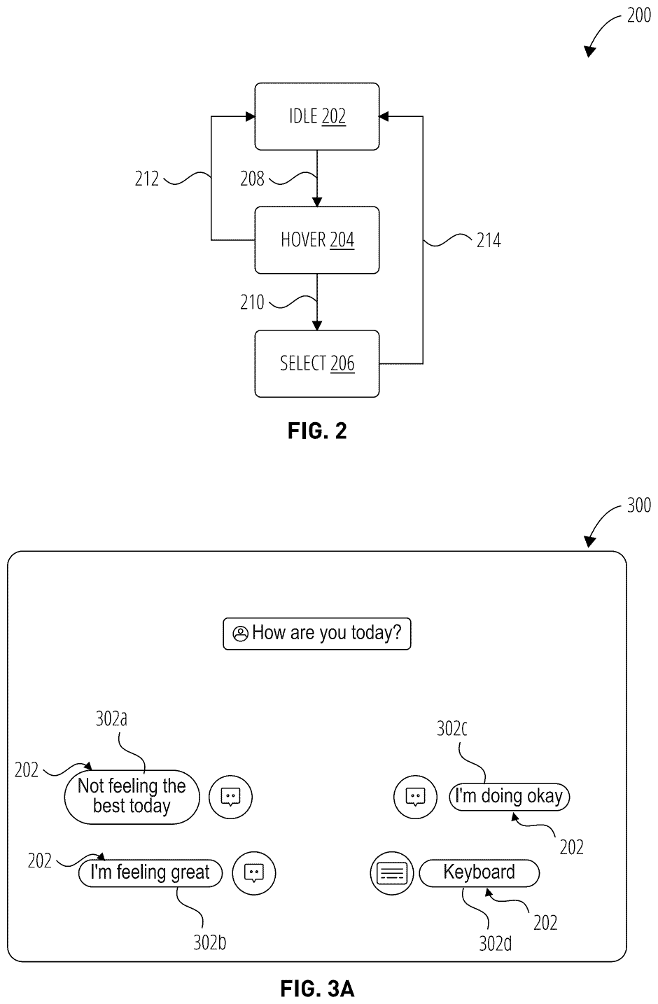

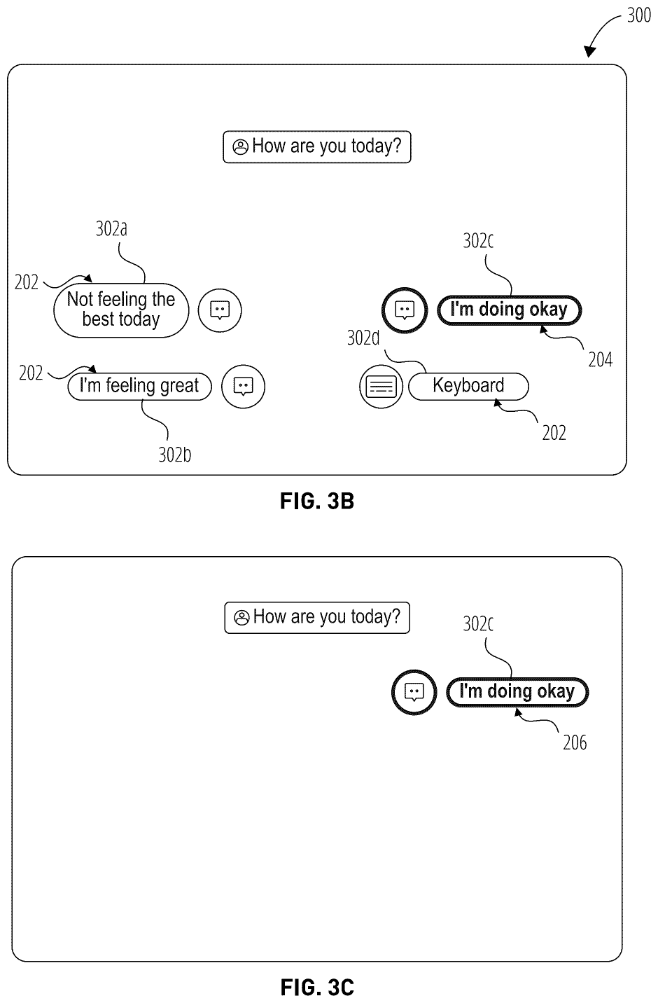

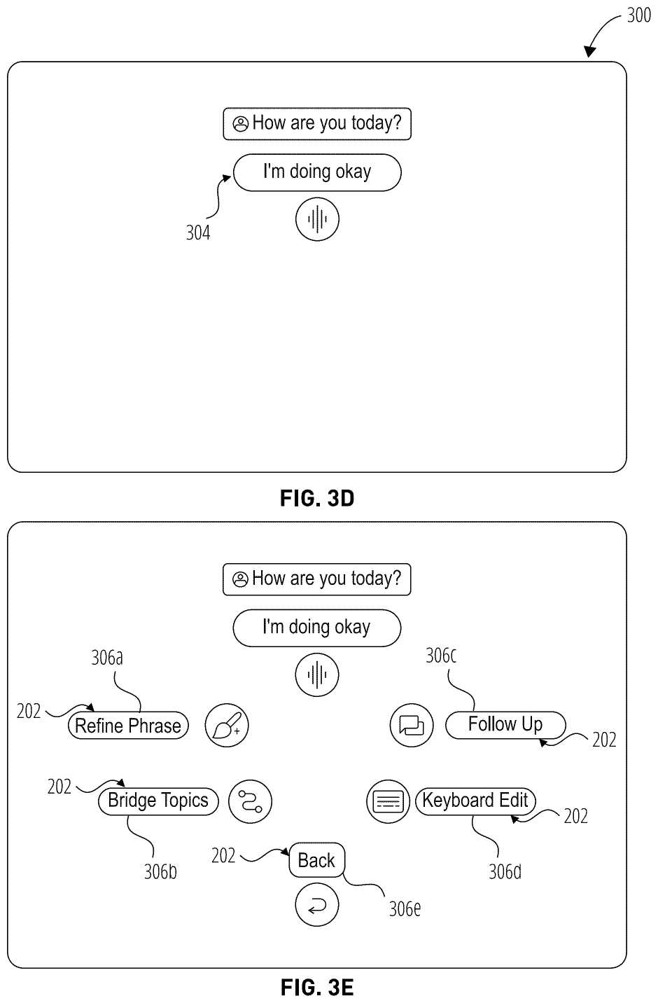

The UI configuration 138 may be configured to provide selection targets in three operating states, as described with respect to the exemplary selection target interaction operating states 200 of FIG. 2 and the exemplary selection target display outputs 300 of FIG. 3A-FIG. 3E. In this manner, the dynamic user interface 118 may accept the UI configuration 138 and provide output 142 to the user 102 in response to the user's biosignal input 130 and current context data 134, such as visual display 120 through a touchscreen, computer monitor, or the user device 106, audio sent through a speaker 122, etc. This may further permit the user 102 to interact with an agency assistive device such as a BCI headset system, a computing device, a robotic device, IoT devices 126 connected to a network, etc.

FIG. 2 illustrates exemplary selection target interaction operating states 200 supporting an interactive interaction framework, in accordance with one embodiment. The exemplary selection target interaction operating states 200 may comprise an idle state 202, a hover state 204, and a selected state 206.

The idle state 202 may be determined as the default state of a selection target presented to a user. The selection target may be presented by configured to prevent user interaction when in the idle state 202. Upon a first classification of a selection target 208 of a selection target in the idle state 202, the selection target may be placed in the hover state 204. The first classification of a selection target 208 may be made when a determination is made that a user is focusing their attention on that selection target. In one embodiment, the first classification may be made periodically at predetermined time intervals. In one embodiment, a first classification may be triggered by a sensor reading or other signal state resulting from a user action or mentation.

The hover state 204 may signify a user's focus of attention upon, and thus intention to interact with, the selection target. In the hover state 204, the selection target may be presented differently from other selection targets that remain in an idle state 202. For example, a selection target in the hover state 204 may be visualized in various ways that distinguish it from other selection targets, such as by changing its color or size, adding a ring around its perimeter, enhancing it with a glow effect, etc. Other configurations that may be sensed by a user as distinct from selection targets in an idle state 202 will readily suggest themselves to one of ordinary skill in the art.

A second classification may then be made with a selection target in the hover state 204. If this second classification is a second classification of the same selection target 210 as the selection target placed in the hover state 204 after the first classification, that selection target may then be placed in the selected state 206. If instead it is a second classification of a new selection target 212 (i.e., one in the idle state 202), the selection target in the hover state 204 may transition back to the idle state 202. In one embodiment, the second classification of a new selection target 212 may be used as a first classification of a selection target 208 for the new selection target. The second classification may in one embodiment be configured to be determined at a specified time interval after the first classification. In one embodiment, a second classification may be triggered by a sensor reading or other signal state resulting from a user action or mentation.

When a selection target enters the selected state 206, a specific action associated with that selection target may be determined to be desired by the user. That specific action may be performed as configured in support of the user's interaction with the intended selection target and thus their desired selected action or operation. Once the selected action is performed, or as part of the performance of the selected action, the selection target may undergo an automatic return to idle state 214.

In one embodiment, selection targets may be configured as inactive. An inactive target may be configured for a display design, but may not yet be displayed or may be displayed but unable to be interacted with. In BCI applications, an inactive selection target may be visible to a user, but may not be flashing at a preconfigured frequency, and thus interaction with the selection target may not be possible through the detection of brain-generated signals by the BCI.

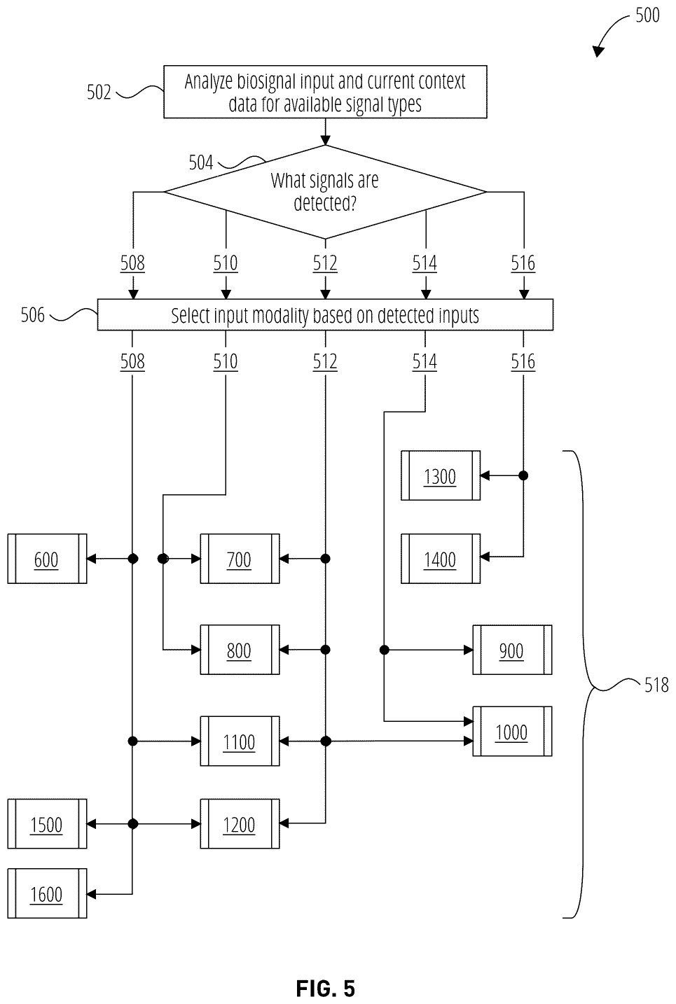

Note that the idle state may be different depending on the input modality detected by the interaction framework, as described in greater detail with respect to FIG. 5-FIG. 16. For example, with steady state visually evoked potentials (SSVEPs), the selection targets appear flashing when in the idle states 202. They may each flash at a distinct frequency so that signals detected by the BCI may be interpretable as user attention on a specific selection target. Specific idle behavior may be defined for each type of input modality accepted the interaction framework and supported by the elements of the interactive system 100.

See the examples below of exemplary selection target display outputs 300 for a BCI application that allows the user to respond to a question they have been asked by a conversational partner. Because it is set up using common interaction states, this interface may be adapted to work with various input modalities.

In some embodiments, input modality implies some type of automatic idle-to-hover transition. One embodiment with this functionality may include a switch controller where the idle-to-hover transition may be driven by a timer. In one embodiment, every idle target is hovered automatically and the biosignals are only used for the hover-to-select action.

In some embodiments, the system may receive a default state of each of the selection target display outputs from the interaction framework based at least in part on the biosignal input and the current context data. Then, the system may configure a user interaction option with an agency assistive device by identifying the selection target display outputs to the user.

FIG. 3A-FIG. 3E illustrate exemplary selection target display outputs 300 in accordance with one embodiment. Selection target display outputs may include buttons, modals, links, sliders, checkboxes, and other visual representations of user-selectable options or data provided to a user, as are well known to those or ordinary skill in the art. FIG. 3A shows selection targets 302a-302d in an idle state 202. The interface may present a question from a conversational partner, such as “How are you today?” A conversational partner may be a second human user communicating in person or remotely with a primary user such as the user 102 of FIG. 1. In one embodiment, the conversational partner may be an AI powered chatbot.

Targets in the idle state may have a default visual appearance indicating that the user is not currently interacting with them, but interaction with these targets may be possible. For example, selection targets 302a-302d may each be flashing at a different frequency.

FIG. 3B shows selection target 302c, reading “I'm doing okay” in a hover state 204. The user may have directed their visual attention upon selection target 302c, which may have led to a change in in their brainwave signals detectable by a BCI. Upon detection of this change, the system may have made the first classification that placed selection target 302c in the hover state.

FIG. 3C shows selection target 302c reading “I'm doing okay” in a selected state 206. This may be a result of a second classification indicating that selection target 302c was still the user's focus of attention, based on the pattern of their brainwaves as detected by a BCI, or through some other method of user attention detection, as are discussed in greater detail later in this disclosure.

FIG. 3D shows the resulting action 304 of selection target 302c entering the selected state 206. In this example, the resulting action 304 is the display of the text “I'm doing okay” via the display in response to the conversational partner's question of “How are you today?” Another display configuration may then be displayed, as shown in FIG. 3E, in which selection targets 306a-306e are shown, each in an idle state 202. In this manner, multiple cycles of question and response may be facilitated by user interaction with exemplary selection target display outputs 300 operable through exemplary selection target interaction operating states 200 supported by the interactive system 100.

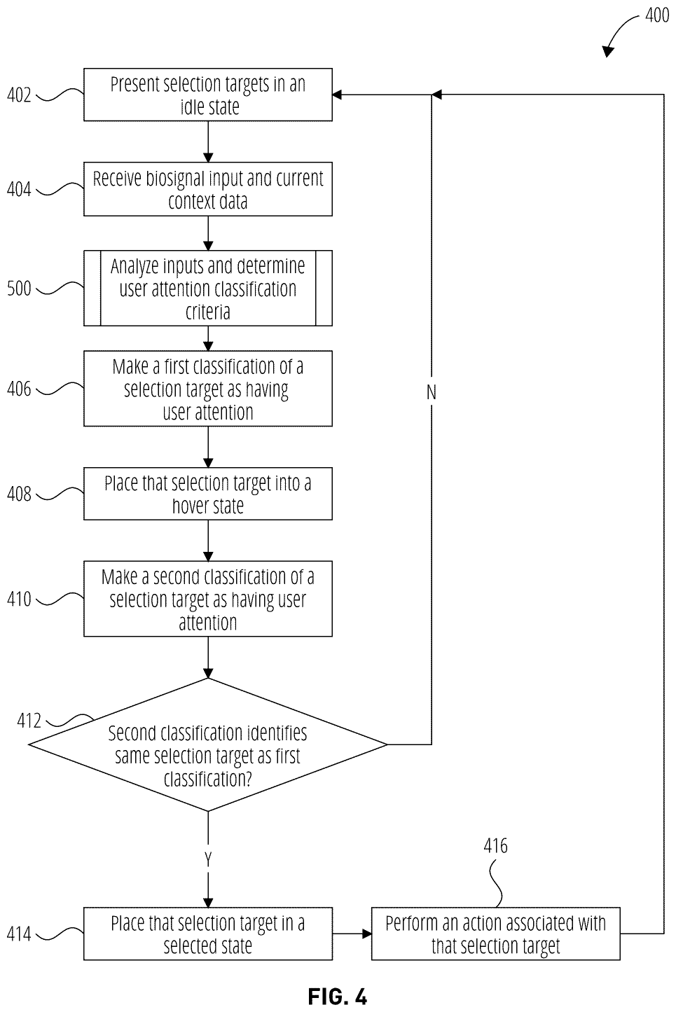

FIG. 4 illustrates a user interaction routine 400 in accordance with one embodiment. The user interaction routine 400 may be performed by elements of the interactive system 100 described above. This user interaction routine 400 represents a general flow of the interaction states, and may be followed by systems supporting a number of input types. Although the example user interaction routine 400 depicts a particular sequence of operations, the sequence may be altered without departing from the scope of the present disclosure. For example, some of the operations depicted may be performed in parallel or in a different sequence that does not materially affect the function of the user interaction routine 400. In other examples, different components of an example device or system that implements the user interaction routine 400 may perform functions at substantially the same time or in a specific sequence.

According to some examples, the method includes presenting selection targets in an idle state at block 402. For example, the dynamic user interface 118 illustrated in FIG. 1 may present selection targets in an idle state. The system may be listening for a preconfigured “wake word” type of biosignal input indicating user attention or desire to interact. In another embodiment, the system may present choices to the user and be expecting user interaction. In one embodiment, the system may present selection targets based on a context estimation derived from the current context data. The idle state indicates that the selection targets are all unselected.

According to some examples, the method includes receiving biosignal input and current context data at block 404. For example, the classifier 114 illustrated in FIG. 1 may receive biosignal input and current context data. The biosignal input may include data indicating that the user desires to interact. The user interaction routine 400 may enter an input analysis and attention determination subroutine 500 upon receiving the biosignal input and current context data.

According to some examples, the method includes making a first classification of a selection target as having user attention at block 406. For example, the classifier 114 illustrated in FIG. 1 may make a first classification of a selection target as having user attention. Classifications may be made subject to attaining a threshold confidence level estimate as a function of the input modality determined by the input analysis and attention determination subroutine 500. The input analysis and attention determination subroutine 500 may include subroutines to specify the parameters by which the first classification and second classification may be determined. This process is described in greater detail with respect to FIG. 5-FIG. 16.

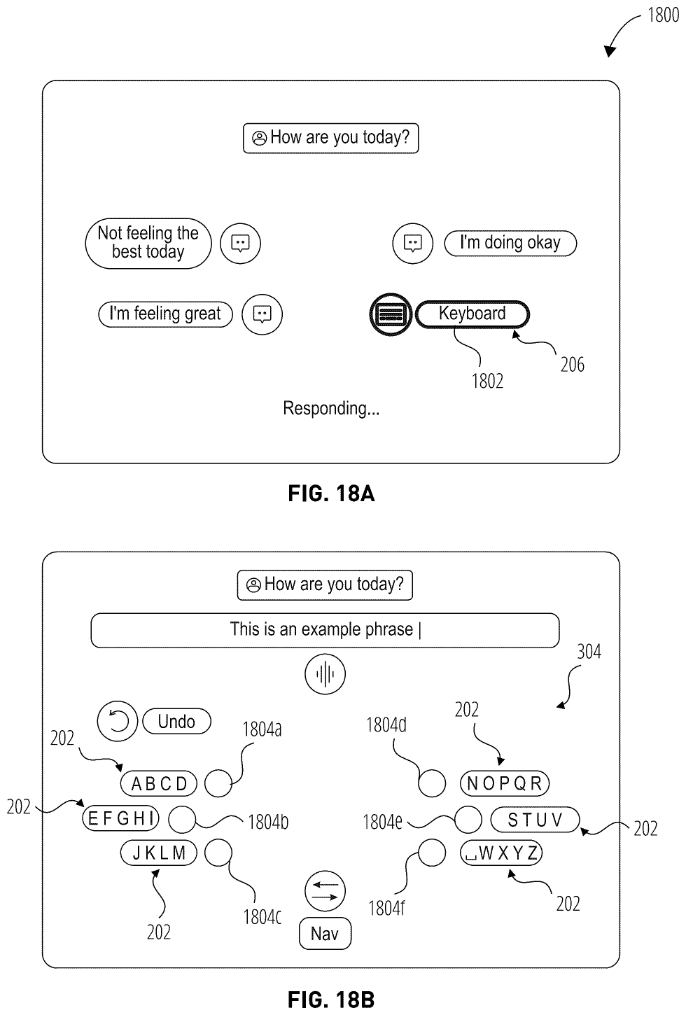

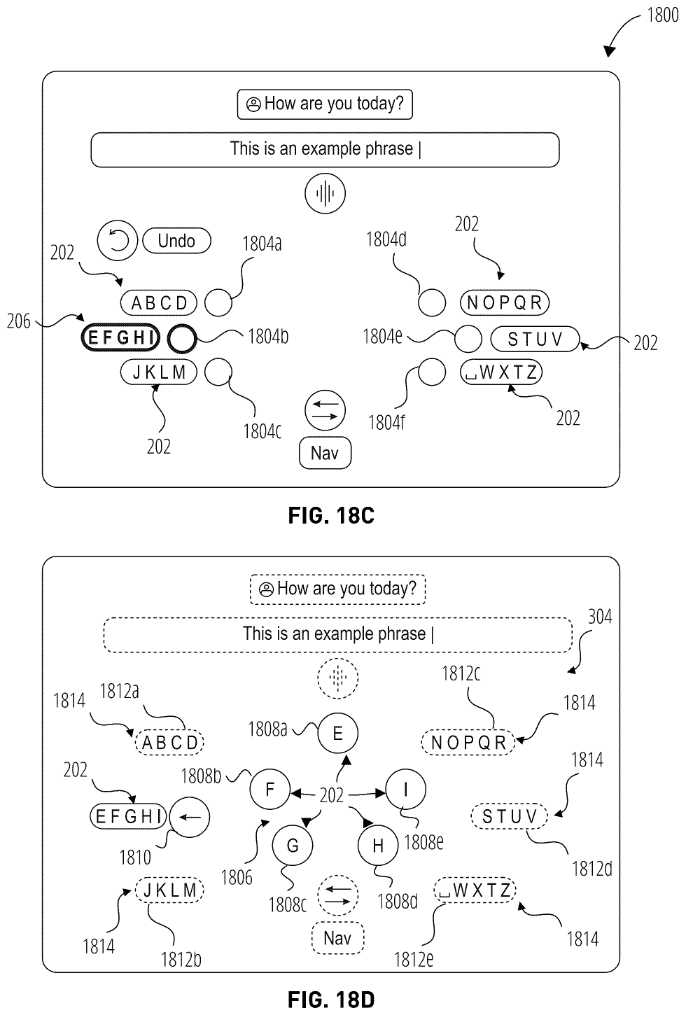

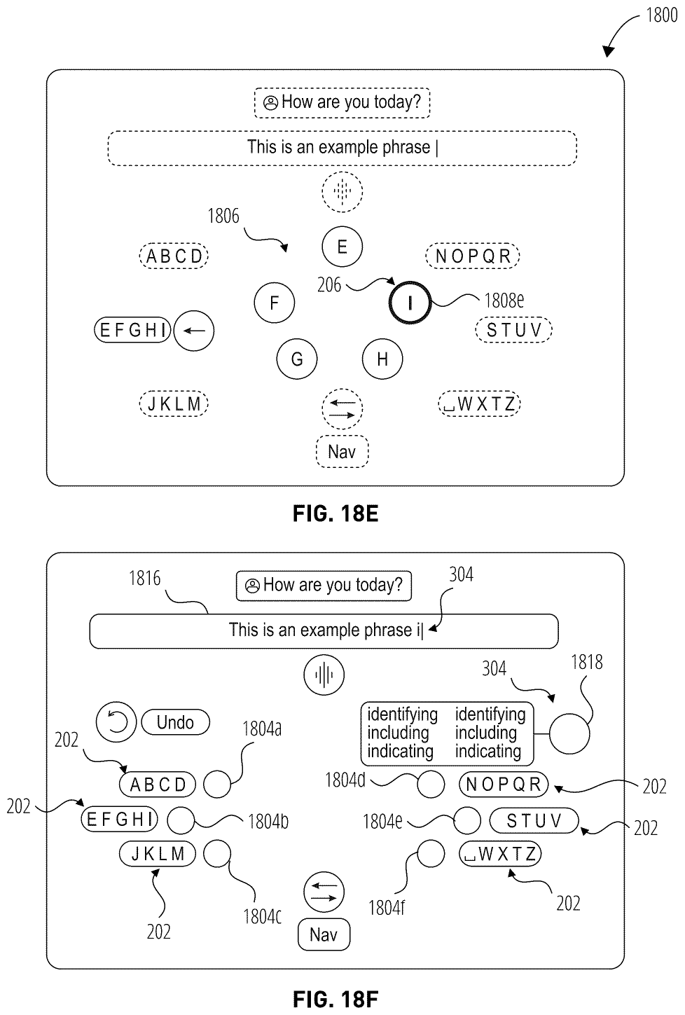

According to some examples, the method includes placing that selection target into a hover state at block 408. For example, the dynamic user interface 118 illustrated in FIG. 1 may place that selection target into a hover state. In some embodiments, the hover state may be a modal submenu. This is illustrated with respect to FIG. 18A-FIG. 18F

According to some examples, the method includes making a second classification of a selection target as having user attention at block 410. For example, the classifier 114 illustrated in FIG. 1 may make a second classification of a selection target as having user attention.

According to some examples, the method includes determining whether the second classification identifies the same selection target as the first classification at decision block 412. If it does, the method includes placing that selection target in a selected state at block 414. For example, the dynamic user interface 118 illustrated in FIG. 1 may place that selection target in a selected state. If it does not, the user interaction routine 400 returns to block 402, with the selection targets presented in an idle state.

According to some examples, the method includes performing an action associated with that selection target at block 416. For example, the dynamic user interface 118 illustrated in FIG. 1 may perform an action associated with that selection target. Once the action has been completed and the modal submenu closed, this routine may return to presenting selection targets in an idle state as described for block 402.

In one embodiment, an interactive system 100 may perform the user interaction routine 400 by presenting selection targets in the idle state, analyzing the biosignal inputs and the current context data to determine user attention classification criteria, making a first classification of a first selection target as having user attention, placing the first selection target having user attention into the hover state, making a second classification of a second selection target as having the user attention, and, on condition the second selection target is the same as the first selection target, placing the first selection target in the selected state, and performing an action associated with the first selection target, while on condition the second selection target is different from the first selection target, placing the first selection target in the idle state. Other technical features may be readily apparent to one skilled in the art from the figures, descriptions, and claims disclosed herein.

FIG. 5 illustrates an input analysis and attention determination subroutine 500 in accordance with one embodiment. Although the example input analysis and attention determination subroutine 500 depicts a particular sequence of operations, the sequence may be altered without departing from the scope of the present disclosure. For example, some of the operations depicted may be performed in parallel or in a different sequence that does not materially affect the function of the input analysis and attention determination subroutine 500. In other examples, different components of an example device or system that implements the input analysis and attention determination subroutine 500 may perform functions at substantially the same time or in a specific sequence.

According to some examples, the method includes analyzing biosignal input and current context data for available signal types at block 502. For example, the classifier 114 illustrated in FIG. 1 may analyze biosignal input and current context data for available signal types. Available signal types may include signals from a BCI, signals from eye or head tracking devices, signals from a binary or switch device, and signals from other sensors, including but not limited to cameras, microphones, wearable monitors, and other devices disclosed herein.

According to some examples, the method includes determining what input signals are detected as providing the biosignal input and current context data at decision block 504. Based on this determination, one or more input modalities may be selected for use in making input classifications at block 506. The appropriate input modality(ies) may be determined algorithmically and may select among available inputs based on received user biosignal inputs and current context data. In one embodiment, multiple input modalities may be used at a time. In this manner, different types of biosignals may reinforce a classification or indicate a need for clarification.

Input modalities may be detected from inputs such as neuro-signals 508, head position data 510, eye position data 512, binary input data 514, radial gesture data 516, and similar inputs to the interactive system 100. Routines based on input modality or combinations of input modalities 518 may be performed as a result of the input modalities determined at block 506.

Where neuro-signals 508 are detected at decision block 504, a BCI signal input modality may be selected at block 506, and a BCI classification routine 600, BCI binary input classification routine 1500, or BCI binary input classification routine 1600 may be performed.

Where head position data 510 and/or eye position data 512 are detected at decision block 504, a head or eye position input modality may be selected at block 506, and a head or eye tracking classification routine 700 or head or eye tracking classification routine 800 may be performed. Where binary input data 514 are detected at decision block 504, a binary or switched input modality may be selected at block 506, and a binary input classification routine 900 may be performed. Where eye position data 512 and binary input data 514 are detected at decision block 504, an eye position input plus binary input modality may be selected at block 506, and an eye tracking and binary input classification routine 1000 may be performed. Where neuro-signal 508 and eye position data 512 are detected at decision block 504, an eye position in put plus BCI input modality may be selected at block 506, and an eye tracking and BCI classification routine 1100 or eye tracking and BCI classification routine 1200 may be performed. Where radial gesture data 516 are detected at decision block 504, a radial gesture input modality may be selected at block 506, and a radial gesture classification routine 1300 or radial gesture classification routine 1400 may be performed.

FIG. 6 illustrates a BCI classification routine 600 in accordance with one embodiment. Although the example BCI classification routine 600 depicts a particular sequence of operations, the sequence may be altered without departing from the scope of the present disclosure. For example, some of the operations depicted may be performed in parallel or in a different sequence that does not materially affect the function of the BCI classification routine 600. In other examples, different components of an example device or system that implements the BCI classification routine 600 may perform functions at substantially the same time or in a specific sequence.

According to some examples, the method includes determining first classification criteria as user focus on a selection target detected from BCI signals at block 602. According to some examples, the method includes determining second classification criteria as user focus on a selection target detected from BCI signals at block 604. In one embodiment, user focus on a selection target may be indicated by the user performing one of a set of known and expected brain gestures.

In this manner, the user may focus their attention on a desired selection target to place it in the hover state, and continue to focus on or re-focus on the same target to place it in the selected state. In one embodiment, SSVEP BCI targets may not be visible or may be displayed but not flashing when inactive. The selection targets may be displayed as flashing at different frequencies in an idle state, making interaction with them detectable by analyzing frequencies of signals detected by the BCI. BCI signal frequencies indicating attention to a particular selection target may result in that selection target changing to the hover state. A reexamination of BCI signals may result in the selection target entering the selection state if the same target is still detected, or a return to the idle state if the BCI signals indicate user attention shifted to a different selection target.

In one embodiment, a BCI device may support multiple simultaneous categorical classifications. The user in this case may be able to utilize an analogous model to that presented above for SSVEP. In this case, the BCI device(s) may generate two or more distinct, categorical outputs based on a user's brain gestures. In alternate embodiments, these categorical outputs may be derived from a combination of two or more biosensing devices.

In this manner, categorical signals received by the BCI may be interpretable as associated with a known brain gesture, which may be configured to correspond to a selection target. User focus may then be detected as the performance of the appropriate brain gesture by the user, and this gesture being detected at the first classification, placing the indicated selection target into hover state. At the time of a second classification the same brain gesture may be determined, and the selection target in hover state may be placed into selected state. Thus the BCI classification routine 600 may allow a user to interact with their environment as using a single, BCI-type device.

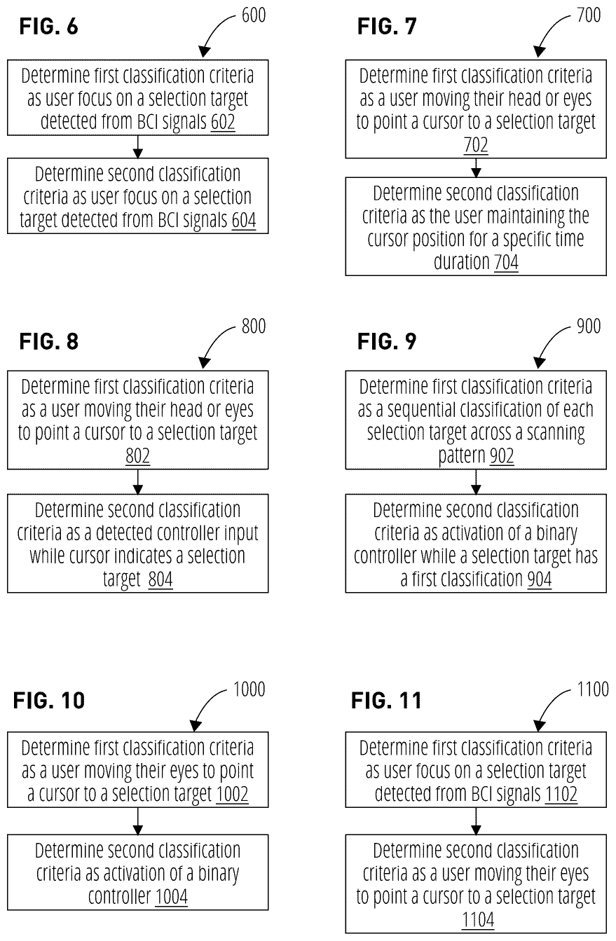

FIG. 7 illustrates a head or eye tracking classification routine 700 in accordance with one embodiment. Although the example head or eye tracking classification routine 700 depicts a particular sequence of operations, the sequence may be altered without departing from the scope of the present disclosure. For example, some of the operations depicted may be performed in parallel or in a different sequence that does not materially affect the function of the head or eye tracking classification routine 700. In other examples, different components of an example device or system that implements the head or eye tracking classification routine 700 may perform functions at substantially the same time or in a specific sequence.

According to some examples, the method includes determining first classification criteria as a user moving their head or eyes to point a cursor to a selection target at block 702. Movement of a user's head or eyes in the x and y dimensions that are coplanar with the display plane of a display device may be detected and used to position a mouse-like cursor with respect to selection targets shown on the display device. Each selection target may include a target zone within which placement of the cursor may be interpreted as user attention.

According to some examples, the method includes determining second classification criteria as the user maintaining the cursor position for a specific time duration at block 704. The specific time duration may be preconfigured as, for example, one second of the cursor being still within a target zone. In one embodiment, where a user's eye motion is tracked, a pattern or number of eyelid blinks may be used as the criteria for second classification. In this manner, a user may select a desired selection target by moving their eyes or head to point a curser at it to place it in a hover state, then maintain that cursor position until the selection target enters the selected state, blink to place it in the selected state, or some combination thereof.

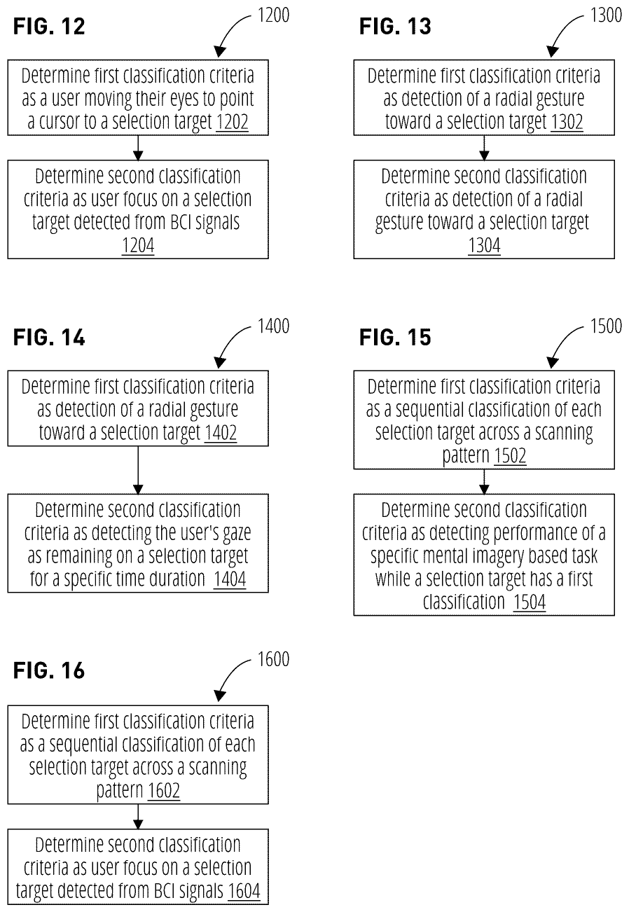

Selection targets in idle state may have a default visual appearance indicating the user is not currently interacting with them, but interaction is possible. This is a common interaction method, which may be extended and may benefit from the addition of BCI as described with respect to FIG. 11 and FIG. 12 below. The head or eye tracking classification routine 700 may allow a user to indicate their attention or focus on a desired selection target using body pose data, which may be mapped into X-Y coordinates.

FIG. 8 illustrates a head or eye tracking classification routine 800 in accordance with one embodiment. Although the example head or eye tracking classification routine 800 depicts a particular sequence of operations, the sequence may be altered without departing from the scope of the present disclosure. For example, some of the operations depicted may be performed in parallel or in a different sequence that does not materially affect the function of the head or eye tracking classification routine 800. In other examples, different components of an example device or system that implements the head or eye tracking classification routine 800 may perform functions at substantially the same time or in a specific sequence.

According to some examples, the method includes determining first classification criteria as a user moving their head or eyes to point a cursor to a selection target at block 802.

According to some examples, the method includes determining second classification criteria as a detected controller input while cursor indicates a selection target at block 804.

The detected controller input may be a signal from a keyboard, gamepad, touch screen, etc. indicating a key or button press, a screen tap, or some other user interaction with a controller configured to communicate with the interaction framework. In this manner, a user may use eye motion or head motion to hover a cursor over a desired selection target, then press, click, or otherwise interact with a control mechanism to place the selection target in the selected state. In another embodiment, BCI may be combined with a binary controller. This includes determining first classification from user focus on a selection target detected from BCI signals, and determining second classification from activation of a binary controller. In such a case the hover state may be determined by BCI signals, and binary controller activation may be used to move the hovered target into the selected state.

In this interaction method, the eyes may be used for targeting (looking at the desired target) through interpretation of X-Y eye tracking data interpreted from signals from an eye tracking device. A binary controller may be used to confirm selection. BCI may be used as a binary input to select a currently hovered target as described in greater detail below. stpOther forms of BCI, such as mental imagery, may be used in a similar way.

FIG. 9 illustrates a binary input classification routine 900 in accordance with one embodiment. Although the example binary input classification routine 900 depicts a particular sequence of operations, the sequence may be altered without departing from the scope of the present disclosure. For example, some of the operations depicted may be performed in parallel or in a different sequence that does not materially affect the function of the binary input classification routine 900. In other examples, different components of an example device or system that implements the binary input classification routine 900 may perform functions at substantially the same time or in a specific sequence.

According to some examples, the method includes determining first classification criteria as a sequential classification of each selection target across a scanning pattern at block 902. Each displayed selection target may be identified by a first classification and placed in the hover state in turn, and a new first classification may be made after a preconfigured time period if no additional activity is detected, placing a new selection target in the hover state.

According to some examples, the method includes determining second classification criteria as activation of a binary controller while a selection target has a first classification at block 904. The binary controller may be a switch having an off and an on position, a clicker, button, or other device that sends a signal when activated and sends no signal when left alone, or other similar devices as are well known by those of ordinary skill in the art. In one embodiment, the binary controller may utilize a binary biosignal, such as an EMG threshold, detectable using a wearable or implantable neurosensory device. In this manner, a user may observe the selection targets provided each enter the hover state in turn. The user may then interact with the binary controller when their desired selection target is in the hover state, thereby triggering a second classification that may place that selection target into the selected state. In another embodiment combining BCI with binary controller, BCI signals may be used to perform a set of specific navigational controls or actions, such as moving the hover state to the next target in a sequence of non-BCI targets (not flashing). Non-BCI targets may then be activated using binary controller, or by focusing on a specific BCI target used for performing an activation of the current hovered target. This approach may be beneficial when larger numbers of targets are needed in a UI, but it is not necessary to have all of them be active (flashing) BCI targets. In another embodiment, multiple binary controllers may be used for added abilities like navigating or performing specific actions. For example, one binary controller may be activated to move classification to the next target in a sequence, while a second binary controller may be activated to move classification to the previous target in a sequence. This may be combined with another type of input, such as BCI, which could be used for second classification.

FIG. 10 illustrates an eye tracking and binary input classification routine 1000 in accordance with one embodiment. Although the example eye tracking and binary input classification routine 1000 depicts a particular sequence of operations, the sequence may be altered without departing from the scope of the present disclosure. For example, some of the operations depicted may be performed in parallel or in a different sequence that does not materially affect the function of the eye tracking and binary input classification routine 1000. In other examples, different components of an example device or system that implements the eye tracking and binary input classification routine 1000 may perform functions at substantially the same time or in a specific sequence.

According to some examples, the method includes determining first classification criteria as a user moving their eyes to point a cursor to a selection target at block 1002. According to some examples, the method includes determining second classification criteria as activation of a binary controller at block 1004.

In this manner, the user may move a cursor through eye motion into a target zone of a desired selection target to place it in the hover state. The user may then interact with a binary controller to place the hovered selection target in the selected state. In one embodiment, the hover state may be maintained for a preconfigured time even if the user moves their eyes. In another embodiment, eye motion may place the selection targets back into an idle state. In one embodiment, the BCI may be used as a binary controller. This is described in greater detail below with respect to FIG. 15 and FIG. 16.

FIG. 11 illustrates an eye tracking and BCI classification routine 1100 in accordance with one embodiment. Although the example eye tracking and BCI classification routine 1100 depicts a particular sequence of operations, the sequence may be altered without departing from the scope of the present disclosure. For example, some of the operations depicted may be performed in parallel or in a different sequence that does not materially affect the function of the eye tracking and BCI classification routine 1100. In other examples, different components of an example device or system that implements the eye tracking and BCI classification routine 1100 may perform functions at substantially the same time or in a specific sequence.

According to some examples, the method includes determining first classification criteria as user focus on a selection target detected from BCI signals at block 1102. According to some examples, the method includes determining second classification criteria as a user moving their eyes to point a cursor to a selection target at block 1104.

In this manner, the user may focus their attention on a particular idle selection target, placing it in a hover state. The user may then move their eyes to control a cursor, placing the cursor on the desired selection target. Where the same target is indicated by both the first and second classification, the selected selection target may be placed in the selected state.

SSVEP BCI targets may be inactive and not flashing. These selection targets may flash upon entering idle state and may thus become interactable in this state. X-Y eye tracking data and brain sensor data may be used in the eye tracking and BCI classification routine 1100 to place a selection target in an idle state into at least one other state.

FIG. 12 illustrates an eye tracking and BCI classification routine 1200 in accordance with one embodiment. Although the example eye tracking and BCI classification routine 1200 depicts a particular sequence of operations, the sequence may be altered without departing from the scope of the present disclosure. For example, some of the operations depicted may be performed in parallel or in a different sequence that does not materially affect the function of the eye tracking and BCI classification routine 1200. In other examples, different components of an example device or system that implements the eye tracking and BCI classification routine 1200 may perform functions at substantially the same time or in a specific sequence.

According to some examples, the method includes determining first classification criteria as a user moving their eyes to point a cursor to a selection target at block 1202. According to some examples, the method includes determining second classification criteria as user focus on a selection target detected from BCI signals at block 1204.

In this manner, a user may send an idle selection target to the hover state through their eye motion. If a user's focus is detected upon the same object when the second classification is made, that target will transition from the hover state to the selected state. In one embodiment, eye tracking may be combined with BCI in such a way that one classification is needed.

FIG. 13 illustrates a radial gesture classification routine 1300 in accordance with one embodiment. Although the example radial gesture classification routine 1300 depicts a particular sequence of operations, the sequence may be altered without departing from the scope of the present disclosure. For example, some of the operations depicted may be performed in parallel or in a different sequence that does not materially affect the function of the radial gesture classification routine 1300. In other examples, different components of an example device or system that implements the radial gesture classification routine 1300 may perform functions at substantially the same time or in a specific sequence.

According to some examples, the method includes determining first classification criteria as detection of a radial gesture toward a selection target at block 1302. A radial gesture may be considered any detectable motion from a central location to a more peripheral location along a vector. In one embodiment, a radial gesture may be detected as eye movement from a position of looking straight ahead to a position of looking upward and rightward to the upper right corner of a display.

According to some examples, the method includes determining second classification criteria as detection of a radial gesture toward a selection target at block 1304. In one embodiment, the second classification may result in a transition from hover state to selected state of the selection target of the first classification when the radial gesture of the second classification indicates the same selection target. In one embodiment, the target of the second classification may be a “confirm action” selection target in order to put the selection target of the first classification into a selected state. In this manner, a user may select an action by making controlled radial gestures with their eyes, head, hands, etc., to select a desired action from among those presented as selection targets.

Radial gesture interactions may be thought of as similar to detecting macro-level movements of the eyes and assigning meaning or actions to be triggered by moving in specific directions (such as up, down, left, right, diagonal). In this manner, selection targets may be transitioned to different states in one embodiment using uncalibrated eye tracking data, including eye tracking velocity and vectors/gestures.

FIG. 14 illustrates a radial gesture classification routine 1400 in accordance with one embodiment. Although the example radial gesture classification routine 1400 depicts a particular sequence of operations, the sequence may be altered without departing from the scope of the present disclosure. For example, some of the operations depicted may be performed in parallel or in a different sequence that does not materially affect the function of the radial gesture classification routine 1400. In other examples, different components of an example device or system that implements the radial gesture classification routine 1400 may perform functions at substantially the same time or in a specific sequence.

According to some examples, the method includes determining first classification criteria as detection of a radial gesture toward a selection target at block 1402. According to some examples, the method includes determining second classification criteria as detecting the user's gaze as remaining on a selection target for a specific time duration at block 1404.

In this manner, a user may indicate a desired selection target by performing a radial gesture of the eyes toward a desired selection target, then fixing the eyes upon that target. Similarly, radial gestures of the head or hand toward, followed by maintaining a position indicative of, the desired selection target. Embodiments may use a dwell time, such as when the user remains looking in a specific direction, to confirm a selection. This may be detected through incorporating X-Y position of eye gaze among the inputs analyzed.

FIG. 15 illustrates a BCI binary input classification routine 1500 in accordance with one embodiment. Although the example BCI binary input classification routine 1500 depicts a particular sequence of operations, the sequence may be altered without departing from the scope of the present disclosure. For example, some of the operations depicted may be performed in parallel or in a different sequence that does not materially affect the function of the BCI binary input classification routine 1500. In other examples, different components of an example device or system that implements the BCI binary input classification routine 1500 may perform functions at substantially the same time or in a specific sequence.

According to some examples, the method includes determining first classification criteria as a sequential classification of each selection target across a scanning pattern at block 1502. According to some examples, the method includes determining second classification criteria as detecting performance of a specific mental imagery based task while a selection target has a first classification at block 1504.

In this manner, a user may perform a mental imagery based task when a desired selection target is in the hover state to transition that target to the selected state. A mental imagery based task may include imagining a physical action or performing a specific thought pattern. Thus BCI may be used as a binary input to select the currently hovered target. SEP For example, if using SSVEP, the scanning pattern may determine which stimulus is currently active (flashing). Classification may determine if the user is focusing on the active stimuli enough to make a selection. SEP′

Other forms of BCI, such as implantable BCI and BCI that uses mental imagery or P300, may be used in a similar way, but without the need for stimuli. A more detailed example of this is provided below For implantable, non-stimuli based BCI, a unique flow that does not involve flashing may be implemented. For types of BCI that do not rely on stimuli, such as implantable BCI or mental imagery based BCI, a specific mental task may be performed to trigger an action such as selection. Gesture, as used throughout this disclosure, may be defined as a ‘time-based’ analog input to a digital interface, and may include, but not be limited to, time-domain (TD) biometric data from a sensor, motion tracking data from a sensor or camera, direct selection data from a touch sensor, orientation data from a location sensor, and may include the combination of time-based data from multiple sensors.

FIG. 16 illustrates a BCI binary input classification routine 1600 in accordance with one embodiment. Although the example BCI binary input classification routine 1600 depicts a particular sequence of operations, the sequence may be altered without departing from the scope of the present disclosure. For example, some of the operations depicted may be performed in parallel or in a different sequence that does not materially affect the function of the BCI binary input classification routine 1600. In other examples, different components of an example device or system that implements the BCI binary input classification routine 1600 may perform functions at substantially the same time or in a specific sequence.

According to some examples, the method includes determining first classification criteria as a sequential classification of each selection target across a scanning pattern at block 1602. According to some examples, the method includes determining second classification criteria as user focus on a selection target detected from BCI signals at block 1604. In this manner, a user may focus upon a desired selection target, and when that target has been placed in the hover state, detection of the user's attention may transition that target to the selected state.

BCI may thus be used as a binary input to select the currently hovered target. spil example, if using SSVEP, the scanning pattern may determine which stimulus is currently active (flashing). Classification may determine if the user is focusing on the active stimuli enough to make a selection. sEpisEp Other forms of BCI, such as mental imagery or P300, may be used in a similar way.

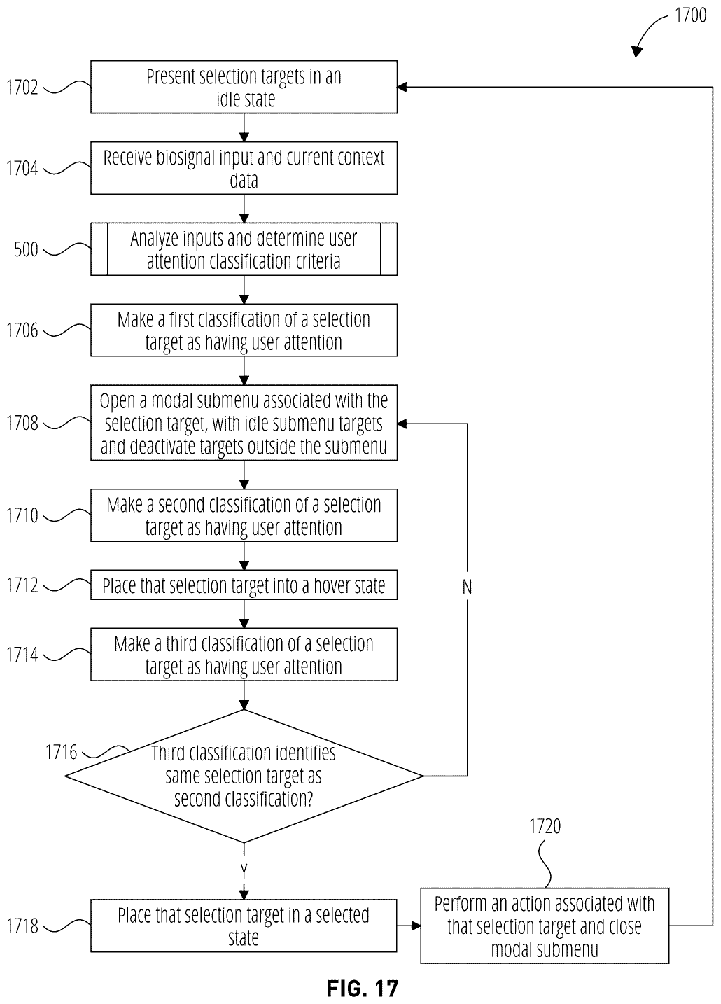

FIG. 17 illustrates a routine for modal submenu selection targets 1700 in accordance with one embodiment. Although the example routine for modal submenu selection targets 1700 depicts a particular sequence of operations, the sequence may be altered without departing from the scope of the present disclosure. For example, some of the operations depicted may be performed in parallel or in a different sequence that does not materially affect the function of the routine for modal submenu selection targets 1700. In other examples, different components of an example device or system that implements the routine for modal submenu selection targets 1700 may perform functions at substantially the same time or in a specific sequence.

According to some examples, the method includes presenting selection targets in an idle state at block 1702. For example, the interaction framework 112 illustrated in FIG. 1 may present selection targets in an idle state. The system may be listening for a preconfigured “wake word” type of biosignal input indicating user attention or desire to interact. In another embodiment, the system may present choices to the user and be expecting user interaction. In one embodiment, the system may present selection targets based on a context estimation derived from the current context data. The idle state indicates that the selection targets are all unselected.

According to some examples, the method includes receiving biosignal input and current context data at block 1704. For example, the interaction framework 112 illustrated in FIG. 1 may receive biosignal input and current context data. The biosignal input may include data indicating that the user desires to interact.

According to some examples, the method includes analyzing inputs and determining user attention classification criteria at input analysis and attention determination subroutine 500. For example, the interaction framework 112 illustrated in FIG. 1 may analyze inputs and determine user attention classification criteria. This process is described in greater detail with respect to FIG. 5-FIG. 16.

According to some examples, the method includes making a first classification of a selection target as having user attention at block 1706. For example, the classifier 114 illustrated in FIG. 1 may make a first classification of a selection target as having user attention.

According to some examples, the method includes opening a modal sub menu associated with the selection target, with idle submenu targets and deactivate targets outside the submenu at block 1708. According to some examples, the method includes making a second classification of a selection target as having user attention at block 1710.

According to some examples, the method includes placing that selection target into a hover state at block 1712. For example, the interaction framework 112 illustrated in FIG. 1 may place that selection target into a hover state. In some embodiments, the hover state may be a modal submenu.

According to some examples, the method includes making a third classification of a selection target as having user attention at block 1714. While FIG. 6-FIG. 16 describe the determination of first and second classifications, it may be readily understood by one of ordinary skill in the art how a third classification and additional classification levels may be similarly determined as needed.

According to some examples, the method includes Third classification identifies same selection target as second classification at decision block 1716. According to some examples, the method includes placing that selection target in a selected state at block 1718. For example, the interaction framework 112 illustrated in FIG. 1 may place that selection target in a selected state.

According to some examples, the method includes performing an action associated with that selection target and close modal submenu at block 1720. For example, the interactive system 100 illustrated in FIG. 1 may perform an action associated with that selection target and close modal submenu. Once the action has been completed and the modal submenu closed, this routine may return to presenting selection targets in an idle state as described for block 1702. One of ordinary skill in the art will readily apprehend that the steps of this routine may be augmented, rearranged, and iterated to provide multiple nested layers of selection targets configured to support a user in requesting a desired action be completed. FIG. 18A-FIG. 18F show an exemplary keyboard application that uses a modal submenu implementation such as the routine for modal submenu selection targets 1700 to assist a user in typing a response.

In one embodiment, the routine for modal submenu selection targets 1700 may be performed by an interactive system 100 by presenting selection targets in the idle state, analyzing the biosignal inputs and the current context data to determine user attention classification criteria, making a first classification of a first selection target as having user attention, opening a modal submenu associated with the first selection target, with submenu selection targets in the idle state and deactivating selection targets outside the modal submenu, making a second classification of a first submenu selection target as having the user attention, placing the first submenu selection target in the hover state, making a third classification of a second submenu selection target as having the user attention, and, on condition the first submenu selection target is the same as the second submenu selection target, placing the first submenu selection target in the selected state, performing an action associated with the first submenu selection target, and closing the modal submenu. Other technical features may be readily apparent to one skilled in the art from the figures, descriptions, and claims disclosed herein.

FIG. 18A-FIG. 18F illustrate exemplary display output for keyboard interaction 1800 in accordance with one embodiment. As seen in FIG. 18A, a user may place a keyboard selection target 1802 in a selected state 206 as disclosed above. As a resulting action 304, as shown in FIG. 18B, a character group selection targets 1804a-1804f may be displayed in an idle state 202. The user may then place a desired selection target into a selected state 206 as disclosed above, such as character group selection target 1804b, as shown in FIG. 18C.

The resulting action 304 of selecting character group selection target 1804b may be to open a modal submenu 1806, as shown in FIG. 18D. The modal submenu 1806 may include character selection targets 1808a-1808e and a go back selection target 1810 in the idle state 202. Selection targets now in the background, such as background selection targets 1812a-1812c may now appear as deactivated 1814.

The user may place character selection target 1808e from the modal submenu 1806 into the selected state 206, as previously disclosed, and as shown in FIG. 18E. The resulting actions 304 may include the incorporation of the character selected using character selection target 1808e into a message in progress 1816 and the provision of a related new selection target 1818, as shown in FIG. 18F. The modal submenu may close and previously background character group selection targets 1804a and character group selection target 1804c-1804f may become active again and return to idle state 202, along with character group selection target 1804b.

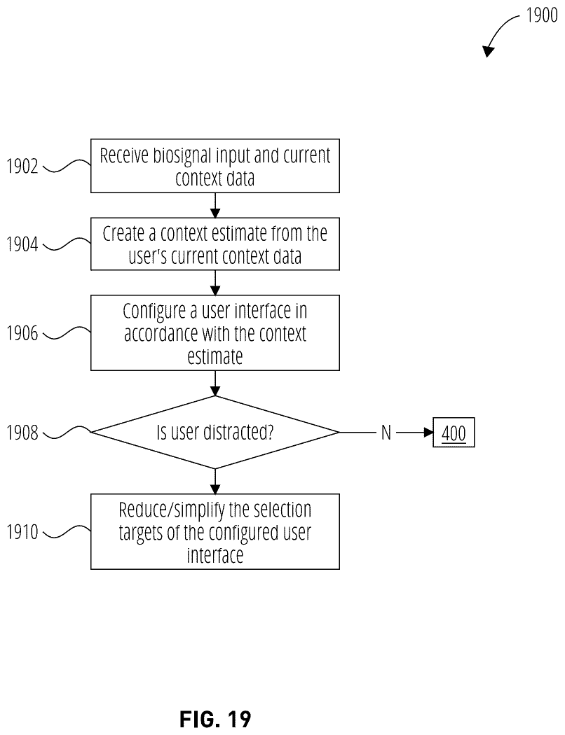

FIG. 19 illustrates a routine using context estimation 1900 in accordance with one embodiment. In one embodiment of the disclosed solution the presentation provided by the dynamic user interface 118 may be modified based on a user context estimation 136 determined from the current context data 134. For example, a user may become distracted or fatigued, exhibiting high cognitive load, emotional distress, etc., which may be detectable from the biosignal input 130. As a result, the user interface display may be simplified for casier selection in some embodiments, as supported by the routine using context estimation 1900 as described below.

Although the example routine using context estimation 1900 depicts a particular sequence of operations, the sequence may be altered without departing from the scope of the present disclosure. For example, some of the operations depicted may be performed in parallel or in a different sequence that does not materially affect the function of the routine using context estimation 1900. In other examples, different components of an example device or system that implements the routine using context estimation 1900 may perform functions at substantially the same time or in a specific sequence.

According to some examples, the method includes receiving biosignal input and current context data at block 1902. For example, the interaction framework 112 illustrated in FIG. 1 may receive biosignal input and current context data. The biosignal input may include data indicating that the user desires to interact.

According to some examples, the method includes creating a context estimate from the user's current context data at block 1904. For example, the context estimator 116 illustrated in FIG. 1 may create a context estimate from the user's current context data. In one embodiment, the system may receive signals related to the user's cognitive load, fatigue, attention and distraction levels, mood, etc. The context estimate may incorporate indicators that these user conditions may need accommodation in configuring the user interface.

According to some examples, the method includes configuring a user interface in accordance with the context estimate at block 1906. For example, the interaction framework 112 illustrated in FIG. 1 may configure a user interface in accordance with the context estimate.

According to some examples, the method includes determining whether or not the user distracted at decision block 1908, or is experiencing some other condition for which accommodation with a simpler user interface may facilitate interaction. If the user is not determined to be distracted or otherwise need accommodation, the disclosed system may continue to operate as described with respect to the user interaction routine 400 previously described. If the user is determined to be distracted or otherwise in need of accommodation at decision block 1908, the routine using context estimation 1900 may continue to block 1910.

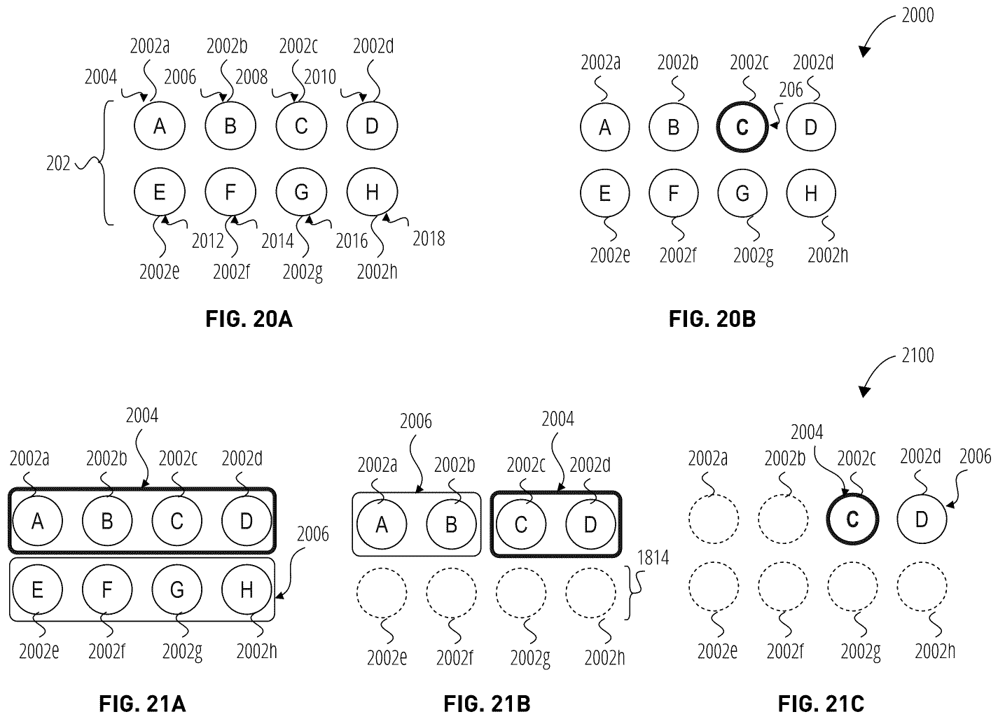

According to some examples, the method includes reducing/simplify the selection targets of the configured user interface at block 1910. For example, the interaction framework 112 illustrated in FIG. 1 may reduce/simplify the selection targets of the configured user interface. For example, some idle targets may be rendered inactive based on a statistical use algorithm, user history, or a similar methodology. In another embodiment, simplified forms of the interface comprising fewer selection targets may be selected. FIG. 20A-FIG. 22G illustrate how such simplifications may be implemented in exemplary user interfaces.

FIG. 20A and FIG. 20B illustrate exemplary selection among eight BCI selection targets 2000 in accordance with one embodiment and FIG. 21A-FIG. 21C illustrate an exemplary simplified selection among eight BCI selection targets 2100 in accordance with one embodiment. The system for which the exemplary selection among eight BCI selection targets 2000 and exemplary simplified selection among eight BCI selection targets 2100 may be implemented may detect EEG readings that are indicative of distress or lack of concentration. As a result, the interaction framework may provide an interface with a reduced number of on screen choices (exemplary simplified selection among eight BCI selection targets 2100) when compared with a default configuration (exemplary selection among eight BCI selection targets 2000).

In one embodiment, as shown in FIG. 20A, a default exemplary selection among eight BCI selection targets 2000 may present eight active selection targets to the user simultaneously, such as BCI selection target 2002a-2002h. When in the idle state 202 each of BCI selection target 2002a-2002h may flash at a different frequency in order to elicit a specific, frequency-dependent SSVEP from the user upon receiving the user's attention or focus. This is indicated by frequencies 2004-2018.

User focus upon one target, such as BCI selection target 2002c, may be indicated by a frequency response of signals received by a BCI device worn by the user exhibiting characteristics evoked by frequency 2008. Detection of such a response from the BCI device signals may result in BCI selection target 2002c being placed in a hover state, then a selected state 206, as shown in FIG. 20B. Assuming all eight BCI targets are flashing at different frequencies, an expert and/or alert user might have no difficulty selecting BCI selection target 2002c as disclosed herein.

However, if the disclosed system detects EEG readings which are indicative of distress or lack of concentration, the system may provide an interface that reduces the number of on screen choices, such as the exemplary simplified selection among eight BCI selection targets 2100. To make interaction as simple as possible, options may be reduced to binary decisions (A or B, yes or no, left or right, etc.)

The same eight BCI selection targets 2002a-2002h may be displayed, for example, but they may be configured in the exemplary simplified selection among eight BCI selection targets 2100 to flash in two groups, such that the top four targets (BCI selection targets 2002a-2002d) flash at frequency 2004 and the bottom four targets (BCI selection targets 2002e-2002h) flash at frequency 2006, as shown in FIG. 21A. In this manner, a novice user or a user experiencing distraction, fatigue, etc., who might struggle with selecting from eight options at once, may first select from among two options.

The user may, for example, accept the top group of targets shown in FIG. 21A, and as a result, that group may subdivide as shown in FIG. 21B. The bottom group of FIG. 21A (BCI selection targets 2002e-2002h) may become deactivated 1814. The top group of FIG. 21A may divide into a left group including BCI selection target 2002a and 2002b flashing at frequency 2006, and a right group of BCI selection target 2002c and 2002d flashing at frequency 2004. This may allow the user to select again between two options, such as selecting the right group of BCI selection target 2002c and 2002d.

As a result, and as shown in FIG. 21C, the user may finally be presented with BCI selection target 2002c and BCI selection target 2002d, the other targets being deactivated. BCI selection target 2002c may flash at frequency 2004, and BCI selection target 2002d may flash at frequency 2006. This may allow the user to select BCI selection target 2002c by focusing on one of two flashing targets through a series of steps that follow the process disclosed herein.

This methodology may also be useful if the user is struggling to make selections accurately. For example, an expert BCI user may be able to quickly select the target they want from 8 possible targets presented simultaneously with an accuracy of 95%. However, for a novice BCI user, this may prove too difficult. If the novice is making mistakes and becoming frustrated, this may be detected by the system as higher levels of stress. In this case, the same interface may be adapted to reduce the number of active targets shown at the same time. Thus, the user may gradually narrow down their selection to the desired target through a series of choices.

Alternate embodiment of user state estimation indicative of distraction or fatigue may include whether or not the user needs to use back or undo buttons, detecting whether or not a delay between selections is increasing, and detecting BCI oscillation between hover states, determining user motion and/or acceleration. Targeting entropy may be discerned from eye tracking data. SSVEP presentation-response delay may be noted as increasing. Environmental noise may be detected by microphones coupled to the system, indicating that the user is in a loud room. System cameras may indicate that objects and people are moving around and may be impacting the user's cognitive load. These data may be incorporated into the context estimation used to determine whether a simpler user interface may be helpful.

In one embodiment, the subdivisions of selection target groups may be based on the input modality. Where multiple modalities are available, the interaction framework may be configured to switch to a modality more efficiently adaptable to binary input. For example, for a user experiencing difficulty making selections with eye tracking, the system may instead present a user interface reliant upon eye gesture direction.

In one embodiment, the currently active modality may be exposed to by the operating system in various ways. In particular, the active modality may provide one of the following capabilities:
1. Single binary selection (e.g. switch control)
2. Multiple selection, along with a numeric value indicating the number of simultaneous selections possible
3. Confidence values indicating how confident the modality interface is in the user's selection

In some embodiments, the interaction layer may dynamically adapt the responsive interface to reflect modality capabilities or confidence. In some embodiments, the interaction layer may dynamically remap or calibrate the mapping between multiple selection categories and interface elements. This may occur in order to increase overall accuracy, to adapt to frequently used elements, or to support other improvements and efficiencies of system performance and user accessibility, as will be readily understood by one of ordinary skill in the art.

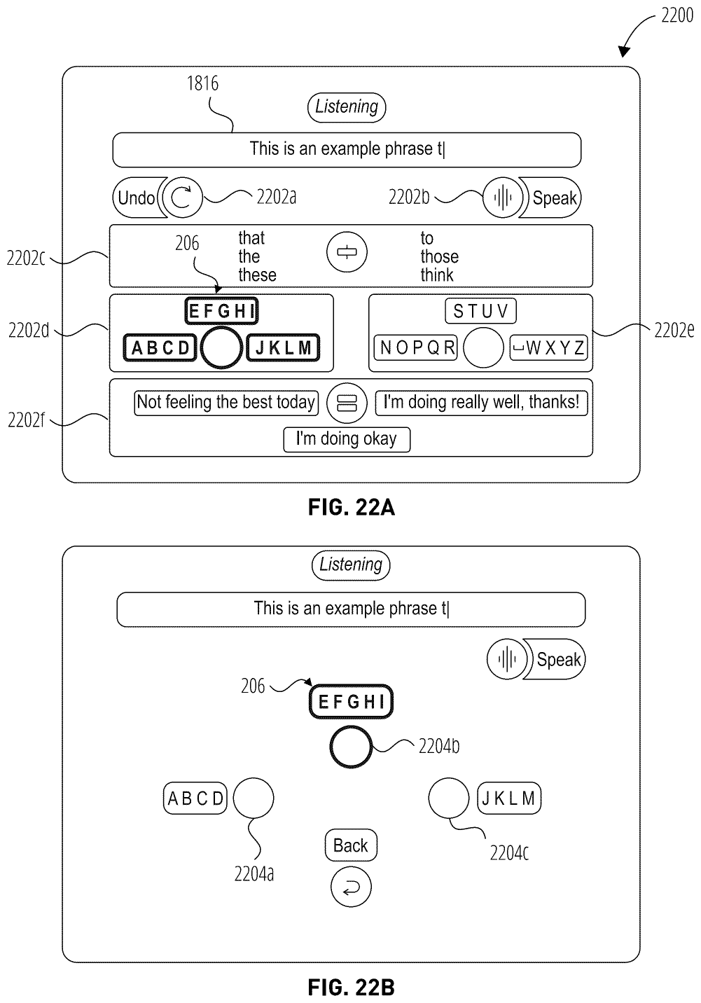

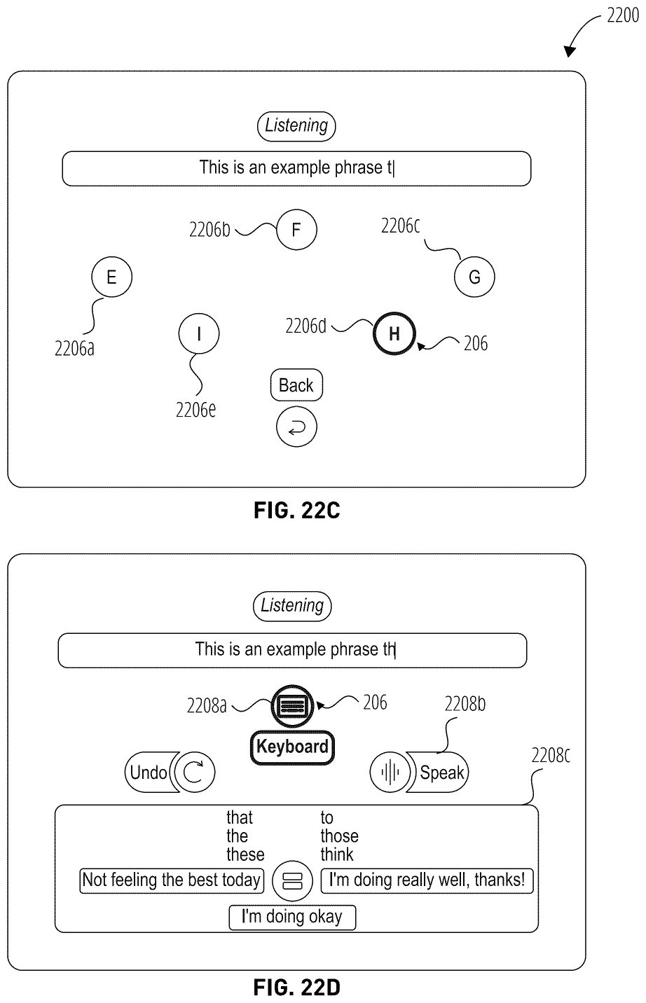

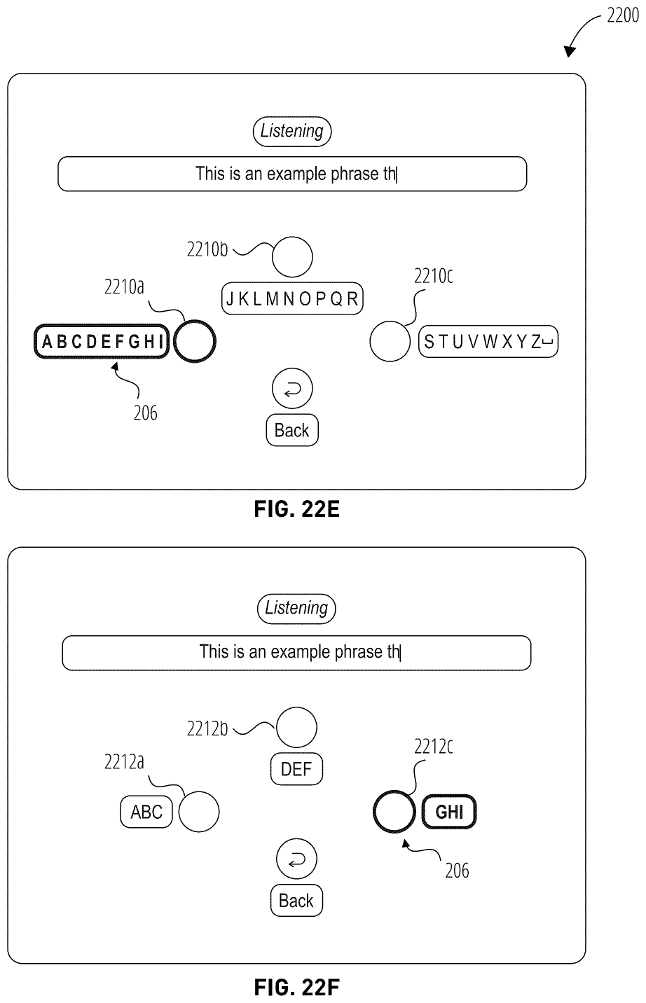

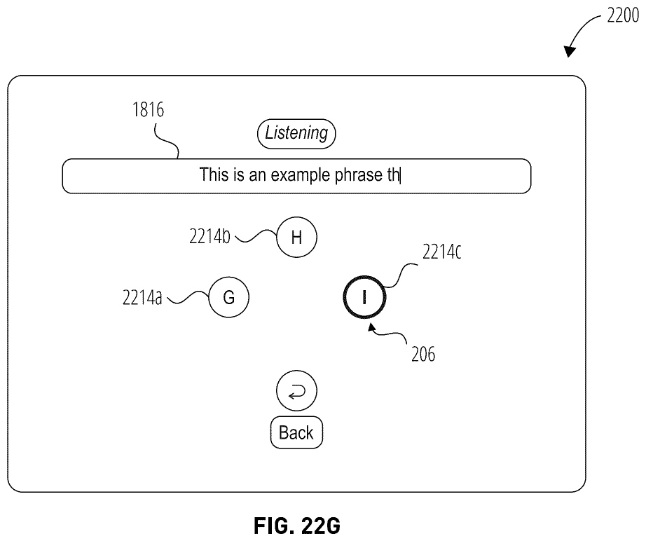

FIG. 22A-FIG. 22G illustrate exemplary simplified display output for keyboard interaction 2200 in accordance with one embodiment. An interactive display such as the exemplary simplified display output for keyboard interaction 2200 may allow a user to navigate a keyboard interface to input text. The display may start by providing six large targets that may be selected at any time, as shown by selection targets 2202a-2202f in FIG. 22A. However, the system may determine from biosignal input that the user is struggling to make accurate selections, and may thus adapt to a simplified version of the keyboard interface introduced in FIG. 18B.

In FIG. 22A, the user may begin follow the methodology described herein to select the letter “h” to add to the example phrase message in progress 1816. The user may select from among selection targets 2202a-2202f to place selection target 2202d into the selected state 206, as the target associated for entering a letter from the group of A through M.

In FIG. 22B, the user may continue to use the exemplary simplified display output for keyboard interaction 2200 to place character group selection target 2204b in the hover state and selected state 206, as containing the desired letter “h” option, thus selecting it from among character group selection targets 2204a-2204c. In FIG. 22C, the user may continue to interact as disclosed herein to place the character selection target 2206d into a selected state 206 by focusing their attention on it from among their choices of character selection targets 2206a-2206c.

The system may detect a biosignal input indicative of distraction, fatigue, elevated cognitive load, etc. In one embodiment, the system may offer an additionally simplified interface as shown in FIG. 22D. Among the selection targets offered to the user may be a selection target 2208a supporting continued keyboard use, selection target 2208b offering the option to switch to speaking rather than typing, and selection target 2208c, where the user may select from among various common words indicated by their previous choices and the option to provide explicit indication of their personal status. According to the illustrated example, the user may elect to place the keyboard use selection target 2208a into the selected state 206, to continue typing using the exemplary simplified display output for keyboard interaction 2200.

The user may proceed through the options shown in FIG. 22E, FIG. 22F, and FIG. 22G, to select (place in selected state 206) the character set selection target 2210a from among character set selection targets character set selection target 2210a-2210c, followed by character set selection target 2212c from among character set selection targets 2212a-2212c and character selection target 2214c from among character selection targets 2214a-2214c, respectively, to select the letter “i” for addition to the message in progress 1816. It will be readily understood by one of ordinary skill in the art how predictive text algorithms may be used to further simplify the displayed keyboard by omitting characters from the character selection targets 2214a-2214c which would not be applicable to any word being entered into the message in progress 1816 in the user's language.

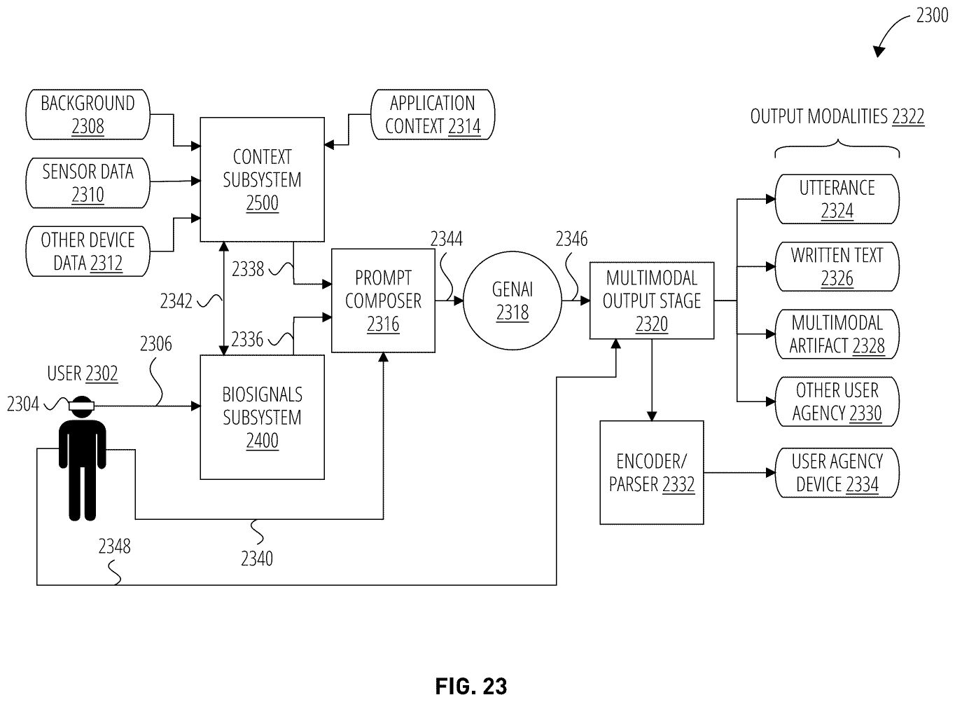

FIG. 23 illustrates a user agency and capability augmentation system 2300 in accordance with one embodiment. The user agency and capability augmentation system 2300 comprises a user 2302, a wearable computing and biosignal sensing device 2304, biosignals 2306, background material 2308, sensor data 2310, other device data 2312, application context 2314 a prompt composer 2316, a GenAI 2318, a multimodal output stage 2320, an encoder/parser 2332, output modalities 2322 such as an utterance 2324, a written text 2326, a multimodal artifact 2328, an other user agency 2330, and a non-language user agency device 2334, a biosignals subsystem 2400, and a context subsystem 2500.

The user 2302 in one embodiment may be equipped with and interact with a wearable computing and biosignal sensing device 2304. The wearable computing and biosignal sensing device 2304 may be a device such as the brain computer interface or BCI headset system 2600 described in greater detail with respect to FIG. 26A through FIG. 26D. This embodiment may provide the user 2302 with capability augmentation or agency support by utilizing biosignals 2306, such as neurologically sensed signals and physically sensed signals, detected from the wearable computing and biosignal sensing device 2304 and sent to a biosignals subsystem 2400, in addition to data from biosignal sensors that may be part of the biosignals subsystem 2400. The biosignals subsystem 2400 may produce as its output a tokenized biosignals prompt 2336. The action of the biosignals subsystem 2400 is described in detail with respect to FIG. 24.

This embodiment may provide the user 2302 with capability augmentation or agency support by utilizing inference of the user's environment, physical state, history, and current desired capabilities as a user context, to be gathered at a context subsystem 2500, described in greater detail with respect to FIG. 25. This data may be provided as background material 2308 on the user stored in a database or other storage structure, sensor data 2310 and other device data 2312 from a range of devices and on-device and off-device sensors, and application context 2314 provided by applications, interfaces, or parameters configured to provide the capability augmentation sought by the user 2302. The context subsystem 2500 may produce as its output a tokenized context prompt 2338.

In one embodiment, the biosignals subsystem 2400 and the context subsystem 2500 may be coupled or configured to allow shared data 2342 to flow between them. For instance, some sensor data 2310 or other device data 2312 may contain biosignal information that may be useful to the biosignals subsystem 2400. Or the biosignals subsystem 2400 may capture sensor data 2310 indicative of the user 2302 context. These systems may communicate such data, in raw, structured, or tokenized forms, between themselves using wired or wireless communication. In one embodiment, these systems may operate as part of a device that is also configured and utilized to run other services.

This embodiment may finally provide the user 2302 capability augmentation or agency support by utilizing direct user 2302 input in the form of a user input prompt 2340, such as mouse, keyboard, or biosignal-based selections, typed or spoken language, or other form of direct interaction the user 2302 may have with a computational device that is part of or supports the user agency and capability augmentation system 2300 disclosed. In one embodiment, the user 2302 may provide an additional token sequence in one or more sensory modes, which may include a sequence of typed or spoken words, an image or sequence of images, and a sound or sequence of sounds. The biometric and optional multimodal prompt input from the user may be tokenized using equivalent techniques as for the context data.

The biosignals prompt 2336, context prompt 2338, and user input prompt 2340 may be sent to a prompt composer 2316. The prompt composer 2316 may consume the data including the biosignals prompt 2336, context prompt 2338, and user input prompt 2340 tokens, and may construct a single token, a set of tokens, or a series of conditional or unconditional commands suitable to use as a prompt 2344 for a GenAI 2318 such as a Large Language Model (LLM), a Generative Pre-trained Transformer (GPT) like GPT-4, or a generalist agent such as Gato. For example, a series such as “conditional on command A success, send command B, else send command C” may be built and sent all at once given a specific data precondition, rather than being built and sent separately.

The prompt composer 2316 may also generate tokens that identify a requested or desired output modality (text vs. audio/visual vs. commands to a computer or robotic device, etc.) from among available output modalities 2322 such as those illustrated. In one embodiment, the prompt composer 2316 may further generate an embedding which may be provided separately to the GenAI 2318 for use in an intermediate layer of the GenAI 2318. In another embodiment, the prompt composer 2316 may generate multiple tokenized sequences at once that constitute a series of conditional commands. In one exemplary use case, the user 2302 submits a general navigational command to an autonomous robot or vehicle, such as “go to the top of the hill.” The prompt composer 2316 may then interact with satellite and radar endpoints to construct specific motor commands, such as “Move forward 20 feet and turn left,” that navigate the robot or vehicle to the desired destination.

In one exemplary use case, the context subsystem 2500 may generate a context prompt 2338 token sequence corresponding to the plaintext, “The user has travelled to Los Angeles to visit a doctor specializing in rare diseases. The user is sitting in the doctor's office and preparing to discuss their disease. The user is looking at the doctor who has just asked the user for an update on their condition.” Such a context prompt 2338 may be generated by utilizing sensors on a computing device worn or held by the user 2302, such as a smart phone or the wearable computing and biosignal sensing device 2304. Such sensors may include global positioning system (GPS) components, as well as microphones configured to feed audio to a speech to text (STT) device or module in order to identify the doctor and the questions. The biosignals subsystem 2400 may generate a biosignals prompt 2336 including a token sequence corresponding to the user selecting “speak” with a computing device to select this directive using an electroencephalography-based brain computer interface. The user input prompt 2340 may include a token sequence corresponding to the plaintext, “The user has selected ‘summarize my recent disease experience’.” In this case, the prompt composer 2316 may simply append these three token sequences into a single prompt 2344 and may then pass it to the GenAI 2318. In an alternate embodiment, the prompt composer 2316 may replace the biosignals prompt 2336 with a token sequence corresponding to the plaintext “Generate output in a format suitable for speech synthesis.”

In some embodiments, the prompt composer 2316 may utilize a formal prompt composition language such as Microsoft Guidance. In such a case, the composition language may utilize one or more formal structures that facilitate deterministic prompt composition as a function of mixed modality inputs. For example, the prompt composer 2316 may contain subroutines that process raw signal data and utilize this data to modify context prompt 2338 and/or biosignals prompt 2336 inputs in order to ensure specific types of GenAI 2318 outputs.

A more intricate exemplary prompt from the prompt composer 2316 to the GenAI 2318, incorporating information detected from user 2302 context and biosignals 2306, may be as follows:

I am Sarah, a 60-year-old retired schoolteacher with advanced ALS. I enjoy the peaceful sounds of birds chirping. I just finished reading a mystery novel recommended by my friend Donna. As a literature enthusiast, I have a long history of discussing books with my friends and family I need help communicating and you are my assistant.

This is the current context:
Conversation history: Recent discussions about books with family and friends, including favorite authors, genres, and specific titles
Personal preferences: Fondness for mystery novels, historical fiction, and biographies; appreciation for strong character development and engaging plots
Language corpus and demographics: 60-year-old, retired school teacher, well-versed in literary terms and expressions
Mood: Content, relaxed, and eager to share her thoughts on the novel
Conversation Partner: Donna, my friend with shared interest in literature
Environmental audio: Sounds of birds chirping, rustling leaves, and distant neighborly conversations in the garden
Front-facing camera: Images of blooming flowers, lush greenery, and the mystery novel's cover
Location, motion, and positioning: At home, sitting in a comfortable garden chair
Reading preferences: Mystery novels, historical fiction, biographies, and classic literature
Educational background: Years of teaching experience in literature, familiarity with various literary periods and styles.

If I send an emoji, use it to topically or thematically improve prediction and alter tone. Use all contextual information and prior conversation history to modulate your responses. After each input, review the prior inputs and modify your subsequent predictions based on the context of the thread. Taking into account the current context, with spartan language, return a JSON string called ‘suggestions’ with three different and unique phrases without quotes. They should be complete sentences longer than two words. Do not include explanations. The phrases you respond with will be spoken by my speech generating device.

The GenAI 2318 may take in the prompt 2344 from the prompt composer 2316 and use this to generate a multimodal output 2346. The GenAI 2318 may consist of a pre-trained machine learning model, such as GPT. The GenAI 2318 may generate a multimodal output 2346 in the form of a token sequence that may be converted back into plaintext, or which may be consumed by a user agency process directly as a token sequence. In an alternate embodiment, the output of the GenAI 2318 further constitutes embeddings that may be decoded into multimodal or time-series signals capable of utilization by agency endpoints. Once determined, the output is digitally communicated to an agency endpoint capable of supporting the various output modalities 2322.

In some embodiments, the GenAI 2318 may generate two or more possible multimodal outputs 2346 and the user 2302 may be explicitly prompted at the multimodal output stage 2320 to select between the choices. In the case of language generation, the user 2302 may at the multimodal output stage 2320 select between alternative utterances 2324. In the case of robot control, the choices may consist of alternative paths that a robot could take in order to achieve a user-specified goal. In these embodiments, there may be an output mode selection signal 2348 provided by the user 2302 explicitly or indicated through biosignals 2306, to the multimodal output stage 2320. The output mode selection signal 2348 may instruct a choice between the multimodal outputs 2346 available from the GenAI 2318 at the multimodal output stage 2320. In one embodiment, the user 2302 may further direct one or more of the alternatives to alternate endpoints supporting the various output modalities 2322. For example, the user 2302 may select one utterance 2324 for audible presentation and a different one for transformation and/or translation to written text 2326.

In an alternate configuration, the user agency and capability augmentation system 2300 may contain multiple GenAIs 2318, each of which is pre-trained on specific application, context, or agency domains. In this configuration, the context subsystem 2500 may be responsible for selecting the appropriate GenAI 2318 or GenAIs 2318 for the current estimated user context. In some embodiments, mixture-of-experts models such as a generalist language model may be used for this.

In some embodiments, models may be fine-tuned by the user 2302. For example, the user 2302 may provide a GenAI 2318 LLM classifier model with exemplars of classes, either by speaking or writing them, and through few-shot learning, the model may improve accuracy. The multimodal outputs 2346 may be made available to the user 2302 through the agency endpoints supporting the various output modalities 2322, and the user 2302 may respond in a manner detectable through the user's biosignals 2306, or directly through an additional user input prompt 2340, and in this manner may also provide data through which the GenAI 2318 may be refined.

The multimodal outputs 2346 may be used to extend and support user 2302 agency and augment user 2302 capability into real and virtual endpoints. In one embodiment, the selected user agency process may be a speech synthesis system capable of synthesizing a token sequence or text string as a spoken language utterance 2324 in the form of a digital audio signal. In another embodiment, the system's output may be constrained to a subset of domain-relevant utterances 2324 for applications such as employment, industry, or medical care. This output constraint may be implemented using a domain specific token post-processing system or it may be implemented with an alternate GenAI that has been pre-trained on the target domain. In another embodiment, the endpoint may be a written text 2326 composition interface associated with a communication application such as email, social media, chat, etc., or presented on the user's or their companions' mobile or wearable computing device. In a further embodiment, the output may be a multimodal artifact 2328 such as a video with text, an audio file, etc. In another embodiment, the output may augment some other user agency 2330, such as by providing haptic stimulation, or through dynamic alteration of a user's interface, access method, or complexity of interaction, to maximize utility in context.

In some embodiments, the multimodal outputs 2346 may be additionally encoded using an encoder/parser 2332 framework such as an autoencoder. In this system, the output of the encoder/parser 2332 framework may be a sequence of control commands to control a non-language user agency device 2334 or robotic system such as a powered wheelchair, prosthetic, powered exoskeleton, or other smart, robotic, or AI-powered device. In one embodiment, the prompt 2344 from the prompt composer 2316 may include either biosignals prompt 2336 or user input prompt 2340 tokens which represent the user's desired configuration, and the multimodal output includes detailed steps that a robotic controller may digest, once encoded by the encoder/parser 2332. In this embodiment, the user 2302 may express a desire to move from location A to location B, and the combination of the GenAI 2318 and the robot controller may generate an optimal path as well as detailed control commands for individual actuators. In another embodiment, biosignals 2306 may be used to infer a user's comfort with the condition of their surroundings, their context indicating that they are at home, and a prompt may be developed such that the GenAI 2318 provides multimodal outputs 2346 instructing a smart home system to adjust a thermostat, turn off music, raise light levels, or perform other tasks to improve user comfort. In a further embodiment, the GenAI 2318 may generate a novel control program which is encoded by parsing or compiling it for the target robot control platform at the encoder/parser 2332. In general, the GenAI 2318 may generate one or more computer programs intended to be executed by another computing device, to achieve the user's intended outcome. The multimodal output 2346 may through these methods be available as information or feedback to the user 2302, through presentation via the wearable computing and biosignal sensing device 2304 or other devices in the user's immediate surroundings. The multimodal output 2346 may be stored and become part of the user's background material 2308. The user 2302 may respond to the multimodal output 2346 in a manner detectable through biosignals 2306, and thus a channel may be provided to train the GenAI 2318 based on user 2302 response to multimodal output 2346.

In general, the user agency and capability augmentation system 2300 may be viewed as a kind of application framework that uses the biosignals prompt 2336, context prompt 2338, and user input prompt 2340 sequences to facilitate interaction with an application, much as a user 2302 would use their finger to interact with a mobile phone application running on a mobile phone operating system. Unlike a touchscreen or mouse/keyboard interface, this system incorporates real time user inputs along with an articulated description of their physical context and historical context to facilitate extremely efficient interactions to support user agency. FIG. 23 shows the pathways signals take from input, by sensing devices, stored data, or the user 2302, to output in the form of text-to-speech utterances 2324, written text 2326, multimodal artifacts 2328, other user agency 2330 supportive outputs, and/or commands to a non-language user agency device 2334. It will be well understood by one of skill in the art that not all components of the disclosed user agency and capability augmentation system 2300 may be used in every application such a system may operate within or may not be used with equal weight. Some applications may make greater use of biosignals 2306 than of context indicating the user history and surroundings. Some applications may necessitate operation completely independent from user input prompt 2340 data. The disclosed user agency and capability augmentation system 2300 may be used in support of such user applications as are described in the embodiments disclosed herein.

FIG. 24 illustrates a biosignals subsystem 2400 in accordance with one embodiment. The biosignals subsystem 2400 may comprise additional biosensors 2402, a biosignals classifier 2404, an electroencephalography or EEG tokenizer 2406, a kinematic tokenizer 2408, and additional tokenizers 2410, each of which may be suitable for one or more streams of biosignal data.

In addition to sensors which may be available on the wearable computing and biosignal sensing device 2304 worn by the user 2302, additional biosensors 2402 may be incorporated into the biosignals subsystem 2400. These may be of a mixture of physical sensors on or near the user's body that connect with network-connected and embedded data sources and models to generate a numerical representation of a biosignal estimate. An appropriate biosignal tokenizer may encode the biosignal estimate with associated data to generate at least one biosignal token sequence. In some embodiments, the mobile or wearable computing and biosignal sensing device 2304 may include a set of sensory peripherals designed to capture user 2302 biometrics. In this manner, the biosignals subsystem 2400 may receive biosignals 2306, which may include at least one of a neurologically sensed signal and a physically sensed signal.

Biosignals 2306 may be tokenized through the use of a biosignals classifier 2404. In some embodiments, these biometric sensors may include some combination of EEG, ECOG, ECG or EKG, EMG, EOG, pulse, heart rate variability, blood sugar sensing, dermal conductivity, etc. These biometric data may be converted into a biosignal token sequence in the biosignals classifier 2404, through operation of the EEG tokenizer 2406, kinematic tokenizer 2408, or additional tokenizers 2410, as appropriate.

It is common practice for biosignal raw signal data to be analyzed in real time using a classification system. For EEG signals, a possible choice for an EEG tokenizer 2406 may be canonical correlation analysis (CCA), which ingests multi-channel time series EEG data and outputs a sequence of classifications corresponding to stimuli that the user may be exposed to. However, one skilled in the art will recognize that many other signal classifiers may be chosen that may be better suited to specific stimuli or user contexts. These may include but are not limited to independent component analysis (ICA), xCCA (CCA variants), power spectral density (PSD) thresholding, and machine learning. One skilled in the art will recognize that there are many possible classification techniques. In one example, these signals may consist of SSVEPs which occur in response to specific visual stimuli. In other possible embodiments, the classification may consist of a binary true/false sequence corresponding to a P300 or other similar neural characteristic. In some embodiments, there will be a user or stimuli specific calibrated signal used for the analysis. In other embodiments, a generic reference may be chosen. In yet other possible embodiments, the classes may consist of discrete event related potential (ERP) responses. It may be clear to one of ordinary skill in the art that other biosignals including EOG, EMG, and EKG, may be similarly classified and converted into symbol sequences. In other embodiments, the signal data may be directly tokenized using discretization and a codebook. The resulting tokens may be used as part of the biosignals prompt 2336.

In some embodiments, the biosignals subsystem may report classification outputs using device emulation protocol such as HID. In this case, the biosignals subsystem may represent classified states as button presses, keyboard events, joystick controls or other simulated controls as permitted by the protocol. In some cases this encoding will also utilize context information from the context subsystem 2500.

The kinematic tokenizer 2408 may receive biosignals 2306 indicative of user 2302 motion, or motion of some part of a user's body, such as gaze detection based on the orientation and dilation of a user's pupils, through eye and pupil tracking. Such kinematic biosignals 2306 may be tokenized through the operation of the kinematic tokenizer 2408 for inclusion in the biosignals prompt 2336. Additional tokenizers 2410 may operate similarly upon other types of biosignals 2306. In one possible embodiment, the kinematic tokenizer 2408 may utilize a codebook that maps state-space values (position/orientation, velocity/angular velocity) into codes which form the sequence of codes. In other embodiments, a model-based tokenizer may be used to convert motion data into discrete code sequences.

The final output from the biosignals subsystem 2400 may be a sequence of text tokens containing a combination of the token sequences generated from the biosignals 2306, in the form of the biosignals prompt 2336. The biosignals subsystem 2400 may also have a connection with the context subsystem 2500 in advance of any prompt composition. This shared data 2342 connection may bidirectionally inform each of the subsystems to allow more precise, or more optimal token generation.

FIG. 25 illustrates a context subsystem 2500 in accordance with one embodiment. The context subsystem 2500 may comprise a raw background material tokenizer 2502, a final background material tokenizer 2504, a raw sensor data tokenizer 2506, a final sensor data tokenizer 2508, a raw device data tokenizer 2510, a final device data tokenizer 2512, a raw application context tokenizer 2514, a final application context tokenizer 2516, and a context prompt composer 2518.

Broadly speaking, the user's context consists of prompts generated from a variety of different data sources, including background material 2308 that provides information about the user's previous history, sensor data 2310 and other device data 2312 captured on or around the user 2302, and application context 2314, i.e., information about the current task or interaction the user 2302 may be engaged in.

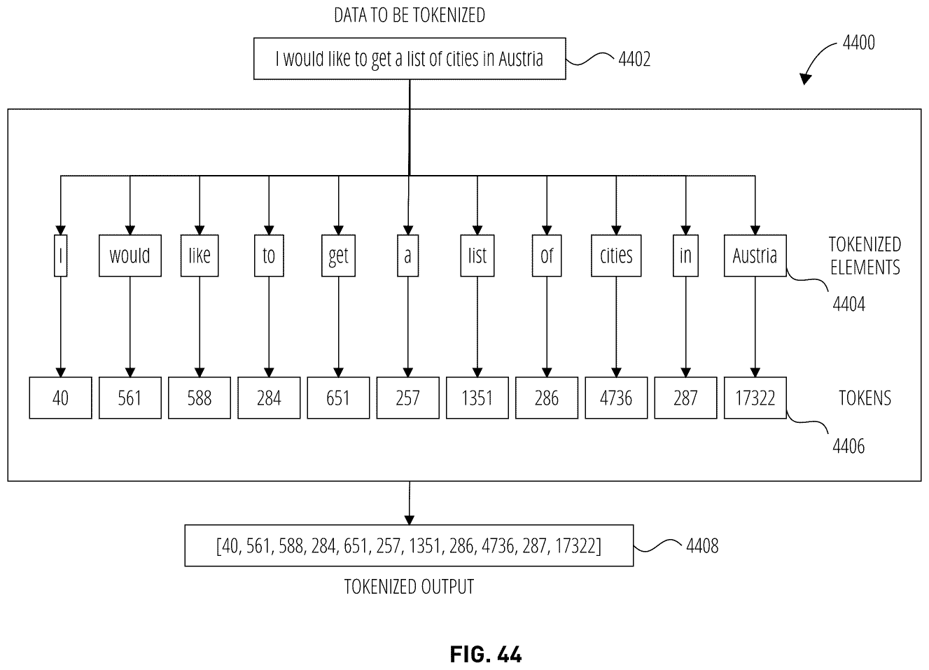

Background material 2308 may be plain text, data from a structured database or cloud data storage (structured or unstructured), or any mixture of these data types. In one embodiment background material 2308 may include textual descriptions of activities that the user 2302 has performed or requested in a similar context and their prior outcomes, if relevant. In one embodiment, background material 2308 may include general information about the user 2302, about topics relevant to the user's current environment, the user's conversational histories, a body of written or other work produced by the user 2302, or notes or other material related to the user's situation which is of a contextual or historical nature. In some embodiments, the background material 2308 may first be converted into a plain text stream and then tokenized using a plaintext tokenizer. This is illustrated in greater detail with respect to FIG. 44.

Sensor data 2310 may include microphone output indicative of sound in the user's environment, temperature, air pressure, and humidity data from climactic sensors, etc., output from motion sensors, and a number of other sensing devices readily available and pertinent to the user's surroundings and desired application of the user agency and capability augmentation system 2300. Other device data 2312 may include camera output, either still or video, indicating visual data available from the user's surrounding environment, location information from a global positioning system device, date and time data, information available via a network based on the user's location, and data from a number of other devices readily available and of use in the desired application of the user agency and capability augmentation system 2300. Scene analysis may be used in conjunction with object recognition to identify objects and people present in the user's environment, which may then be tokenized. The context subsystem may also include a mixture of physical sensors such as microphones and cameras that connect with network-connected and embedded data sources and models to generate a numerical representation of a real-time context estimate.

In some instances, the user 2302 may interact with an application on a computing device, and this interaction may be supported and expanded through the integration of a user agency and capability augmentation system 2300. In these instances, explicit specification of the application may greatly enhance the context subsystem 2500 knowledge of the user 2302 context and may facilitate a more optimal context token set. Application context 2314 data may in such a case be made available to the user agency and capability augmentation system 2300, and data from the application context 2314 data source may be tokenized as part of the operation of the context subsystem 2500, for inclusion in the context prompt 2338. Application context 2314 data may include data about the current application (e.g., web browser, social media, media viewer, etc.) along with the user's interactions associated with the application, such as a user's interaction with a form for an online food order, data from a weather application the user is currently viewing, etc.

For each data source, a raw data tokenizer may generate a set of preliminary tokens 2520. These preliminary tokens 2520 may be passed to final tokenizers for all of the data sources to be consumed as input for the final tokenizers for each data source. Each data source final tokenizer may refine its output based on the preliminary tokens 2520 provided by other data sources. This may be particularly important for background material 2308. For example, the context used by the final background material tokenizer 2504 to determine which background material 2308 elements are likely to be relevant may be the prompt generated by the raw data source tokenizers. For example, camera data and microphone data may indicate the presence and identity of another person within the user's immediate surroundings. Background material 2308 may include emails, text messages, audio recordings, or other records of exchanges between this person and the user, which the final background material tokenizer 2504 may then include and tokenize as of particular interest to the user's present context.

The context subsystem 2500 may send the final tokens output from the final tokenizers for each data source to a context prompt composer 2518. The context prompt composer 2518 may use these final tokens 2522, in whole or in part, to generate a context prompt 2338, which may be the final output from the context subsystem 2500. The context prompt 2338 may be a sequence of text tokens containing the combination of the background, audio/video, and other final tokens 2522 from the final background material tokenizer 2504, final sensor data tokenizer 2508, final device data tokenizer 2512, and final application context tokenizer 2516. In the simplest embodiment, the context prompt composer 2518 concatenates all the final tokens 2522. In other possible embodiments, the context prompt composer 2518 creates as its context prompt 2338 a structured report that includes additional tokens to assist the GenAI in parsing the various final tokens 2522 or prompts.

FIG. 26A illustrates an isometric view of a BCI headset system 2600 in accordance with one embodiment. The BCI headset system 2600 comprises an augmented reality display lens 2602, a top cover 2604, an adjustable strap 2606, a padding 2608, a ground/reference electrode 2610, a ground/reference electrode adjustment dial 2612, a biosensor electrodes 2614, a battery cell 2616, a fit adjustment dial 2618, and a control panel cover 2620.

The augmented reality display lens 2602 may be removable from the top cover 2604 as illustrated in FIG. 26C. The augmented reality display lens 2602 and top cover 2604 may have magnetic portions that facilitate removably securing the augmented reality display lens 2602 to the top cover 2604. The augmented reality display lens 2602 may in one embodiment incorporate a frame around the lens material allowing the augmented reality display lens 2602 to be handled without depositing oils on the lens material.

The adjustable strap 2606 may secure the BCI headset system 2600 to a wearer's head. The adjustable strap 2606 may also provide a conduit for connections between the forward housing 2632 shown in FIG. 26C and the components located along the adjustable strap 2606 and to the rear of the BCI headset system 2600. Padding 2608 may be located at the front and rear of the BCI headset system 2600, as well as along the sides of the adjustable strap 2606, as illustrated. A fit adjustment dial 2618 at the rear of the BCI headset system 2600 may be used to tighten and loosen the fit of the BCI headset system 2600 by allowing adjustment to the adjustable strap 2606.

A snug fit of the BCI headset system 2600 may facilitate accurate readings from the ground/reference electrodes 2610 at the sides of the BCI headset system 2600, as illustrated here in FIG. 26A as well as in FIG. 26C. A snug fit may also facilitate accurate readings from the biosensor electrodes 2614 positioned at the back of the BCI headset system 2600. Further adjustment to these sensors may be made using the ground/reference electrode adjustment dials 2612 shown, as well as the biosensor electrode adjustment dials 2624 illustrated in FIG. 26B.

In addition to the padding 2608, biosensor electrodes 2614, and fit adjustment dial 2618 already described, the rear of the BCI headset system 2600 may incorporate a battery cell 2616, such as a rechargeable lithium battery pack. A control panel cover 2620 may protect additional features when installed, those features being further discussed with respect to FIG. 26B.

FIG. 26B illustrates a rear view of a BCI headset system 2600 in accordance with one embodiment. The control panel cover 2620 introduced in FIG. 26B is not shown in this figure, so that underlying elements may be illustrated. The BCI headset system 2600 further comprises a control panel 2622, a biosensor electrode adjustment dials 2624, an auxiliary electrode ports 2626, and a power switch 2628.

With the control panel cover 2620 removed, the wearer may access a control panel 2622 at the rear of the BCI headset system 2600. The control panel 2622 may include biosensor electrode adjustment dials 2624, which may be used to calibrate and adjust settings for the biosensor electrodes 2614 shown in FIG. 26A.

The control panel 2622 may also include auxiliary electrode ports 2626, such that additional electrodes may be connected to the BCI headset system 2600. For example, a set of gloves containing electrodes may be configured to interface with the BCI headset system 2600, and readings from the electrodes in the gloves may be sent to the BCI headset system 2600 wirelessly, or via a wired connection to the auxiliary electrode ports 2626.

The control panel 2622 may comprise a power switch 2628, allowing the wearer to power the unit on and off while the control panel cover 2620 is removed. Replacing the control panel cover 2620 may then protect the biosensor electrode adjustment dials 2624 and power switch 2628 from being accidentally contacted during use. In one embodiment, a power light emitting diode (LED) may be incorporated onto or near the power switch 2628 as an indicator of the status of unit power, e.g., on, off, battery low, etc.

FIG. 26C illustrates an exploded view of a BCI headset system 2600 in accordance with one embodiment. The BCI headset system 2600 further comprises a universal serial bus or USB port 2630 in the rear of the BCI headset system 2600 as well as a forward housing 2632 which may be capable of holding a smart phone 2634. The USB port 2630 may in one embodiment be a port for a different signal and power connection type. The USB port 2630 may facilitate charging of the battery cell 2616 and may allow data transfer through connection to additional devices and electrodes.

The top cover 2604 may be removed from the forward housing 2632 as shown to allow access to the forward housing 2632, in order to seat and unseat a smart phone 2634. The smart phone 2634 may act as all or part of the augmented reality display. In a BCI headset system 2600 incorporating a smart phone 2634 in this manner, the augmented reality display lens 2602 may provide a reflective surface such that a wearer is able to see at least one of the smart phone 2634 display and the wearer's surroundings within their field of vision.

The top cover 2604 may incorporate a magnetized portion securing it to the forward housing 2632, as well as a magnetized lens reception area, such that the augmented reality display lens 2602 may, through incorporation of a magnetized frame, be secured in the front of the top cover 2604, and the augmented reality display lens 2602 may also be removable in order to facilitate secure storage or access to the forward housing 2632.

FIG. 26D illustrates an exploded view of a BCI headset system 2600 in accordance with one embodiment. The BCI headset system 2600 further comprises a smart phone slot 2636 in the forward housing 2632. When the augmented reality display lens 2602 and top cover 2604 are removed to expose the forward housing 2632 as shown, the smart phone slot 2636 may be accessed to allow a smart phone 2634 (not shown in this figure) to be inserted.

### Additional System Embodiment Details

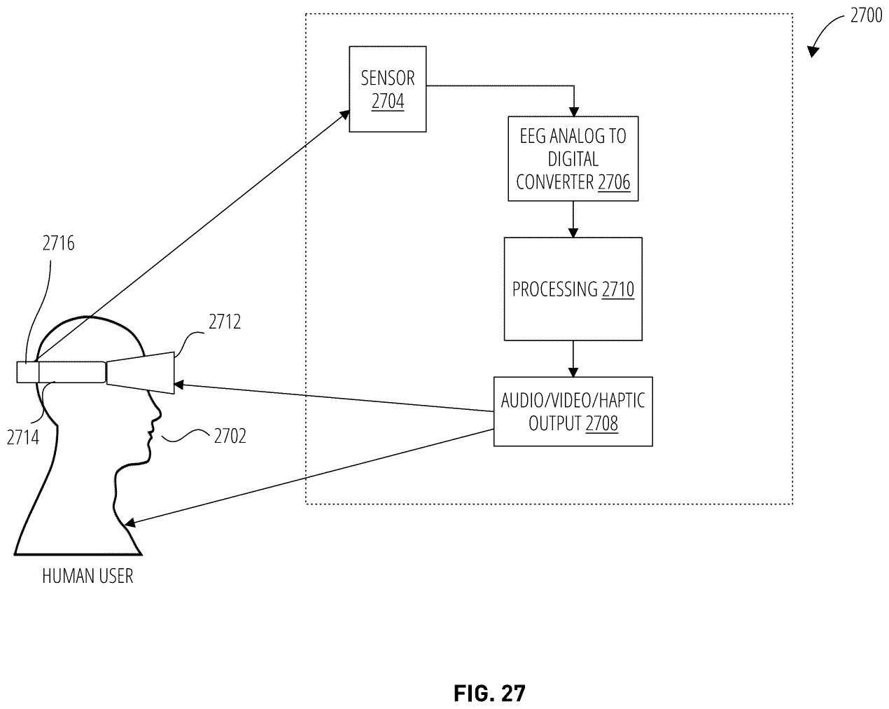

FIG. 27 illustrates an embodiment of a BCI+AR environment 2700. The BCI+AR environment 2700 comprises a sensor 2704, an EEG analog to digital converter 2706, an Audio/Video/Haptic Output 2708, a processing 2710, a strap 2714, an augmented reality glasses 2712, a human user 2702, and a BCI 2716. A human user 2702 is wearing BCI 2716, which is part of a headset. When the human user 2702 interacts with the environment, the sensor 2704, located within the BCI 2716, reads the intentions and triggers the operating system. The EEG analog to digital converter 2706 receives the sensor 2704 output (e.g., intention). EEG analog to digital converter 2706 transforms the sensor output into a digital signal which is sent to processing 2710. The signal is then processed, analyzed and mapped to an Audio/Video/Haptic Output 2708 and displayed on the augmented reality glasses 2712.

In an embodiment, strap 2714 is a head strap for securing the AR+BCI to the human head. In some embodiments, such as an implantable BCI, and AR system, the strap may not be used. The strapless system may use smart glasses or contact lenses. There may be multiple sensors, but no less than one sensor, in different embodiments. After seeing the output, the user may have different bio-signals from the brain, and as such this is a closed-loop biofeedback system. As the user focuses more on the SSVEP stimuli, the audio may feedback by frequency, power (volume), and selected cue audio to assist the human in reinforcing their focus on the stimuli. This may also occur with the vibration type and intensity of the haptics, as well as additional peripheral visual cues in the display. This feedback is independent from the audio and haptics that may play back through the AR headset via a smartphone. It is even possible to remotely add to the sensory mix that of olfactory (smell) feedback that actually travels through entirely different parts of the brain that has been shown to be one of the strongest bio-feedback reinforcements in human cognitive training.

As a non-limiting example, when someone uses the BCI for the first time, they are considered a “naïve” user, or one whose brain has never been trained with this kind of user interface. As a user continues to use it, their brain becomes less naïve and more capable and trained. They may become quicker and quicker at doing it. This is reinforcement learning—the BCI allows someone to align their intention and attention to an object and click it.

In an embodiment, to enrich the user interface experience, multiple feedback modalities (auditory, visual, haptic, and olfactory) may be available for choosing the most advantageous feedback modality for the individual or for the type of training. For example, when an appropriate brain wave frequency is generated by the user, real-time feedback about the strength of this signal may be represented by adjusting the intensity and frequency of the audio or haptic feedback. In addition, the possibility of using multimodal feedback supports simultaneous stimulation of multiple sensory brain regions, which enhances the neural signal and representation of feedback, thereby accelerating learning and neural plasticity.

An advantage of using odors as reinforcers may be due to the direct link between the brain areas that sense smell (olfactory cortex) and those that form memories (hippocampus) and produce emotions (amygdala). Odors may strengthen memory encoding, consolidation, and trigger recall.

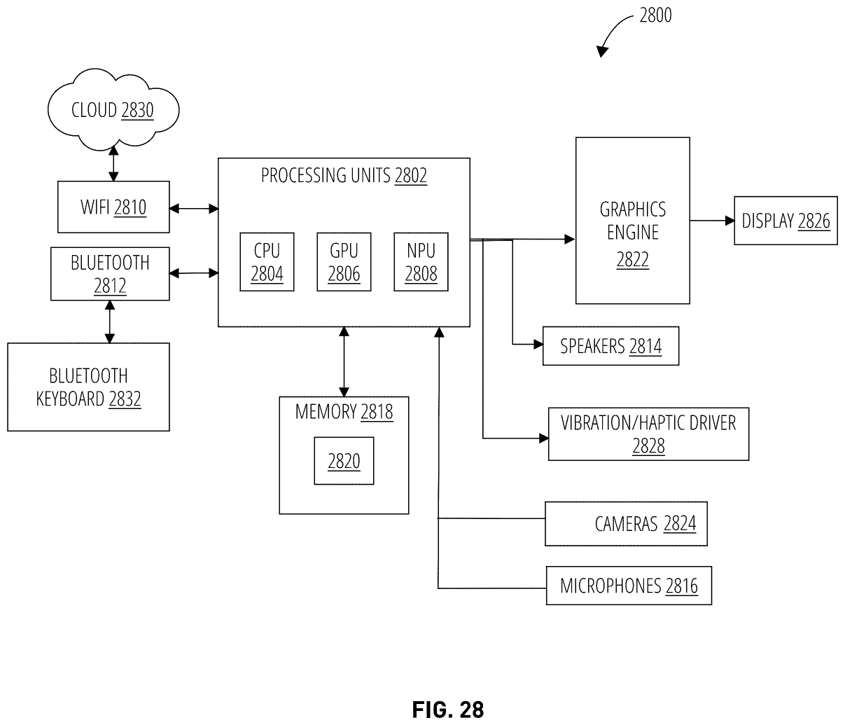

FIG. 28 illustrates components of an exemplary augmented reality device logic 2800. The augmented reality device logic 2800 comprises a graphics engine 2822, a camera 2824, processing units 2802, including one or more central processing units CPU 2804, graphical processing units GPU 2806, and/or neural processing units NPU 2808, a WiFi 2810 wireless interface, a Bluetooth 2812 wireless interface, speakers 2814, microphones 2816, one or more memory 2818, logic 2820, a visual display 2826, and vibration/haptic driver 2828.

The processing units 2802 may in some cases comprise programmable devices such as bespoke processing units optimized for a particular function, such as AR related functions. The augmented reality device logic 2800 may comprise other components that are not shown, such as dedicated depth sensors, additional interfaces, etc.

Some or all of the components in FIG. 28 may be housed in an AR headset. In some embodiments, some of these components may be housed in a separate housing connected or in wireless communication with the components of the AR headset. For example, a separate housing for some components may be designed to be worn or a belt or to fit in the wearer's pocket, or one or more of the components may be housed in a separate computer device (smartphone, tablet, laptop or desktop computer etc.) which communicates wirelessly with the display and camera apparatus in the AR headset, whereby the headset and separate device constitute the full augmented reality device logic 2800. A user may also communicate with the AR headset via a Bluetooth keyboard 2832. Additionally, the AR headset may communicate with the cloud 2830 via WiFi 2810 or cellular connection.

The memory 2818 comprises logic 2820 to be applied to the processing units 2802 to execute. In some cases, different parts of the logic 2820 may be executed by different components of the processing units 2802. The logic 2820 typically comprises code of an operating system, as well as code of one or more applications configured to run on the operating system to carry out aspects of the processes disclosed herein.

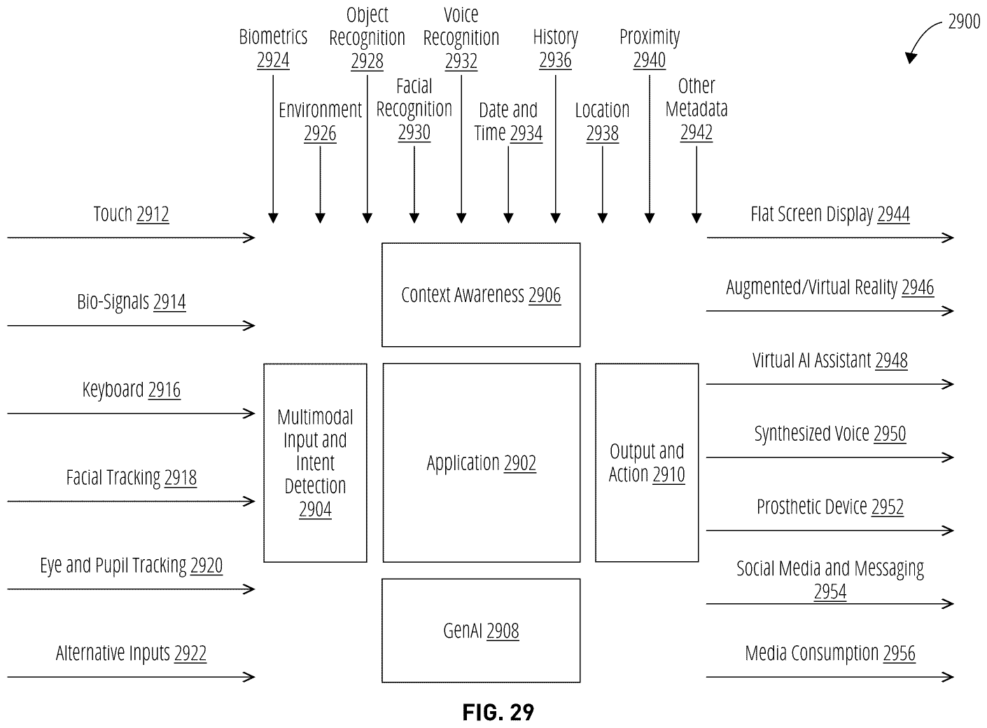

FIG. 29 is a block diagram of nonverbal multi-input and feedback device 2900 of a nonverbal multi-input and feedback device such as herein. It may be a block diagram of a portion of the device such as a processing portion of the device. FIG. 29 may be a high-level system architecture block diagram that helps explain the major building blocks. Block diagram of nonverbal multi-input and feedback device 2900 may be applied to the overall system (e.g., multiple devices used as inputs), into a common universal application interface that allows the application 2902 to synchronize data coming from multiple devices and process signals with meta data, plus vocabulary and output logic to a plurality of output methods.

In the center of block diagram of nonverbal multi-input and feedback device 2900 is the application 2902 or main processing block. To the left is the multimodal input and intent detection 2904 block which receives and processes user inputs from sensors (e.g., based on user input received by the sensors) such as touch 2912; bio-signals 2914; keyboard 2916; facial tracking 2918; eye and pupil tracking 2920; and alternative inputs 2922. This multimodal input and intent detection 2904 block feeds the processing from these inputs to the application 2902.

Above is a context awareness 2906 block which receives and processes metadata inputs from sensors such as biometrics 2924; environment 2926; object recognition 2928; facial recognition 2930; voice recognition 2932; date and time 2934; history 2936; location 2938; proximity 2940; and other metadata 2942 inputs. This context awareness 2906 block feeds the processing from these inputs to the application 2902.

To the right is an output and action 2910 block which sends outputs to displays, computing devices, controllers, speakers and network communication devices such as flat screen flat screen display 2944; augmented/virtual reality 2946; virtual AI assistant 2948; synthesized voice 2950; prosthetic device 2952; social media and messaging 2954; media consumption 2956; and other output. The outputs may include control commands and communication sent to other computing devices. They may include text, graphics, emoji, and/or audio.

Below is a GenAI 2908 block that provides a lexicon or vocabulary in the selected language to the application. FIG. 29 may also be applied to a single sensory device unto itself. This may be a “Big Idea” in so far as the architecture may scale from a single closed-loop system as well as combinations of sensory I/O devices. It may be a system of systems that scale up, down and play together.

The system in block diagram of nonverbal multi-input and feedback device 2900 comprises one (or more) sensory input, one intent detection application programming interface (API), one application, one (or more) meta data, one (or more) vocabulary, one (or more) output and action method, and one (or more) output/actuation system or device. It may be thought of as a universal “augmented intelligence” engine that takes inputs, enriches them with extra meaning, and directs the output based on instructions for the enriched information.

In a simple embodiment of diagram, a user sees a symbol or button that signifies “help”, and presses it, and the device says “help”. In a more complicated embodiment of block diagram of nonverbal multi-input and feedback device 2900, a user sees a symbol or button that signifies “help” and presses it. Here, rather than the device saying “help,” it learns that the user is connected to a caregiver with logic to send urgent matters to that person via text or instant message when away from home. The device may geolocation data that indicates the user is away from home; tag the communication with appended contextual information; and its output and action logic tell the system to send a text message to the caregiver with the user's location in a human-understandable grammatically correct phrase “Help, I'm in Oak Park” including the user's Sender ID/Profile and coordinates pinned on a map.

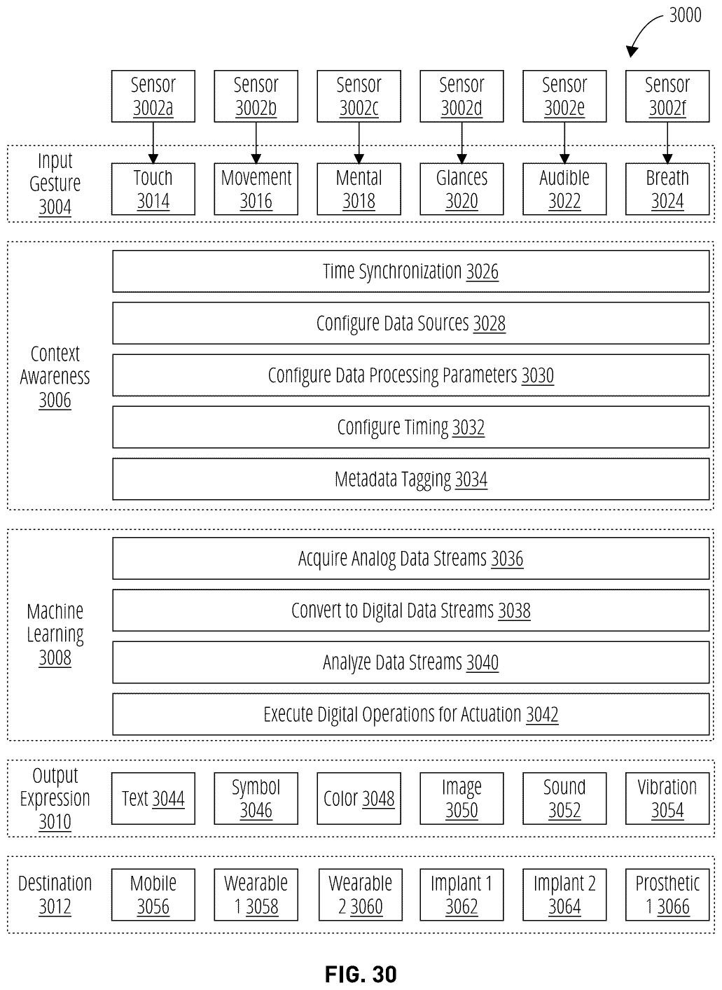

FIG. 30 is a block diagram of a single framework of a nonverbal multi-input and feedback device 3000 such as herein. The block diagram of a single framework of a nonverbal multi-input and feedback device 3000 may be of a single framework for translating diverse sensor inputs into a variety of understandable communication and command outputs for a nonverbal multi-input and feedback device such as herein. The single framework of a nonverbal multi-input and feedback device comprises sensors 3002a-3002f, input gestures 3004, context awareness 3006, machine learning 3008, output expressions 3010, and destinations 3012. Input gestures 3004 may include touch 3014, movement 3016, mental 3018, glances 3020, audible 3022, and breath 3024. Context awareness 3006 may include time synchronization 3026, configure data sources 3028, configure data processing parameters 3030, configure timing 3032, and metadata tagging 3034. Machine learning 3008 may include an acquire analog data streams 3036, convert to digital data streams 3038, analyze data streams 3040, and execute digital operations for actuation 3042. Output expressions 3010 may include text 3044, symbol 3046, color 3048, an image 3050, sound 3052, and vibration 3054. Destinations 3012 may include a mobile 3056, a wearable 1 3058, a wearable 2 3060, an implant 1 3062, an implant 2 3064, and a prosthetic 1 3066.

FIG. 30 may describe in more detail what kind of processing is happening within and across the blocks of FIG. 29. Specifically, the left intention signals being combined with context awareness metadata to enrich the data in order to determine the logic of the output and action. FIG. 30 may include the description of the GenAI 2908 and application 2902 boxes of FIG. 29, though not shown. It may be a block diagram of a portion of the device such as a processing portion of the device. In the framework, input from the sensors 3002a-3002f (e.g., due to input received by the sensors) are received by or as an input gesture 3004. In the framework, context awareness 3006 awareness is used to interpret or determine the user gesture or intent from the inputs received. In the framework machine learning 3008 is used to interpret or determine the user gesture or intent from the inputs received. In the framework, output expression 3010 is used to determine the outputs, such as control commands and communication sent to other computing devices that include text, graphics, emoji, and/or audio. In the framework, destination 3012 is used to determine where the outputs are sent, such as to what other computing devices the command and/or communications are to be sent (such as by the network). The user's Primary and Secondary language preferences are accessed during the processing of intention data which is stored in the GenAI 2908 subsystem such as shown in FIG. 29, and may be accessed in the context awareness 3006, machine learning 3008 and output and action 2910 systems and methods in FIG. 29 and FIG. 30.

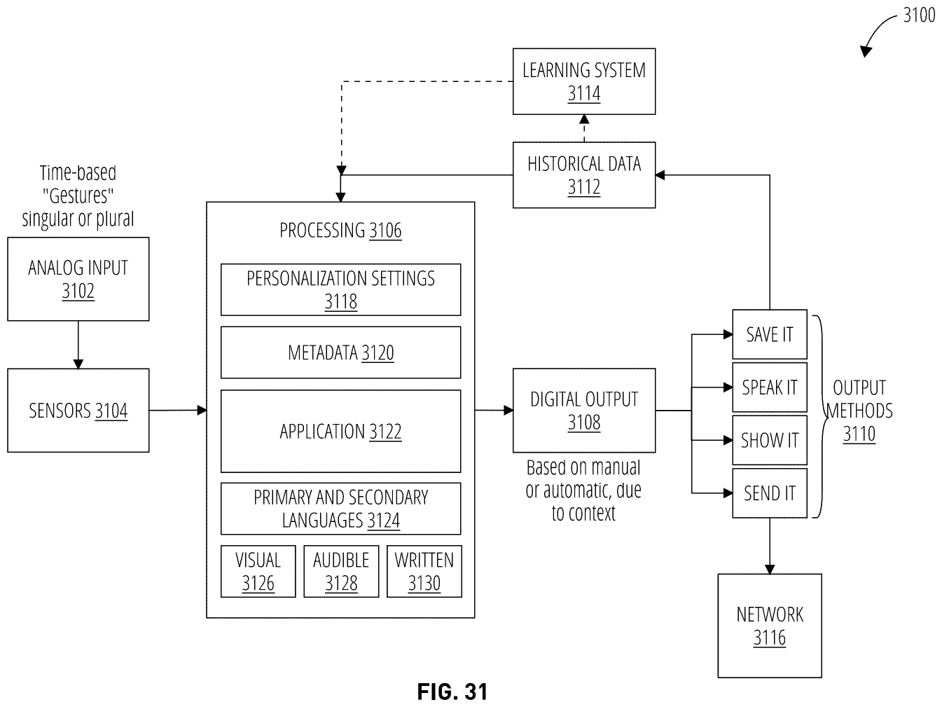

FIG. 31 illustrates a block diagram of nonverbal multi-input and feedback device 3100 in one embodiment. The block diagram of nonverbal multi-input and feedback device 3100 shows a system comprising analog input 3102, sensors 3104, processing 3106, digital output 3108, and output methods 3110 that may be performed with the digital output 3108.

The system illustrated may include an application programming interface (API) that is interoperable with multiple types of analog input 3102 from the sensors 3104. The system illustrated may also comprise a real-time clock for tracking, synchronizing, and metadata 3120 tagging of data streams and analog inputs 3102. The system further comprises a subsystem for data storage and management, for historical data 3112 in some embodiments. The system may comprise a subsystem for personalization settings 3118, as well as a subsystem for sourcing and integrating metadata 3120 into the application 3122 and data stream. The system may further comprise a software application 3122. In some embodiments, the system may include a graphical user interface (GUI) for the software application for the user. In other embodiments, the system may include a GUI for the software application for others who are connected to a system user.

A subsystem of the system may include processing for visual 3126, audible 3128, and written 3130 languages. This language subsystem may differentiate between the user's primary and secondary languages 3124. The language subsystem may set the secondary language manually or automatically. Attributes processed by visual 3126, audible 3128, and written 3130 language subsystems may include but not be limited to color, image, graphics, audible tones, phonemes, dialects, jargon, semantics, tonality, and written characters. In one embodiment, the language subsystems may consist of a suitably trained generative AI model.

The system may include a subsystem of digital outputs 3108 and output methods 3110, that may be configured either manually or automatically. The variety of output methods 3110 may include a network 3116 interface connection. The system may comprise a subsystem for managing data transfer over the network 3116.

The system in some embodiments may comprise a historical data 3112 subsystem for closed-loop machine learning of the system and subsystems and the sensory devices being used with the system. In some embodiments, improved models, algorithms and software may be pushed from the learning system 3114 to update and be used within the system and subsystems and the sensory devices being used with the system.

In one embodiment, the system and subsystems may operate entirely on a sensory device. In one embodiment, the system and subsystems may operate partially on a sensory device and partially distributed to other devices or the cloud. In one embodiment, the system and subsystems may operate entirely distributed on other devices or the cloud.

The system of FIG. 31 may be one embodiment of a fully self-contained brain computer interface in a wireless headset, comprising an augmented reality display as part of the digital output 3108, at least two sensors 3104 for reading a bio-signal from a user as analog input 3102, at least one processing 3106 module for the augmented reality display, at least one biofeedback device that produces at least one of a visual, audible, and tactile effect in communication with the processing module to provide feedback to the user, a wireless network interface that transmits and receives data to and from other devices over the processing 3106, wherein the data is at least one of stored, passed through, and processed on the fully self-contained BCI, as part of the output methods 3110, a battery, wherein the battery provides power to one or more of the augmented reality display, the at least two sensors, the processing module, and the at least one biofeedback device, at least one of onboard storage or remote storage with enough memory to store, process and retrieve the data, and a printed circuit board.

Bio-signals from the user may comprise at least one of EEG, ECG, functional near infrared spectroscopy (fNIRS), Magnetoencephalography (MEG), EMG, EOG, and Time-Domain variants (TD-) of these bio-signal processing methods. Bio-signals may also comprise a visually evoked potential, an audio evoked potential, a haptic evoked potential, and a motion evoked potential, and other bio-signals from multiple sources attached to other body parts other than a user's head.

The at least one processing module for the augmented reality display may include a processor that renders a stimulation effect. This stimulation effect may be at least one of a timed visual stimulation on the augmented reality display, a timed audio stimulation, and a haptic stimulation on the fully self-contained BCI configured to evoke a measurable response in a user's brain. The processing module may include a processor that analyzes and maps the bio-signal into a digital command. This digital command may include at least one of instructions for a visual output configured for displaying on the augmented reality display and instructions for triggering a visual effect. The processing module may be embodied as the processing units 2802 introduced in FIG. 28.

The printed circuit board may include at least one of the at least two sensors, the processing module, the at least one biofeedback device, the battery, and combinations thereof. The printed circuit board may be configured to emulate a Bluetooth keyboard and send output data to at least one of a mobile device, a computer, and the augmented reality display. The output data may include at least one of a letter, a character, a number, and combinations thereof.

Processing performed by the processing module may include the visually evoked potential, the audio evoked potential, and the haptic evoked potential. The bio-signal is processed and analyzed in real-time. The processing module may have different modes, including raw, simmer, and cooked modes, a human interface device-keyboard mode, and combinations thereof. The system may also have a strapless mode, wherein the fully self-contained BCI uses smart glasses or smart contact lenses, an implantable brain computer interface, and an AR system.

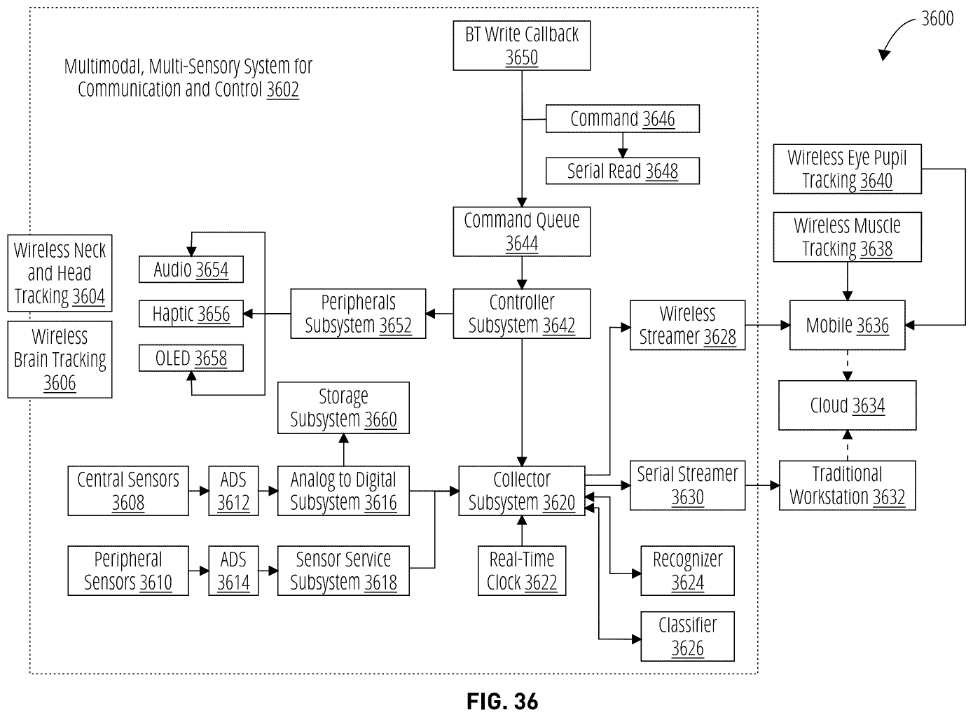

The raw mode may stream a full EEG sensor stream of data for further processing locally on device or remotely in a cloud via a mobile or desktop internet connected device that may filter, recognize, or interact with the full EEG sensor stream of data. The cooked mode may comprise a fully processed custom digital command generated by a local recognizer and classifier. This cooked mode data may consist of a sequence of biosignals tokens, as provided by the EEG tokenizer 2406, the kinematic tokenizer 2408, or the additional tokenizers 2410 introduced with respect to FIG. 24. The fully processed custom digital command may be sent to a destination system over the network 3116, per the “send it” output method 3110, and executed on the destination system, with no raw data passed to the user. The recognizer and classifier may be embodied as the recognizer 3624 and classifier 3626 introduced in FIG. 36. The simmer mode may be a hybrid combination between the raw mode and the cooked mode, and the at least one processing module may intersperse a raw data stream with cooked metadata 3120 appended to bio-signal data.

Time domain data may be appended to raw data, cooked data, and simmer data in order for the system to process bio-signal data streams from multiple bio-signal data sources and ensure all bio-signal data streams are synchronized. Metadata from other sensors and data sources may be appended to the raw data, the cooked data, and the simmer data in order for a classifier to alter the command that is sent to execute on a destination system. This classifier may be embodied as the classifier 3626 introduced in FIG. 36. Visual, audible, and tactile sensory frequency stimulators may be appended with metadata from other sensors 3104 and data sources wherein the visual, audible, and tactile sensory frequency stimulators are altered to produce a unique pattern which includes metadata that is decodable by the recognizer and classifier.

The fully self-contained BCI may be electrically detached from the augmented reality display and may be configured to transfer data wirelessly or via a wired connection to an external augmented reality display. The fully self-contained BCI in the wireless headset may be an accessory apparatus that is configured to be temporarily mechanically integrated with another wearable device and configured to transfer data wirelessly or via a wired connection to the other wearable device. The fully self-contained BCI may in another embodiment be permanently mechanically integrated with another wearable device and may transfer data wirelessly or via a wired connection to the other wearable device.

A charging port may be connected to a charging bridge, wherein the charging bridge includes internal circuitry and data management connected to the fully self-contained BCI and the augmented reality display. The internal circuitry may include charging circuitry, thereby allowing charging of both the fully self-contained BCI and the augmented reality display with the charging circuitry.

The fully self-contained BCI may be configured to generate visual, auditory, or haptic stimulations to a user's visual cortex, a user's auditory cortex, and a user's somatosensory cortex, thereby resulting in detectable brain wave frequency potentials that are at least one of stimulated, event-related, and volitionally evoked. The BCI may process the detectable brain wave frequencies, thereby facilitating mapping of bio-signals to digital commands. Stimulation effects and digital commands may be altered with metadata from other sensors or data sources.

The BCI may synchronize bio-signal processing from multiple sensors with a real-time clock such as the real-time clock 3622 introduced in FIG. 36. Digital commands may be associated with a device. The device may be operated according to the digital commands. The BCI may stimulate the user's visual cortex, wherein stimulating includes biofeedback to the user's visual cortex and biofeedback confirmation of the operating of the device. The BCI may stimulate the user's somatosensory cortex, wherein stimulating includes the biofeedback confirmation of the operating of the device. The BCI may stimulate the user's auditory cortex, wherein the stimulating includes biofeedback confirmation of the operating of the device.

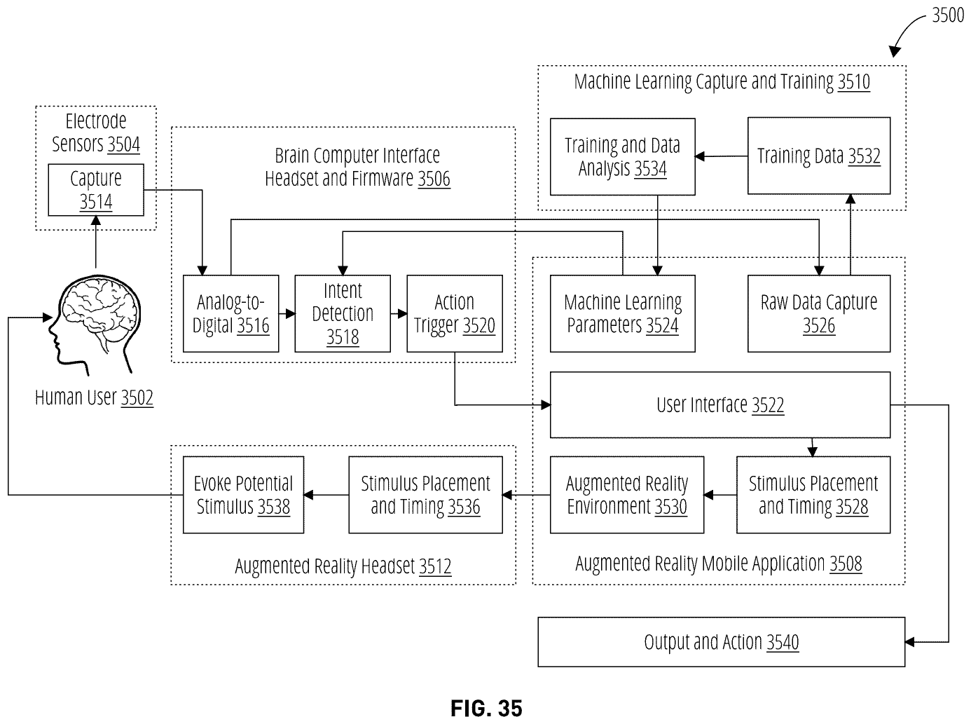

The fully self-contained BCI may be configured to utilize AI machine learning for pattern recognition, classification, and personalization that operates while the fully self-contained BCI is not connected to a network 3116. The AI machine learning may be embodied as the machine learning 3008 introduced in FIG. 30. It may be included in the learning system 3114 of this figure. It may also be supported by the machine learning capture and training 3510 and machine learning parameters 3524 introduced in FIG. 35. The AI machine learning may act as one or more of an auto-tuning dynamic noise reducer, a feature extractor, and a recognizer-categorizer-classifier. AI machine learning training may be applied when the fully self-contained BCI is connected to the network 3116 to create an individualized recognizer-categorizer-classifier. Derived outputs of the AI machine learning training may be stored in a GenAI model in cloud storage or on a mobile computing device having at least one of a wireless connection and a wired connection to the wireless headset and being at least one of mounted on the wireless headset and within wireless network range of the wireless headset. Synthesized insights derived from the AI machine learning and the GenAI may be stored in cloud storage or on the mobile computing device and may be used to generate an individualized executable recognizer-categorizer-classifier downloadable onto the at least one processing 3106 module of the fully self-contained BCI or the mobile computing device via at least one of a wireless connection and a wired connection between the network and a BCI storage device for offline usage without network dependencies. The system may be configured to interface with resource constrained devices including wearable devices, implantable devices, and internet of things (IoT) devices. At least one biofeedback device may be configured to stimulate at least one of a user's central nervous system and peripheral nervous system.

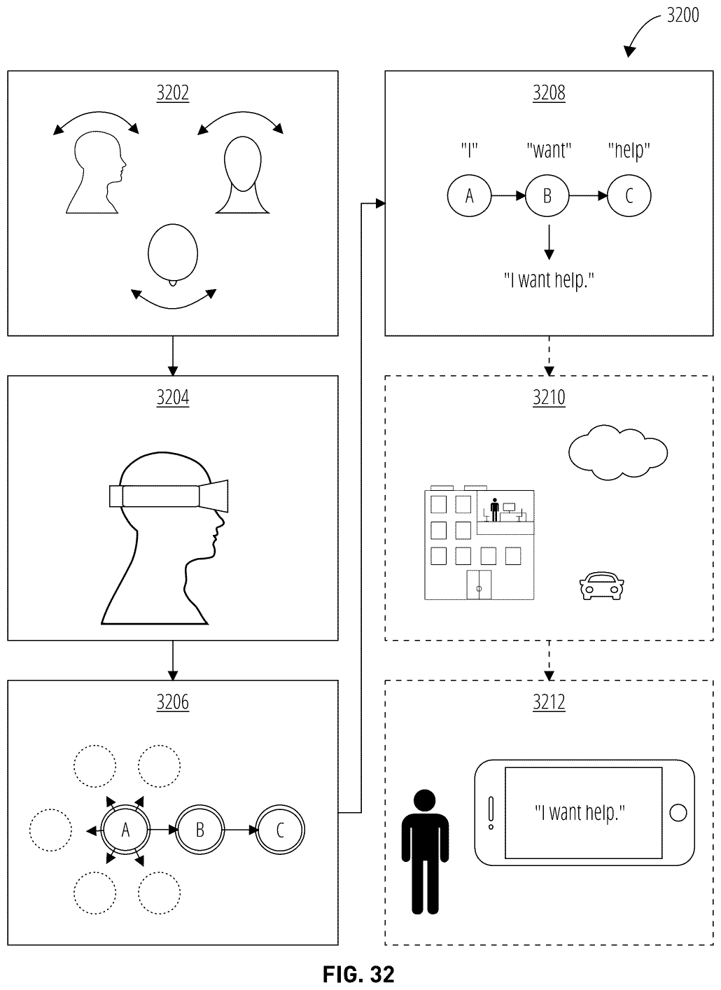

FIG. 32 illustrates a logical diagram of a user wearing an augmented reality headset 3200 that includes a display, speakers and vibration haptic motors and an accelerometer/gyroscope and magnetometer. FIG. 32 shows the flow of activity from head motion analog input 3202 as captured by a headset with head motion detection sensors 3204, through how a user selects options through head motion 3206 and the application creates output based on the user's selected options 3208. On the condition that system detects the user is away from home 3210, FIG. 32 shows that the system may send output to a caregiver via text message 3212.

The user may calibrate the headset based on the most comfortable and stable neck and head position which establishes the X/Y/Z position of 0/0/0. Based on this central ideal position, the user interface is adjusted to conform to the user's individual range of motion, with an emphasis of reducing the amount of effort and distance needed to move a virtual pointer in augmented reality from the 0/0/0 position to outer limits of their field of view and range of motion. The system may be personalized with various ergonomic settings to offset and enhance the users case of use and comfort using the system. A head motion analog input 3202 may be processed as analog streaming data and acquired by the headset with head motion detection sensors 3204 in real-time, and digitally processed, either directly on the sensory device or via a remotely connected subsystem. The system may include embedded software on the sensory device that handles the pre-processing of the analog signal. The system may include embedded software that handles the digitization and post-processing of the signals. Post-processing may include but not be limited to various models of compression, feature analysis, classification, metadata tagging, categorization. The system may handle preprocessing, digital conversion, and post-processing using a variety of methods, ranging from statistical to machine learning. As the data is digitally post-processed, system settings and metadata may be referred to determine how certain logic rules in the application are to operate, which may include mapping certain signal features to certain actions. Based on these mappings, the system operates by sending these post-processed data streams as tokens to the GenAI models and may include saving data locally on the sensory device or another storage device, streaming data to other subsystems or networks.

In the case illustrated in FIG. 32, the user is looking at a display that may include characters, symbols, pictures, colors, videos, live camera footage or other visual, oral or interactive content. In this example, the user is looking at a set of “radial menus” or collection of boxes or circles with data in each one that may be a symbol, character, letter, word or entire phrase. The user has been presented a set of words that surround a central phrase starter word in the middle like a hub and spoke to choose from based on typical functional communication with suggested fringe words and access to predictive keyboard, structured and unstructured language. The user selects options through head motion 3206 and may rapidly compose a phrase by selecting the next desired word presented in the radial menus or adding a new word manually via another input method. The user traverses the interface using head movement gestures, similar to 3-dimensional swipe movements, to compose communication. The user progressively chooses the next word until they're satisfied with the phrase they've composed and may determine how to actuate the phrase. Algorithms may be used to predict the next character, word, or phrase, and may rearrange or alter the expression depending on its intended output including but not limited to appending emoji, symbols, colors, sounds or rearranging to correct for spelling or grammar errors. The user may desire for the phrase to be spoken aloud to a person nearby, thus selecting a “play button” or simply allowing the sentence to time out to be executed automatically. The application creates output based on the user's selected options 3208. If they compose a phrase that is a control command like “turn off the lights”, they may select a “send button” or may, based on semantic natural language processing and understanding, automatically send the phrase to a third party virtual assistant system to execute the command, and turn off the lights. The potential use of metadata, in this example, could simply be geolocation data sourced from other systems such as a geographic information system (GIS) or a global positioning system (GPS) data or WiFi data, or manually personalized geofencing in the application personalization settings, where the system would know if the user is “at home” or “away from home”. On condition that system detects the user is away from home 3210, for example, the metadata may play a role in adapting the language being output to reflect the context of the user. For instance, the system could be configured to speak aloud when at home but send output to a caregiver via text message 3212 and append GPS coordinates when away from home. The system may support collecting and processing historical data from the sensory device, system, subsystems, and output actions to improve the performance and personalization of the system, subsystems, and sensory devices.

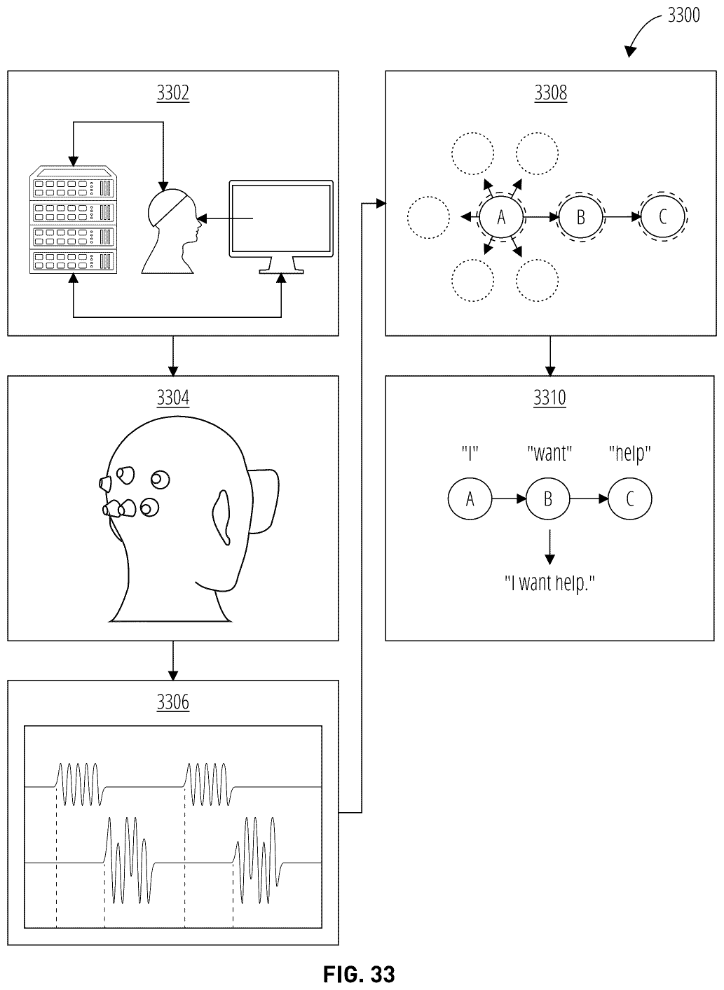

FIG. 33 illustrates a logical diagram of a user wearing an augmented reality headset 3300, in which user wears an EEG-based brain-computer interface headset 3302 containing electrodes that are contacting the scalp 3304. FIG. 33 shows that streaming analog data may be acquired from the brainwave activity 3306. In this manner, the user may be presented a set of words to choose from 3308, compose a phrase, and select what action the system takes using the phrase they've composed 3310.

A user wears an EEG-based brain-computer interface headset 3302 containing electrodes that are contacting the scalp 3304. The electrodes are connected to an amplifier and analog-to-digital processing pipeline. The sensory device (BCI) acquires streaming electrical current data measured in microvolts (uV). The more electrodes connected to the scalp and to the BCI, the more streaming analog data may be acquired from the brainwave activity 3306. The analog streaming data is acquired by the electrodes, pre-processed through amplification, and digitally processed, either directly on the sensory device or via a remotely connected subsystem. The system may include embedded software on the sensory device that handles the pre-processing of the analog signal. The system may include embedded software that handles the digitization and post-processing of the signals. Post-processing may include but not be limited to various models of compression, feature analysis, classification, metadata tagging, categorization. The system may handle preprocessing, digital conversion, and post-processing using a variety of methods, ranging from statistical to machine learning. As the data is digitally post-processed, system settings and metadata may be referred to determine how certain logic rules in the application are to operate, which may include mapping certain signal features to certain actions. Based on these mappings, the system operates by executing commands and may include saving data locally on the sensory device or another storage device, streaming data to other subsystems or networks.

In the case illustrated in FIG. 33, the user is looking at a display that may include characters, symbols, pictures, colors, videos, live camera footage or other visual, oral or interactive content. In this example, the user is looking at a group of concentric circles, arranged in a radial layout, with characters on each circle. The user has been presented a set of words to choose from 3308 based on typical functional communication with suggested fringe words and access to predictive keyboard and may rapidly compose a phrase by selecting the next desired word presented in the outer ring of circles or adding a new word manually. The user progressively chooses the next word until they're satisfied with the phrase they've composed 3310 and may determine how to actuate the phrase. GenAI may be used to predict the next character, word, or phrase, and may rearrange or alter the expression depending on its intended output including but not limited to appending emoji, symbols, colors, sounds or rearranging to correct for spelling or grammar errors. The user may desire for the phrase to be spoken aloud to a person nearby, thus selecting a “play button” or simply allowing the sentence to time out to be executed automatically. If they compose a phrase that is a control command like “turn off the lights”, they may select a “send button” or may, based on semantic natural language processing and understanding, automatically send the phrase to a third party virtual assistant system to execute the command, and turn off the lights. The potential use of metadata, in this example, could simply be geolocation data sourced from other systems such as GIS or GPS data or WiFi data, or manually personalized geofencing in the application personalization settings, where the system may know if the user is “at home” or “away from home”. In this case, the metadata may play a role in adapting the language being output to reflect the context of the user. For instance, the system could be configured to speak aloud when at home but send to a caregiver via text message and append GPS coordinates when away from home. The system may support collecting and processing historical data from the sensory device, system, subsystems, and output actions to improve the performance and personalization of the system, subsystems, and sensory devices.

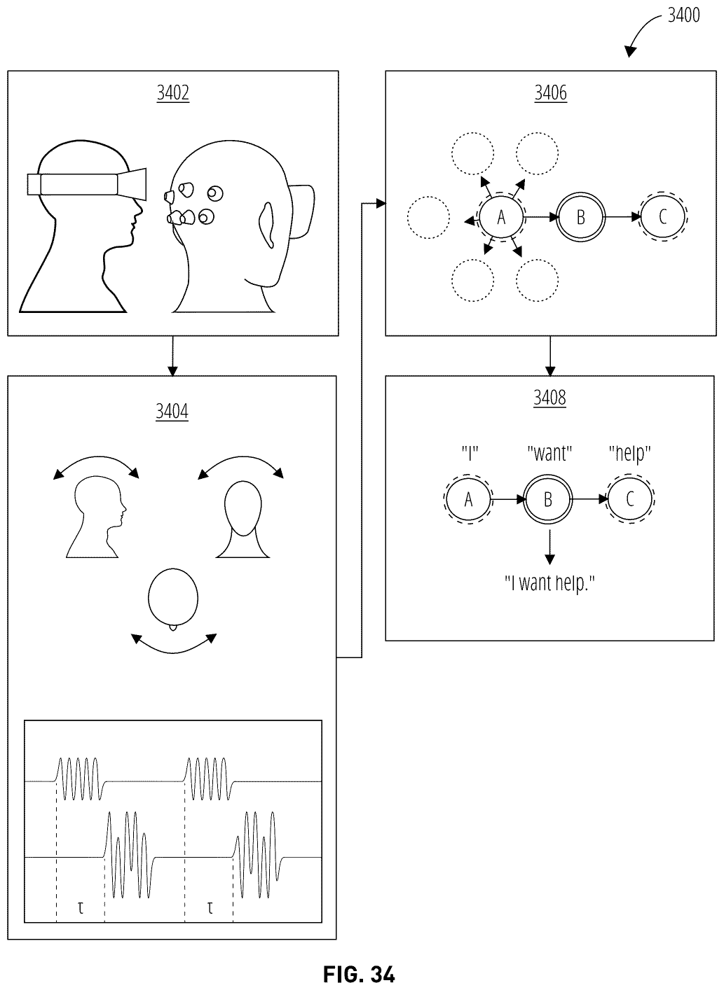

FIG. 34 illustrates a diagram of a use case including a user wearing an augmented reality headset 3400, in which a user wears an augmented reality headset combined with a brain computer interface 3402, having the capabilities described with respect to FIG. 32 and FIG. 33. Both head motion analog input and brainwave activity 3404 may be detected and may allow a user to select from a set of words to choose from 3406, as well as what to do with the phrase they've composed 3408 by selecting those words.

A user is wearing an augmented reality headset combined with a brain computer interface on their head. The headset contains numerous sensors as a combined sensory device including motion and orientation sensors and temporal bioelectric data generated from the brain detected via EEG electrodes contacting the scalp of the user, specifically in the regions where visual, auditory and sensory/touch is processed in the brain. The AR headset may produce visual, auditory or haptic stimulation that is detectible via the brain computer interface, and by processing brainwave data with motion data, the system may provide new kinds of multi-modal capabilities for a user to control the system. The analog streaming data is acquired by the Accelerometer, Gyroscope, Magnetometer and EEG analog-to-digital processor, and digitally processed, either directly on the sensory device or via a remotely connected subsystem. The system may include embedded software on the sensory device that handles the pre-processing of the analog signal. The system may include embedded software that handles the digitization and post-processing of the signals. Post-processing may include but not be limited to various models of compression, feature analysis, classification, metadata tagging, categorization. The system may handle preprocessing, digital conversion, and post-processing using a variety of methods, ranging from statistical to machine learning. As the data is digitally post-processed, system settings and metadata may be referred to determine how certain logic rules in the application are to operate, which may include mapping certain signal features to certain actions. Based on these mappings, the system operates by executing commands and may include saving data locally on the sensory device or another storage device, streaming data to other subsystems or networks.

In the case illustrated in FIG. 34, the user is looking at a display that may include characters, symbols, pictures, colors, videos, live camera footage or other visual, oral or interactive content. In this example, the user is looking at a visual menu system in AR with certain hard to reach elements flickering at different frequencies. The user has been presented a set of items to choose from based on typical functional communication with suggested fringe words and access to predictive keyboard and may rapidly compose a phrase by selecting the next desired word presented in the AR head mounted display or adding a new word manually. Supporting the user affordances of extra-sensory reach of visible objects out of reach within the comfortable range of motion of neck movement. The user progressively chooses the next word until they're satisfied with the phrase they've composed and may determine how to actuate the phrase. Algorithms may be used to predict the next character, word, or phrase, and may rearrange or alter the expression depending on its intended output including but not limited to appending emoji, symbols, colors, sounds or rearranging to correct for spelling or grammar errors. The user may desire for the phrase to be spoken aloud to a person nearby, thus selecting a “play button” or simply allowing the sentence to time out to be executed automatically. If they compose a phrase that is a control command like “turn off the lights”, they may select a “send button” or may, based on semantic natural language processing and understanding, automatically send the phrase to a third party virtual assistant system to execute the command, and turn off the lights. The potential use of metadata, in this example, could simply be geolocation data sourced from other systems such as GIS or GPS data or WIFI data, or manually personalized geofencing in the application personalization settings, where the system may know if the user is “at home” or “away from home”. In this case, the metadata may play a role in adapting the language being output to reflect the context of the user. For instance, the system could be configured to speak aloud when at home but send to a caregiver via text message and append GPS coordinates when away from home. The system may support collecting and processing historical data from the sensory device, system, subsystems, and output actions to improve the performance and personalization of the system, subsystems, and sensory devices.

FIG. 35 is a flow diagram 3500 showing a closed loop bio-signal data flow for a nonverbal multi-input and feedback device such as herein. It may be performed by inputs or a computer of the device. The flow diagram 3500 comprises a human user 3502, electrode sensors 3504, a brain computer interface headset and firmware 3506, an augmented reality mobile application 3508, machine learning capture and training 3510 that may be performed in an edge, peer, or cloud device, and an augmented reality headset 3512. The electrode sensors 3504 may capture 3514 data that is sent for analog-to-digital 3516 conversion. The digital signal may be used for intent detection 3518 resulting in an action trigger 3520 to a user interface 3522. The digital data may further be sent to raw data capture 3526 and may be used as training data 3532 for training and data analysis 3534. Training and data analysis 3534 may yield machine learning parameters 3524 which may be fed back for use in intent detection 3518. The user interface 3522 may determine stimulus placement and timing 3528, which may be used in the augmented reality environment 3530 created by the augmented reality mobile application 3508. The stimulus placement and timing 3536 resulting in the augmented reality headset 3512 and may evoke potential stimulus 3538 in the human user 3502. The user interface 3522 may also generate an output and action 3540.

The flow diagram 3500 includes computer stimulates visual, auditory and somatosensory cortex with evoked potentials; signal processing of real time streaming brain response; human controls computer based on mental fixation of stimulation frequencies; and system may determine different output or actions on behalf of the user for input data received via one or more sensors of the device. Flow diagram 3500 may apply to a user wearing any of the nonverbal multi-input and feedback devices and/or sensors herein. As a result of this being closed-loop biofeedback and sensory communication and control system that stimulates the brains senses of sight, sound, and touch and reads specific stimulation time-based frequencies, and tags them with metadata in real-time as the analog data is digitized, the user may rapidly learn how to navigate and interact with the system using their brain directly. This method of reinforcement learning is known in the rapid development process of the brain's pattern recognition abilities and the creation of neural plasticity to develop new neural connections based on stimulation and entrainment. This further allows the system to become a dynamic neural prosthetic extension of their physical and cognitive abilities. The merging of context awareness metadata, vocabulary, and output and action logic into the central application in addition to a universal interface for signal acquisition and data processing is what makes this system extremely special. Essentially, this system helps reduce the time latency between detecting cognitive intention and achieving the associated desired outcome, whether that be pushing a button, saying a word or controlling robots, prosthetics, smart home devices or other digital systems.

FIG. 36 is a flow diagram 3600 showing multimodal, multi-sensory system for communication and control 3602 for a nonverbal multi-input and feedback device such as herein. It may be performed by inputs or a computer of the device. The flow diagram 3600 comprises multimodal, multi-sensory systems for communication and control 3602 that includes wireless neck and head tracking 3604 and wireless brain tracking 3606. The multimodal, multi-sensory system for communication and control 3602 may further comprise central sensors 3608 for EEG, peripheral sensors 3610 such as EMG, EOG, ECG, and others, an analog to digital signal processor 3612 processing data from the central sensors 3608, and an analog to digital signal processor 3614 processing data from the peripheral sensors 3610. The analog to digital subsystem 3616 and sensor service subsystem 3618 manage output from the analog to digital signal processor 3612 and the analog to digital signal processor 3614, respectively. Output from the analog to digital subsystem 3616 may be sent to a storage subsystem 3660.

Outputs from the analog to digital subsystem 3616 and sensor service subsystem 3618 go to a collector subsystem 3620, which also receives a real-time clock 3622. The collector subsystem 3620 communicates with a recognizer 3624 for EEG data and a classifier 3626 for EMG, EOG, and ECG data, and data from other sensing. The collector subsystem 3620 further communicates to a wireless streamer 3628 and a serial streamer 3630 to interface with a miniaturized mobile computing system 3636 and a traditional workstation 3632, respectively. The traditional workstation 3632 and miniaturized mobile computing system 3636 may communicate with a cloud 3634 for storage or processing. The miniaturized mobile computing system 3636 may assist in wireless muscle tracking 3638 (e.g., EMG data) and wireless eye pupil tracking 3640.

A controller subsystem 3642 accepts input from a command queue 3644 which accepts input from a Bluetooth or BT write callback 3650. The BT write callback 3650 may send commands 3646 to a serial read 3648. The controller subsystem 3642 may send output to the controller subsystem 3642 and a peripherals subsystem 3652. The peripherals subsystem 3652 generates audio feedback 3654, haptic feedback 3656, and organic LED or OLED visual feedback 3658 for the user.

The flow diagram 3600 includes synchronizing signals from multiple biosensors including brain, body (see skin colored arm), eye and movement; processing multiple models concurrently for multi-sensory input; and directing and processing biofeedback through peripheral subsystems. Flow diagram 3600 may apply to a user wearing any of the nonverbal multi-input and feedback devices and/or sensors herein.

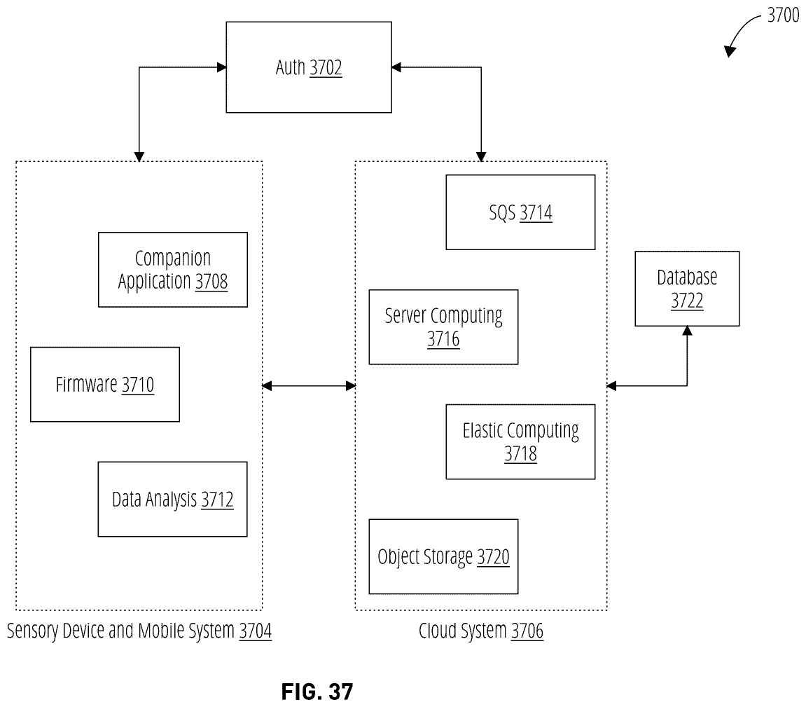

FIG. 37 is a block diagram 3700 showing an example of cloud processing for a nonverbal multi-input and feedback device such as herein. The block diagram 3700 comprises data authentication 3702, a sensory device and mobile system 3704, a cloud system 3706, and a database 3722. The data authentication 3702 module may be configured to authenticate data and communicate with the sensory device and mobile system 3704 and cloud system 3706. The sensory device and mobile system 3704 may include companion application 3708 and data collection, firmware 3710 and data collection, and data analysis 3712 or raw and processed data. The cloud system 3706 may comprise simple queue service or SQS message queuing 3714, server computing 3716 to analyze raw and process data, clastic computing 3718 to build, train, and test machine learning models, and object storage 3720 for persistent storage of biodata, machine learning, and metadata. The database 3722 stores associations and metadata and is in communication with the cloud system 3706.

Block diagram 3700 has the cloud system, the nonverbal multi-input device and an authorization system. Block diagram 3700 includes: machine learning processing signal data on device; metadata enrichment; push raw and processed data to cloud; cloud application building new models for devices; system updates devices remotely and wirelessly; secure and privacy compliant. This configuration is quite powerful but unassumingly simple in this block diagram.

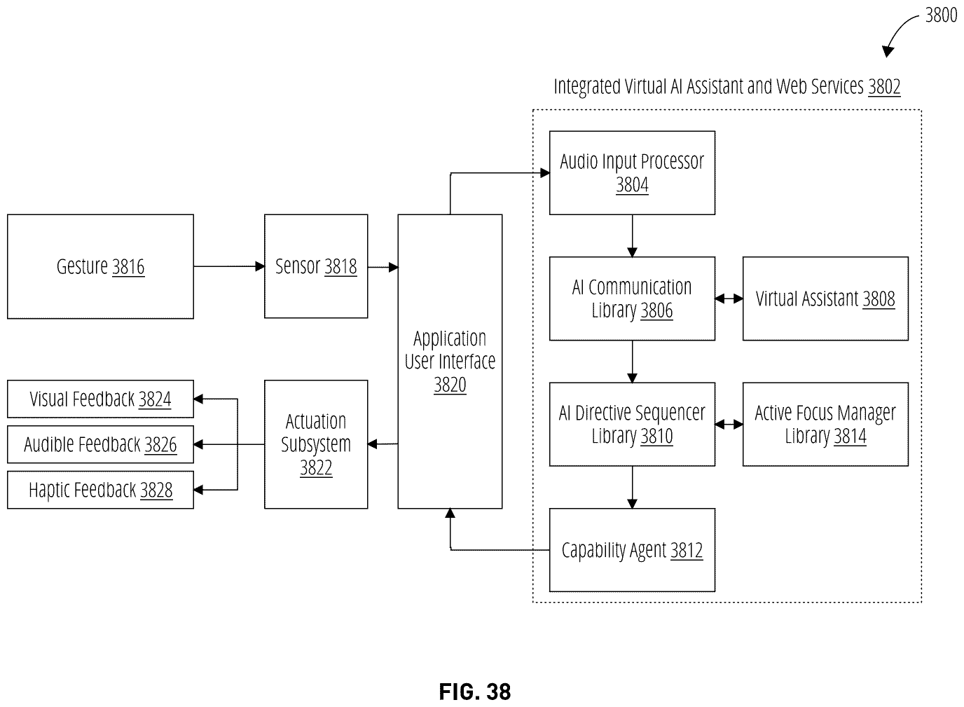

FIG. 38 is a block diagram 3800 showing an example of a system architecture for integrated virtual AI assistant and web services 3802 for a nonverbal multi-input and feedback device such as herein. The block diagram 3800 comprises integrated virtual AI assistant and web services 3802 which may include an audio input processor 3804, an AI communication library 3806, a virtual assistant 3808 such as Alexa, an AI directive sequencer library 3810, a capability agent 3812, and an active focus manager library 3814. A gesture 3816 from a user may be detected by a sensor 3818. An application user interface 3820 may process sensor data and may send data to the audio input processor 3804. The capability agent 3812 may send data back to the application user interface 3820. The application user interface 3820 may signal an actuation subsystem 3822 to provide visual feedback 3824, audible feedback 3826, and haptic feedback 3828.

The block diagram 3800 includes: system manages intention signal acquisition, processing, language composition, and output; in the event where a user wants to send their intention to a virtual assistant (like Alexa, Siri). The blocks outside of the dashed border run on the sensory device, and currently, the blocks inside the dashed line are running in the cloud (e.g., represent a custom configuration for how to use the Alexa service in a cloud architecture.) It may also be possible that all of what is described here as in the cloud may run locally in the sensory device.

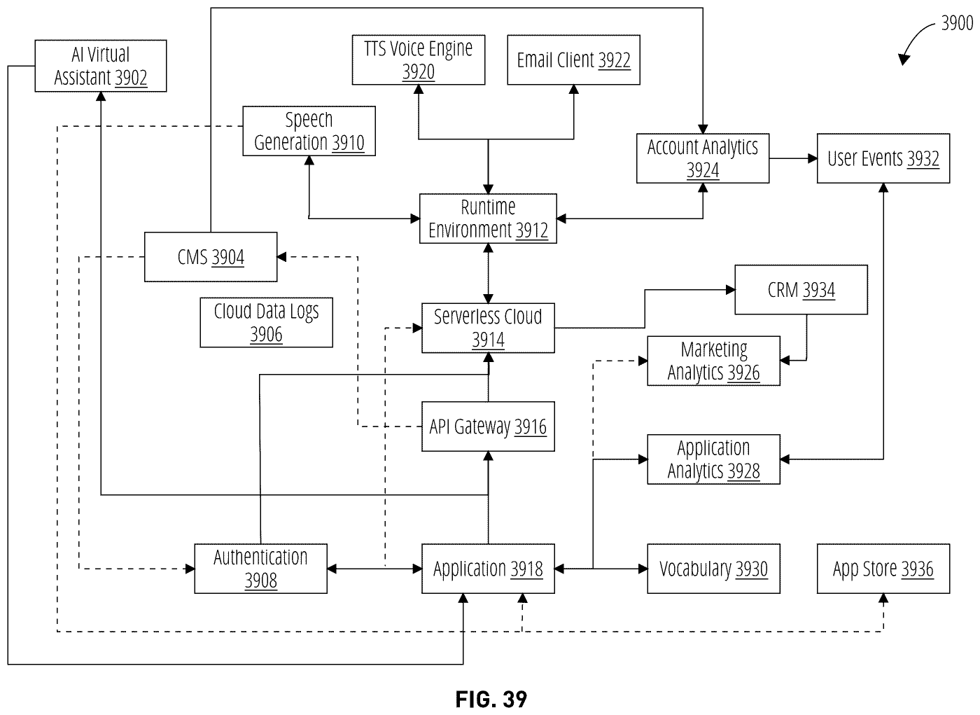

FIG. 39 is a block diagram 3900 showing an example of system operations for a nonverbal multi-input and feedback device such as herein. The block diagram 3900 comprises an AI virtual assistant 3902, such as Alexa, a content management system 3904, cloud data logs 3906, authentication 3908, speech generation 3910, a runtime environment 3912, a serverless cloud 3914, an API gateway 3916, an application 3918, a text-to-speech or TTS voice engine 3920, an email client 3922, account analytics 3924, marketing analytics 3926, application analytics 3928, a vocabulary 3930, user events 3932, a customer relations management 3934, and an app store 3936.

Block diagram 3900 includes: system operation blocks including authentication. This is an example of the complexity of a system operating in the cloud. Everything in this figure is in the cloud, except for the application that is running on the sensory device. The augment/virtual reality application 3918 for the nonverbal multi-input and feedback device may interface with an authentication 3908 module, an API gateway 3916, a vocabulary 3930, application analytics 3928, AI virtual assistant 3902, and marketing analytics 3926. The AI virtual assistant 3902 may communicate back to the application 3918. The application 3918 may also be in direct communication with a serverless cloud 3914 or may communicate with the serverless cloud 3914 through the API gateway 3916. Authentication 3908 may also be in communication with the serverless cloud 3914. The API gateway 3916 further allows the application 3918 to communicate with the content management system 3904, which may be used to store cloud data logs 3906. The content management system 3904 may send data back to the application 3918 through the authentication 3908 module, which may act as a gateway to ensure security and content authorization. Finally, the content management system 3904 may provide data to an account analytics 3924 module. Account analytics 3924 may provide data to a user events 3932 module, which may in turn feed data to application analytics 3928.

The serverless cloud 3914 may allow communication with the runtime environment 3912 and the customer relations management 3934 module. The customer relations management 3934 may provide data for marketing analytics 3926. The runtime environment 3912 may interface with speech generation 3910, a TTS voice engine 3920, an email client 3922, and account analytics 3924. Speech generation 3910 may allow a user to access an app store 3936.

FIG. 40 illustrates an embodiment of a computing device 4000 to implement components and process steps of the system described herein.

Input devices 4004 comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 4004 are keyboards which respond to touch or physical pressure from an object or proximity of an object to a surface, mice which respond to motion through space or across a plane, microphones which convert vibrations in the medium (typically air) into device signals, scanners which convert optical patterns on two or three dimensional objects into device signals. The signals from the input devices 4004 are provided via various machine signal conductors (e.g., busses or network interfaces) and circuits to memory 4006.

The memory 4006 is typically what is known as a first or second level memory device, providing for storage (via configuration of matter or states of matter) of signals received from the input devices 4004, instructions and information for controlling operation of the central processing unit or CPU 4002, and signals from storage devices 4010.

The memory 4006 and/or the storage devices 4010 may store computer-executable instructions 4016 and thus forming logic 4014 that when applied to and executed by the CPU 4002 implement embodiments of the processes disclosed herein.

Information stored in the memory 4006 is typically directly accessible to the CPU 4002 of the device. Signals input to the device cause the reconfiguration of the internal material/energy state of the memory 4006, creating in essence a new machine configuration, influencing the behavior of the computing device 4000 by affecting the behavior of the CPU 4002 with control signals (instructions) and data provided in conjunction with the control signals.

Second or third level storage devices 4010 may provide a slower but higher capacity machine memory capability. Examples of storage devices 4010 are hard disks, optical disks, large capacity flash memories or other non-volatile memory technologies, and magnetic memories.

The CPU 4002 may cause the configuration of the memory 4006 to be altered by signals in storage devices 4010. In other words, the CPU 4002 may cause data and instructions to be read from storage devices 4010 in the memory 4006 from which may then influence the operations of CPU 4002 as instructions and data signals, and from which it may also be provided to the output devices 4008. The CPU 4002 may alter the content of the memory 4006 by signaling to a machine interface of memory 4006 to alter the internal configuration, and then converted signals to the storage devices 4010 to alter its material internal configuration. In other words, data and instructions may be backed up from memory 4006, which is often volatile, to storage devices 4010, which are often non-volatile.

Output devices 4008 are transducers which convert signals received from the memory 4006 into physical phenomenon such as vibrations in the air, or patterns of light on a machine display, or vibrations (i.e., haptic devices) or patterns of ink or other materials (i.e., printers and 3-D printers).

The network interface 4012 receives signals from the memory 4006 and converts them into electrical, optical, or wireless signals to other machines, typically via a machine network.

The network interface 4012 also receives signals from the machine network and converts them into electrical, optical, or wireless signals to the memory 4006.

Terms used herein may be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting that operation or function. For example, an association operation may be carried out by an “associator” or “correlator”. Likewise, switching may be carried out by a “switch”, selection by a “selector”, and so on.

As shown in FIG. 41, computer system/server 4102 in cloud computing node 4100 is shown in the form of a general-purpose computing device. The components of computer system/server 4102 may include, but are not limited to, one or more processors or processing units 4106, a system memory 4104, and a bus 4126 that couples various system components, including system memory 4104, to processing units 4106.

Bus 4126 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 4102 typically includes a variety of computer system readable media. Such media may be any available media that is accessible by computer system/server 4102, and it includes both volatile and non-volatile media, removable and non-removable media.

System memory 4104 may include computer system readable media in the form of volatile memory, such as Random access memory (RAM) 4108 and/or cache memory 4112. Computer system/server 4102 may further include other removable/non-removable, volatile/non-volatile computer system storage media. By way of example, a storage system 4120 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media may be provided. In such instances, each may be connected to bus 4126 by one or more data media interfaces. As will be further depicted and described below, system memory 4104 may include at least one program product having a set (e.g., at least one) of program modules that are configured to carry out the functions of the present disclosure.

Program/utility 4122 having a set (at least one) of program modules 4124 may be stored in system memory 4104 by way of example, and not limitation, as well as an operating system, one or more application programs, other program modules, and program data. Each of the operating system, one or more application programs, other program modules, and program data or some combination thereof, may include an implementation of a networking environment. Program modules 4124 generally carry out the functions and/or methodologies of the present disclosure as described herein.

Computer system/server 4102 may also communicate with one or more external devices 4114 such as a keyboard, a pointing device, a display 4116, etc.; one or more devices that allow a user to interact with computer system/server 4102; and/or any devices (e.g., network card, modem, etc.) that allow computer system/server 4102 to communicate with one or more other computing devices. Such communication may occur via I/O interfaces 4110. Computer system/server 4102 may communicate with one or more networks such as a local area network (LAN), a general wide area network (WAN), and/or a public network (e.g., the Internet) via network adapter 4118. As depicted, network adapter 4118 communicates with the other components of computer system/server 4102 via bus 4126. It may readily be understood that although not shown, other hardware and/or software components may be used in conjunction with computer system/server 4102. Examples include, but are not limited to: microcode, device drivers, redundant processing units, external disk drive arrays, RAID systems, tape drives, and data archival storage systems, etc.

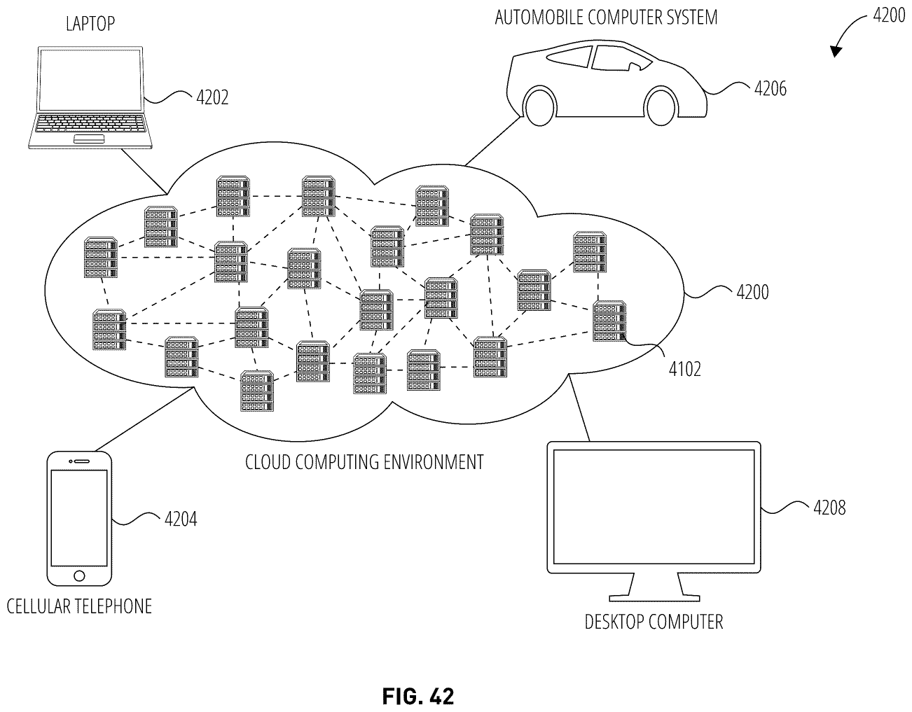

Referring now to FIG. 42, illustrative cloud computing environment 4200 is depicted. As shown, cloud computing environment 4200 comprises one or more cloud computing nodes 4100 with which computing devices such as, for example, a laptop 4202, a personal digital assistant (PDA) or cellular telephone 4204, an automobile computer system 4206, and/or a desktop computer 4208 may communicate. This allows for infrastructure, platforms, and/or software to be offered as services from cloud computing environment 4200, so that each client need not separately maintain such resources. It is understood that the types of computing devices shown in FIG. 42 are intended to be illustrative and that a cloud computing environment 4200 may communicate with any type of computerized device over any type of network and/or network/addressable connection (e.g., using a web browser).

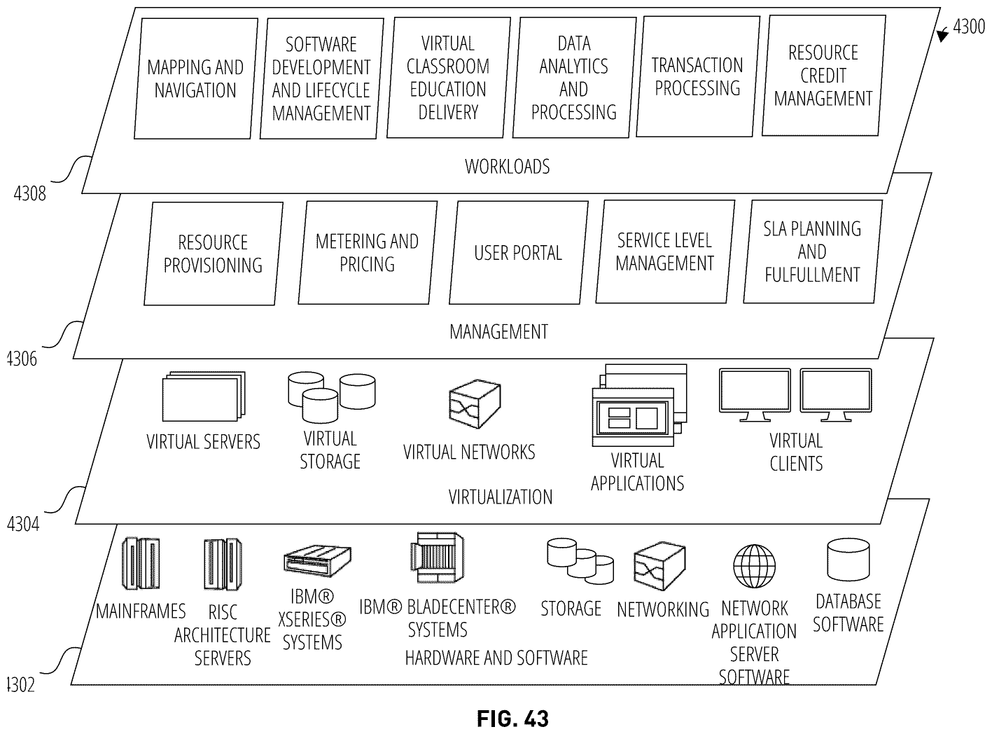

Referring now to FIG. 43, a set of functional abstraction layers provided by a cloud computing environment 4200 such as is illustrated in FIG. 42. It may be understood in advance that the components, layers, and functions shown in FIG. 43 are intended to be illustrative, and the present disclosure is not limited thereto. As depicted, the following layers and corresponding functions are provided:

Hardware and software layer 4302 includes hardware and software components. Examples of hardware components include mainframes. In one example, IBM® zSeries® systems and RISC (Reduced Instruction Set Computer) architecture based servers. In one example, IBM pSeries® systems, IBM xSeries® systems, IBM BladeCenter® systems, storage devices, networks, and networking components. Examples of software components include network application server software. In one example, IBM WebSphere® application server software and database software. In one example, IBM DB2® database software. (IBM, zSeries, pSeries, xSeries, BladeCenter, WebSphere, and DB2 are trademarks of International Business Machines Corporation in the United States, other countries, or both.)

Virtualization layer 4304 provides an abstraction layer from which the following exemplary virtual entities may be provided: virtual servers; virtual storage; virtual networks, including virtual private networks; virtual applications; and virtual clients.

Management layer 4306 provides the exemplary functions described below. Resource provisioning provides dynamic procurement of computing resources and other resources that are utilized to perform tasks within the Cloud computing environment. Metering and Pricing provide cost tracking as resources are utilized within the Cloud computing environment, and billing or invoicing for consumption of these resources. In one example, these resources may comprise application software licenses. Security provides identity verification for users and tasks, as well as protection for data and other resources. User portal provides access to the Cloud computing environment for both users and system administrators. Service level management provides Cloud computing resource allocation and management such that desired service levels are met. Service Level Agreement (SLA) planning and fulfillment provides pre-arrangement for, and procurement of, Cloud computing resources for which a future need is anticipated in accordance with an SLA.

Workloads layer 4308 provides functionality for which the Cloud computing environment is utilized. Examples of workloads and functions which may be provided from this layer include: mapping and navigation; software development and lifecycle management; virtual classroom education delivery; data analytics processing; transaction processing; and resource credit management. As mentioned above, all of the foregoing examples described with respect to FIG. 43 are illustrative, and the present disclosure is not limited to these examples.

FIG. 44 illustrates an exemplary tokenizer 4400 in accordance with one embodiment. data to be tokenized 4402 may be provided to the exemplary tokenizer 4400 in the form of a text string typed by a user. In one embodiment, the text string may be generated by performing voice-to-text conversion on an audio stream. The exemplary tokenizer 4400 may detect tokenizable elements 4404 within the data to be tokenized 4402. Each tokenizable element 4404 may be converted into a token 4406. The set of tokens 4406 created from the tokenizable elements 4404 of the data to be tokenized 4402 may be sent from the exemplary tokenizer 4400 as tokenized output 4408. The set of tokens 4406 may be such as are used to create the prompt 2344 of FIG. 23.

For structured historical data such as plaintext, database, or web-based textual content, tokens may consist of the numerical indexes in an embedded or vectorized (e.g., word2vec or similar) representation of the text content such as are shown here. In some embodiments, a machine learning technique called an autoencoder may be utilized to transform plaintext inputs into high dimensional vectors that are suitable for indexing and tokenization ingestion by the prompt composer 2316 introduced with respect to FIG. 23.

In some embodiments, data to be tokenized may include audio, visual, or other multimodal data. For images, video, and similar visual data, tokenization may be performed using a convolution-based tokenizer such as a vision transformer. In some alternate embodiments, multimodal data may be quantized and converted into tokens 4406 using a codebook. In yet other alternate embodiments, multimodal data may be directly encoded and for presentation to a language model as a vector space encoding. An exemplary system that utilizes this tokenizer strategy is Gato, a generalist agent capable of ingesting a mixture of discrete and continuous inputs, images, and text as tokens.

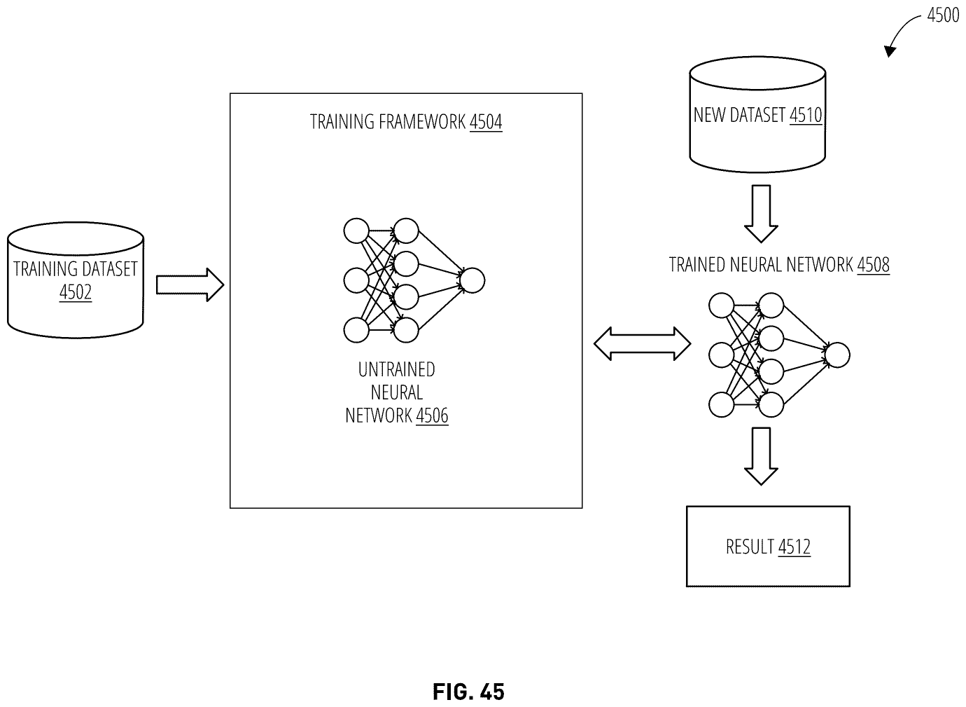

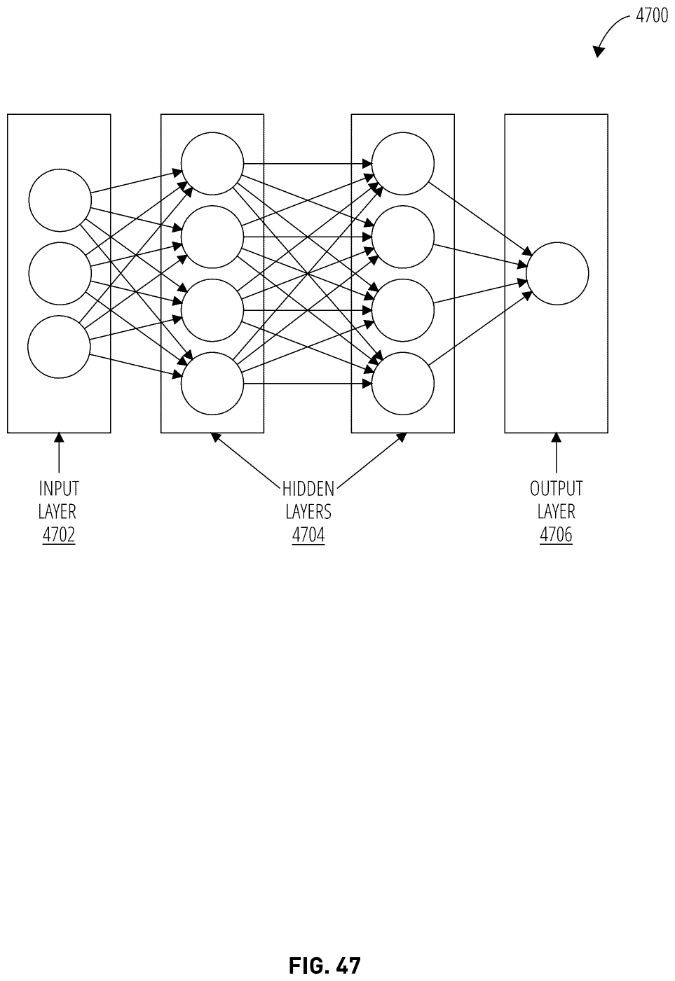

FIG. 45 illustrates the training and deployment of a deep neural network 4500, such as the basic deep neural network 4700 illustrated in FIG. 47, according to at least one embodiment. In at least one embodiment, untrained neural network 4506 is trained using a training dataset 4502. In at least one embodiment, training framework 4504 is a PyTorch framework, whereas in other embodiments, training framework 4504 is a TensorFlow, Boost, Caffe, Microsoft Cognitive Toolkit/CNTK, MXNet, Chainer, Keras, Deeplearning4j, or another training framework. In at least one embodiment, training framework 4504 trains an untrained neural network 4506 and allows it to be trained using processing resources described herein to generate a trained neural network 4508. In at least one embodiment, weights may be chosen randomly or by pre-training using a deep belief network. In at least one embodiment, training may be performed in either a supervised, partially supervised, or unsupervised manner.

In at least one embodiment, untrained neural network 4506 is trained using supervised learning, wherein training dataset 4502 includes an input paired with a desired output for the input, or where training dataset 4502 includes input having a known output and an output of untrained neural network 4506 is manually graded. In at least one embodiment, untrained neural network 4506 is trained in a supervised manner, processes inputs from training dataset 4502, and compares resulting outputs against a set of expected or desired outputs. In at least one embodiment, errors are then propagated back through untrained neural network 4506. In at least one embodiment, training framework 4504 adjusts weights that control untrained neural network 4506. In at least one embodiment, training framework 4504 includes tools to monitor how well untrained neural network 4506 is converging towards a model, such as trained neural network 4508, suitable to generating correct answers, such as in result 4512, based on input data such as a new dataset 4510. In at least one embodiment, training framework 4504 trains untrained neural network 4506 repeatedly while adjusting weights to refine an output of untrained neural network 4506 using a loss function and adjustment algorithm, such as stochastic gradient descent. In at least one embodiment, training framework 4504 trains untrained neural network 4506 until untrained neural network 4506 achieves the desired accuracy. In at least one embodiment, trained neural network 4508 may then be deployed to implement any number of machine learning operations.

In at least one embodiment, untrained neural network 4506 is trained using unsupervised learning, wherein untrained neural network 4506 attempts to train itself using unlabeled data. In at least one embodiment, an unsupervised learning training dataset 4502 will include input data without any associated output data or “ground truth” data. In at least one embodiment, untrained neural network 4506 may learn groupings within training dataset 4502 and may determine how individual inputs are related to other data in the training dataset 4502. In at least one embodiment, unsupervised training may be used to generate a self-organizing map in a trained neural network 4508 capable of performing operations useful in reducing the dimensionality of the new dataset 4510. In at least one embodiment, unsupervised training may also be used to perform anomaly detection, which allows the identification of data points in new dataset 4510 that deviate from normal patterns of new dataset 4510.

In at least one embodiment, semi-supervised learning may be used, which is a technique in which training dataset 4502 includes a mix of labeled and unlabeled data. In at least one embodiment, training framework 4504 may be used to perform incremental learning, such as through transferred learning techniques. In at least one embodiment, incremental learning allows trained neural network 4508 to adapt to new dataset 4510 without forgetting knowledge instilled within trained neural network 4508 during initial training. A trained neural network 4508 such as the one described may be used as the basis for AI and ML models such as may be used in computational systems to analyze complex data and provide results based on that analysis productive toward the improved knowledge or task action performance of people and computational and robotic systems.

The following figures set forth, without limitation, exemplary artificial intelligence-based systems that may be used to implement at least one embodiment.

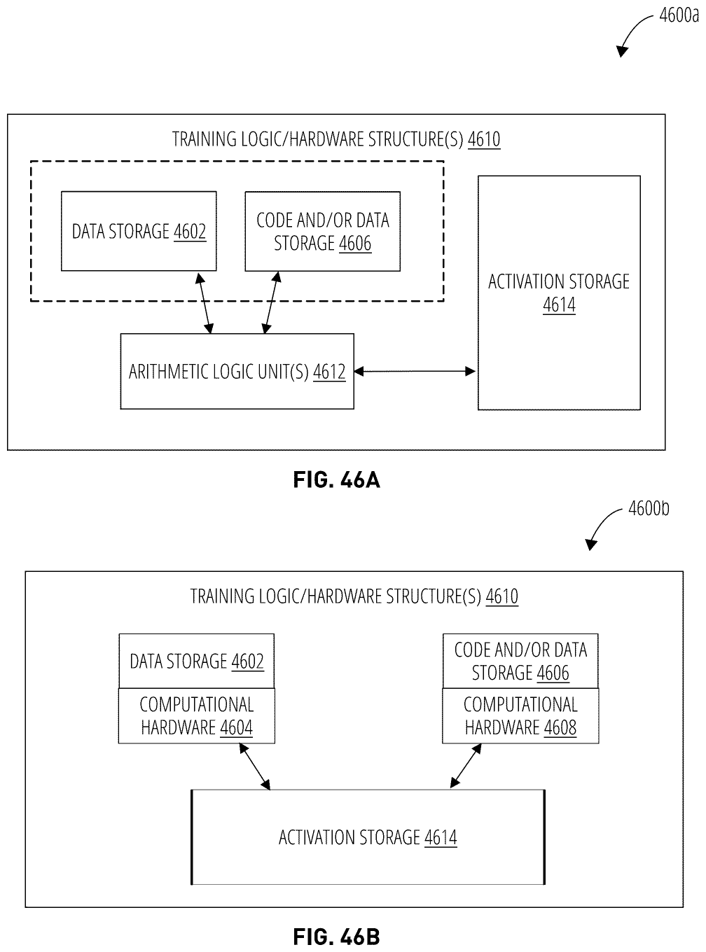

FIG. 46A illustrates inference and/or training logic 4600a used to perform inferencing and/or training operations associated with one or more embodiments. Details regarding training logic/hardware structure 4610 are provided below in conjunction with FIG. 46A and/or FIG. 46B.

In at least one embodiment, training logic/hardware structure 4610 may include, without limitation, code and/or data storage 4602 to store forward and/or output weight and/or input/output data, and/or other parameters to configure neurons or layers of a neural network trained and/or used for inferencing in aspects of one or more embodiments. In at least one embodiment, training logic/hardware structure 4610 may include or be coupled to code and/or data storage 4602 to store graph code or other software to control the timing and/or order in which weight and/or other parameter information is to be loaded to configure logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment code and/or data storage 4602 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 4602 may be included with other on-chip or off-chip data storage, including a processor's L1, L2, or L3 cache or system memory.

In at least one embodiment, any portion of code and/or data storage 4602 may be internal or external to one or more processors or other hardware logic devices or circuits. In at least one embodiment, code and/or data storage 4602 may be cache memory, dynamic randomly addressable memory (DRAM), static randomly addressable memory (SRAM), non-volatile memory (e.g., flash memory), or other storage. In at least one embodiment, a choice of whether code and/or data storage 4602 is internal or external to a processor, for example, or comprising DRAM, SRAM, flash, or some other storage type may depend on available storage on-chip versus off-chip, latency needs of training and/or inferencing functions being performed, batch size of data used in inferencing and/or training of a neural network, or some combination of these factors.

In at least one embodiment, training logic/hardware structure 4610 may include, without limitation, a code and/or data storage 4606 to store backward and/or output weight and/or input/output data corresponding to neurons or layers of a neural network trained and/or used for inferencing in aspects of one or more embodiments. In at least one embodiment, code and/or data storage 4606 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic/hardware structure 4610 may include or be coupled to code and/or data storage 4606 to store graph code or other software to control the timing and/or order in which weight and/or other parameter information is to be loaded to configure logic, including integer and/or floating point units (collectively, arithmetic logic units (ALUs)).

In at least one embodiment, code, such as graph code, causes loading of weight or other parameter information into processor ALUs based on an architecture of a neural network to which such code corresponds. In at least one embodiment, any portion of code and/or data storage 4606 may be included with other on-chip or off-chip data storage, including a processor's L1, L2, or L3 cache or system memory. In at least one embodiment, any portion of code and/or data storage 4606 may be internal or external to one or more processors or other hardware logic devices or circuits. In at least one embodiment, code and/or data storage 4606 may be cache memory, DRAM, SRAM, non-volatile memory (e.g., flash memory), or other storage. In at least one embodiment, a choice of whether code and/or data storage 4606 is internal or external to a processor, for example, or comprising DRAM, SRAM, flash memory or some other storage type may depend on available storage on-chip versus off-chip, latency needs of training and/or inferencing functions being performed, batch size of data used in inferencing and/or training of a neural network, or some combination of these factors.

In at least one embodiment, code and/or data storage 4602 and code and/or data storage 4606 may be separate storage structures. In at least one embodiment, code and/or data storage 4602 and code and/or data storage 4606 may be a combined storage structure. In at least one embodiment, code and/or data storage 4602 and code and/or data storage 4606 may be partially combined and partially separate. In at least one embodiment, any portion of code and/or data storage 4602 and code and/or data storage 4606 may be included with other on-chip or off-chip data storage, including a processor's L1, L2, or L3 cache or system memory.

In at least one embodiment, training logic/hardware structure 4610 may include, without limitation, one or more arithmetic logic units 4612, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 4614 that are functions of input/output and/or weight parameter data stored in code and/or data storage 4602 and/or code and/or data storage 4606. In at least one embodiment, activations stored in activation storage 4614 are generated according to linear algebraic and or matrix-based mathematics performed by arithmetic logic units 4612 in response to performing instructions or other code, wherein weight values stored in code and/or data storage 4606 and/or code and/or data storage 4602 are used as operands along with other values, such as bias values, gradient information, momentum values, or other parameters or hyperparameters, any or all of which may be stored in code and/or data storage 4606 or code and/or data storage 4602 or another storage on or off-chip.

In at least one embodiment, arithmetic logic units 4612 are included within one or more processors or other hardware logic devices or circuits, whereas in another embodiment, arithmetic logic units 4612 may be external to a processor or other hardware logic device or circuit that uses them (e.g., a co-processor). In at least one embodiment, arithmetic logic units 4612 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or code and/or data storage 4602, code and/or data storage 4606, and activation storage 4614 may share a processor or other hardware logic device or circuit, whereas, in another embodiment, they may be in different processors or other hardware logic devices or circuits, or some combination of same and different processors or other hardware logic devices or circuits. In at least one embodiment, any portion of activation storage 4614 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement, and/or other logic circuits.

In at least one embodiment, activation storage 4614 may be cache memory, DRAM, SRAM, non-volatile memory (e.g., flash memory), or other storage. In at least one embodiment, activation storage 4614 may be completely or partially within or external to one or more processors or other logic circuits. In at least one embodiment, a choice of whether activation storage 4614 is internal or external to a processor, for example, or comprising DRAM, SRAM, flash memory or some other storage type may depend on available storage on-chip versus off-chip, latency needs of training and/or inferencing functions being performed, batch size of data used in inferencing and/or training of a neural network, or some combination of these factors.

In at least one embodiment, the training logic/hardware structure 4610 illustrated in FIG. 46A may be used in conjunction with an application-specific integrated circuit (ASIC), such as a TensorFlow® Processing Unit from Google, an inference processing unit (IPU) from Graphcore™, or a Nervana® (e.g., “Lake Crest) processor from Intel Corp. In at least one embodiment, the training logic/hardware structure 4610 illustrated in FIG. 46A may be used in conjunction with central processing unit (CPU) hardware, graphics processing unit (GPU) hardware, or other hardware, such as field programmable gate arrays (FPGAs).

FIG. 46B illustrates inference and/or training logic 4600b, according to at least one embodiment. In at least one embodiment, training logic/hardware structure 4610 may include, without limitation, hardware logic in which computational resources are dedicated or otherwise exclusively used in conjunction with weight values or other information corresponding to one or more layers of neurons within a neural network. In at least one embodiment, the training logic/hardware structure 4610 illustrated in FIG. 46B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, the training logic/hardware structure 4610 illustrated in FIG. 46B may be used in conjunction with central processing unit (CPU) hardware, graphics processing unit (GPU) hardware, or other hardware, such as field programmable gate arrays (FPGAs). In at least one embodiment, training logic/hardware structure 4610 includes, without limitation, code and/or data storage 4602 and code and/or data storage 4606, which may be used to store code (e.g., graph code), weight values and/or other information, including bias values, gradient information, momentum values, and/or other parameter or hyperparameter information. In at least one embodiment illustrated in FIG. 46B, each of code and/or data storage 4602 and code and/or data storage 4606 is associated with a dedicated computational resource, such as computational hardware 4604 and computational hardware 4608, respectively. In at least one embodiment, each of computational hardware 4604 and computational hardware 4608 comprises one or more ALUs that perform mathematical functions, such as linear algebraic functions, on information stored in code and/or data storage 4602 and code and/or data storage 4606, respectively, the result of which is stored in activation storage 4614.

In at least one embodiment, each of code and/or data storage 4602 and 4606 and corresponding computational hardware 4604 and 4608, respectively, correspond to different layers of a neural network, such that resulting activation from one storage/computational pair 4602/4604 of code and/or data storage 4602 and computational hardware 4604 is provided as an input to a next storage/computational pair 4606/4608 of code and/or data storage 4606 and computational hardware 4608, in order to mirror a conceptual organization of a neural network. In at least one embodiment, each of the storage/computational pairs 4602/4604 and 4606/4608 may correspond to more than one neural network layer. In at least one embodiment, additional storage/computation pairs (not shown) subsequent to or in parallel with storage/computation pairs 4602/4604 and 4606/4608 may be included in training logic/hardware structure 4610.

FIG. 47 illustrates a basic deep neural network 4700 in accordance with one embodiment. A basic deep neural network 4700 is based on a collection of connected units or nodes called artificial neurons which loosely model the neurons in a biological brain. Each connection, like the synapses in a biological brain, may transmit a signal from one artificial neuron to another. An artificial neuron that receives a signal may process it and then signal additional artificial neurons connected to it.

In common implementations, the signal at a connection between artificial neurons is a real number, and the output of each artificial neuron is computed by some non-linear function (the activation function) of the sum of its inputs. The connections between artificial neurons are called ‘edges’ or axons. Artificial neurons and edges typically have a weight that adjusts as learning proceeds. The weight increases or decreases the strength of the signal at a connection. Artificial neurons may have a threshold (trigger threshold) such that the signal is sent if the aggregate signal crosses that threshold. Typically, artificial neurons are aggregated into layers. Different layers may perform different kinds of transformations on their inputs. Signals travel from the first layer (the input layer 4702), to the last layer (the output layer 4706), possibly after traversing one or more intermediate layers, called hidden layers 4704.

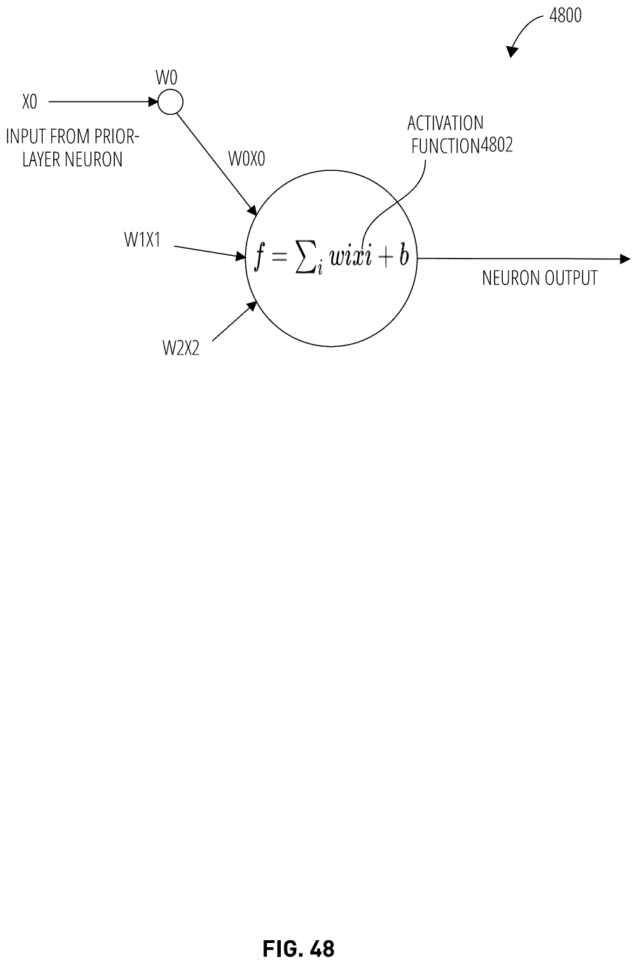

Referring to FIG. 48, an artificial neuron 4800 receiving inputs from predecessor neurons consists of the following components:
inputs xi;
weights wi applied to the inputs;
an optional threshold (b), which stays fixed unless changed by a learning function; and
an activation function 4802 that computes the output from the previous neuron inputs and threshold, if any.

An input neuron has no predecessor but serves as input interface for the whole network of artificial neurons 4800, such as may form a basic deep neural network 4700. Similarly an output neuron has no successor and thus serves as output interface of the whole network.

The network includes connections, each connection transferring the output of a neuron in one layer to the input of a neuron in a next layer. Each connection carries an input x and is assigned a weight w.

The activation function 4802 often has the form of a sum of products of the weighted values of the inputs of the predecessor neurons.

The learning rule is a rule or an algorithm which modifies the parameters of the neural network, in order for a given input to the network to produce a favored output. This learning process typically involves modifying the weights and thresholds of the neurons and connections within the network.

What is claimed is:

1. An interactive system comprising:
user input systems configured to detect, receive, and transmit data for biosignal input and sensor data;
an interaction framework comprising a classifier and a context estimator, the interaction framework configured to receive the biosignal input, the sensor data, and current context data;
a dynamic user interface (UI) configured to receive, from a generative AI system, at least a portion of a configuration;
a processor; and
a memory storing instructions that, when executed by the processor, configure the apparatus to execute the instructions to:
receive, by the interaction framework, the biosignal inputs and the sensor data from the user input systems;
receive, by the context estimator, the current context data;
provide, by the context estimator, a context estimation to the classifier;
provide, by the classifier, the UI configuration to the dynamic UI;
provide, by the generative AI system, generative AI suggestions or instructions to at least one of the dynamic UI and the interaction framework; and
provide, by the dynamic UI, output to a user.

2. The interactive system of claim 1, the instructions further comprising:
receive by the interaction framework, the biosignal input and the context estimation; and
determine an appropriate input modality or combination of input modalities to use in configuring the UI configuration.

3. The interactive system of claim 1, wherein the UI configuration is configured to provide, to the dynamic UI, selection target display outputs in three operating states including an idle state, a hover state, and a selected state.

4. The interactive system of claim 3, the instructions further comprising:
receive a default state of each of the selection target display outputs from the interaction framework based at least in part on the biosignal input and the current context data; and
configure a user interaction option with an agency assistive device, by identifying the selection target display outputs to the user.

5. The interactive system of claim 4, the instructions further comprising:
present selection targets in the idle state;
analyze the biosignal inputs and the current context data to determine user attention classification criteria;
make a first classification of a first selection target as having user attention;
place the first selection target having user attention into the hover state;
make a second classification of a second selection target as having the user attention;
on condition the second selection target is the same as the first selection target:
place the first selection target in the selected state; and
perform an action associated with the first selection target; and
on condition the second selection target is different from the first selection target:
place the first selection target in the idle state.

6. The interactive system of claim 2, the instructions further comprising:
perform an input analysis comprising:
analyze the biosignal inputs and the current context data for available signal types;
determine what available input signals are detected as providing the biosignal input and the current context data; and
select one or more input modalities for use in making input classifications including:
a first classification of a first selection target as having user attention; and
a second classification of a second selection target as having the user attention.

7. The interactive system of claim 4, the instructions further comprising:
present selection targets in the idle state;
analyze the biosignal inputs and the current context data to determine user attention classification criteria;
make a first classification of a first selection target as having user attention;
open a modal submenu associated with the first selection target, with submenu selection targets in the idle state and deactivate selection targets outside the modal submenu;
make a second classification of a first submenu selection target as having the user attention;
place the first submenu selection target in the hover state;
make a third classification of a second submenu selection target as having the user attention;
on condition the first submenu selection target is the same as the second submenu selection target:
place the first submenu selection target in the selected state;
perform an action associated with the first submenu selection target; and
close the modal submenu.

8. The interactive system of claim 2, the instructions further comprising:
create a context estimate from the current context data;
configure the dynamic UI in accordance with the context estimation;
on condition the user is distracted:
modify the presentation of the selection targets of the configured user interface.

9. The interactive system of claim 8, wherein the presentation of the selection targets is based on the input modality, the instructions further comprising:
expose an active modality to the operating system by providing at least one of:
a single binary selection;
a multiple selection, along with a numeric value indicating the number of simultaneous selections possible; and
confidence values indicating how confident the modality interface is in the user's selection.

10. The interactive system of claim 9, the instructions further comprising:
on condition multiple input modalities are available:
switch to a different input modality more efficiently adaptable to binary input.

11. A method comprising:
receiving, by a interaction framework, biosignal inputs and sensor data from user input systems,
wherein the interaction framework includes a classifier and a context estimator, the interaction framework configured to receive the biosignal inputs, the sensor data, and current context data, and
wherein the user input systems are configured to detect, receive, and transmit data for the biosignal inputs and the sensor data;
receiving, by the context estimator, the current context data;
providing, by the context estimator, a context estimation to the classifier;
providing, by the classifier, a UI configuration to a dynamic user interface (UI),
wherein the dynamic UI is configured to receive, from a generative AI system, at least a portion of a configuration;
providing, by the generative AI, generative AI suggestions or instructions to at least one of the dynamic UI and the interaction framework; and
providing, by the dynamic UI, output to a user.

12. The method of claim 11, further comprising:
receiving by the interaction framework, the biosignal inputs and the context estimation; and
determining an appropriate input modality or combination of input modalities to use in configuring the UI configuration.

13. The method of claim 11, wherein the UI configuration is configured to provide, to the dynamic UI, selection target display outputs in three operating states including an idle state, a hover state, and a selected state.

14. The method of claim 13, further comprising:
receiving a default state of each of the selection target display outputs from the interaction framework based at least in part on the biosignal inputs and the current context data; and
configuring a user interaction option with an agency assistive device, by identifying the selection target display outputs to the user.

15. The method of claim 14, further comprising:
presenting selection targets in the idle state;
analyzing the biosignal inputs and the current context data to determine user attention classification criteria;
making a first classification of a first selection target as having user attention;
placing the first selection target having user attention into the hover state;
making a second classification of a second selection target as having the user attention;
on condition the second selection target is the same as the first selection target:
placing the first selection target in the selected state; and
performing an action associated with the first selection target; and
on condition the second selection target is different from the first selection target:
placing the first selection target in the idle state.

16. The method of claim 12, further comprising:
performing an input analysis comprising:
analyzing the biosignal inputs and the current context data for available signal types;
determining what available input signals are detected as providing the biosignal inputs and the current context data; and
selecting one or more input modalities for use in making input classifications including:
a first classification of a first selection target as having user attention; and
a second classification of a second selection target as having the user attention.

17. The method of claim 14, further comprising:
presenting selection targets in the idle state;
analyzing the biosignal inputs and the current context data to determine user attention classification criteria;
making a first classification of a first selection target as having user attention;
opening a modal submenu associated with the first selection target, with submenu selection targets in the idle state and deactivate selection targets outside the modal submenu;
making a second classification of a first submenu selection target as having the user attention;
placing the first submenu selection target in the hover state;
making a third classification of a second submenu selection target as having the user attention;
on condition the first submenu selection target is the same as the second submenu selection target:
placing the first submenu selection target in the selected state;
performing an action associated with the first submenu selection target; and
closing the modal submenu.

18. The method of claim 12, further comprising:
creating a context estimate from the current context data;
configuring the dynamic UI in accordance with the context estimation;
on condition the user is distracted:
modifying the presentation of the selection targets of the configured user interface.

19. The method of claim 18, wherein the presentation of the selection targets is based on the input modality, the method further comprising:
exposing an active modality to the operating system by providing at least one of:
a single binary selection;
a multiple selection, along with a numeric value indicating the number of simultaneous selections possible; and
confidence values indicating how confident the modality interface is in the user's selection.

20. The method of claim 19, further comprising:
on condition multiple input modalities are available:
switching to a different input modality more efficiently adaptable to binary input.
